(19) United States
(12) Patent Application Publication
(10) Pub. No.: US 2025/0234302 A1
(43) Pub. Date: Jul. 17, 2025

(54) METHOD AND APPARATUS FOR TRANSMISSION POWER CONTROL IN WIRELESS COMMUNICATION SYSTEMS

(71) Applicant: SAMSUNG ELECTRONICS CO., LTD., Suwon-si (KR)

(72) Inventors: Youngrok JANG, Suwon-si (KR); Seongmok LIM, Suwon-si (KR); Hyoungju JI, Suwon-si (KR); Kyungjun CHOI, Suwon-si (KR)

(21) Appl. No.: 19/023,000

(22) Filed: Jan. 15, 2025

(30) Foreign Application Priority Data
Jan. 15, 2024 (KR) 10-2024-0006281

(51) Int. Cl. H04W 52/14; H04W 72/231

(52) U.S. Cl. CPC H04W 52/146; H04W 72/231

(57) ABSTRACT

The disclosure relates to a 5G or 6G communication system for supporting a higher data transmission rate. A method performed by a terminal in a wireless communication system in the present disclosure to solve the above problems, comprises receiving, from a base station, a radio resource control (RRC) message including first power control configuration information for an uplink (UL) channel; and transmitting, to the base station, the UL channel based on at least one of the first power control configuration information or second power control configuration information. The RRC message includes the second power control configuration information in case that the RRC message further includes unified transmission configuration indication (TCI) state type configuration information, The first power control configuration information relates to a physical uplink shared channel (PUSCH) or a physical uplink control channel (PUCCH).

### CROSS-REFERENCE TO RELATED APPLICATION

This application is based on and claims priority under 35 U.S.C. § 119 to Korean Patent Application No. 10-2024-0006281, filed on Jan. 15, 2024, in the Korean Intellectual Property Office, the disclosure of which is herein incorporated by reference in its entirety.

### BACKGROUND

### 1. Field

The present disclosure relates to the operation of terminal and base station in a wireless communication system. More particularly, the present disclosure relates to a method and an apparatus for power control in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, a layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As described above, the development of a mobile communication system has made it possible to provide various services, and a measure to provide these services effectively are required.

The above information is presented as background information only to assist with an understanding of the disclosure. No determination has been made, and no assertion is made, as to whether any of the above might be applicable as prior art with regard to the disclosure.

### SUMMARY

The disclosed embodiments are intended to provide an apparatus and a method for effectively providing services in a mobile communication system.

A method performed by a terminal in a wireless communication system in the present disclosure to solve the above problems, comprises receiving, from a base station, a radio resource control (RRC) message including first power control configuration information for an uplink (UL) channel; and transmitting, to the base station, the UL channel based on at least one of the first power control configuration information or second power control configuration information. The RRC message includes the second power control configuration information in case that the RRC message further includes unified transmission configuration indication (TCI) state type configuration information, The first power control configuration information relates to a physical uplink shared channel (PUSCH) or a physical uplink control channel (PUCCH).

A method performed by a base station in a wireless communication system in the present disclosure to solve the above problems, comprises, transmitting, to a terminal, a radio resource control (RRC) message including first power control configuration information for an uplink (UL) channel; and receiving, from the terminal, the UL channel based on at least one of the first power control configuration information or second power control configuration information. The RRC message includes the second power control configuration information in case that the RRC message further includes unified transmission configuration indication (TCI) state type configuration information, The first power control configuration information relates to a physical uplink shared channel (PUSCH) or a physical uplink control channel (PUCCH).

The disclosed embodiments provide an apparatus and a method for effectively providing services in a mobile communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a basic structure of a time-frequency domain in a wireless communication system according to an embodiment of the present disclosure;

FIG. 2 illustrates a structure of a frame, a subframe, and a slot in a wireless communication system according to an embodiment of the present disclosure;

FIG. 3 illustrates an example of a bandwidth part configuration in a wireless communication system according to an embodiment of the present disclosure;

FIG. 4 illustrates radio protocol structures of a base station and a UE in single cell, carrier aggregation, and dual connectivity situations in a wireless communication system according to an embodiment of the present disclosure;

FIG. 5 illustrates a beam application time which may be considered in a case where a unified TCI scheme is used in a wireless communication system according to an embodiment of the present disclosure;

FIG. 6 illustrates a MAC-CE structure for activation and indication of a joint TCI state or a separate DL or UL TCI state in a wireless communication system according to an embodiment of the present disclosure;

FIG. 7 illustrates an example of a control resource set configuration of a downlink control channel in a wireless communication system; according to an embodiment of the present disclosure;

FIG. 8 illustrates a structure of a downlink control channel in a wireless communication system according to an embodiment of the present disclosure;

FIG. 9 illustrates a MAC CE structure including single PHR information according to an embodiment of the present disclosure;

FIG. 10 illustrates a MAC CE structure including multiple PHR information according to an embodiment of the present disclosure;

FIG. 11 illustrates an operation of a UE for controlling uplink transmission power according to an embodiment of the present disclosure;

FIG. 12 illustrates an operation of a base station for controlling uplink transmission power according to an embodiment of the present disclosure;

FIG. 13 illustrates a structure of a UE in a wireless communication system according to an embodiment of the present disclosure; and

FIG. 14 illustrates a structure of a base station in a wireless communication system according to an embodiment of the present disclosure.

### DETAILED DESCRIPTION

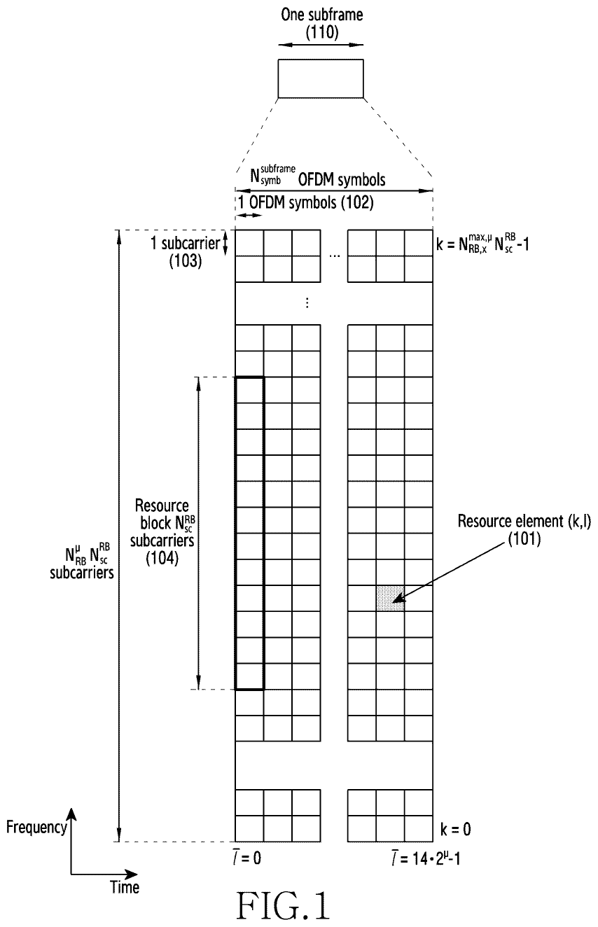

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery lifetime such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

### [NR Time-Frequency Resources]

Hereinafter, a frame structure of a 5G system will be described in more detail with reference to the accompanying drawings.

FIG. 1 illustrates a basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

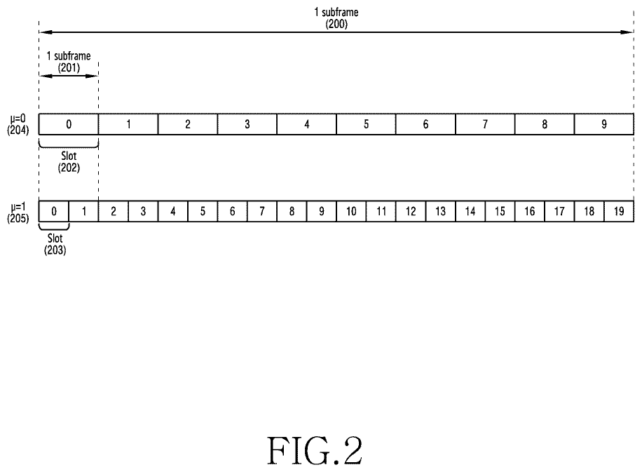

FIG. 2 illustrates a structure of a frame, a subframe, and a slot in a wireless communication system according to an embodiment of the present disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values for the subcarrier spacing 204 or 205. The example in FIG. 2 illustrates a case in which the subcarrier spacing configuration value is p=0 (204), and a case in which p=1 (205). In the case of =0 (204), one subframe 201 may include one slot 202, and in the case of =1 (205), one subframe 201 may include two slots 203. That is, the number of slots per one subframe Nₛₗₒₜ^{subframe,μ}, may differ depending on the subcarrier spacing configuration value μ, and the number of slots per one frame Nₛₗₒₜ^{flame,μ}, may differ accordingly. Nₛₗₒₜ^{subframe,μ}, and Nₛₗₒₜ^{flame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, a bandwidth part (BWP) configuration in a 5G communication system will be described in detail with reference to the accompanying drawings.

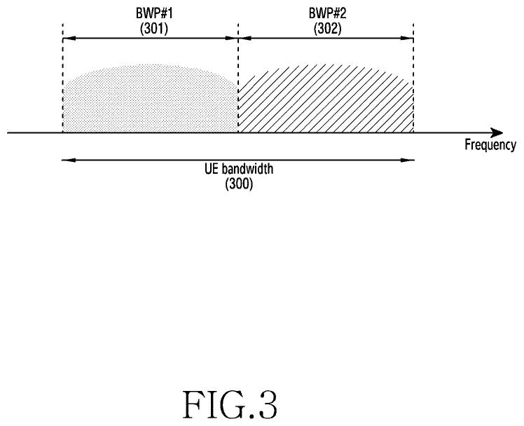

FIG. 3 illustrates an example of a bandwidth part configuration in a wireless communication system according to an embodiment of the present disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Obviously, the above example is not limiting, and various parameters related to the bandwidth part may be configured for the UE, in addition to the above configuration information. The base station may transfer the configuration information to the UE through upper layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to an embodiment, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

The bandwidth part-related configuration supported by 5G may be used for various purposes.

According to an embodiment, if the bandwidth supported by the UE is smaller than the system bandwidth, this may be supported through the bandwidth part configuration. For example, the base station may configure the frequency location (configuration information 2) of the bandwidth part for the UE, so that the UE can transmit/receive data at a specific frequency location within the system bandwidth.

In addition, according to an embodiment, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the bandwidth part configured as the corresponding subcarrier spacing may be activated.

In addition, according to an embodiment, the base station may configure bandwidth parts having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth (for example, a bandwidth part of 20 MHz) for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through an MIB in the initial access step. To be more specific, a UE may have a control resource set (i.e., CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined as given in Table 3 below, for example.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. If the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI indicating a bandwidth part change may indicate a slot offset (K0 or K2) value smaller than the bandwidth part change delay time (T_{BWP}).

If the UE has received DCI (for example, DCI format 11 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [Regarding CA/DC]

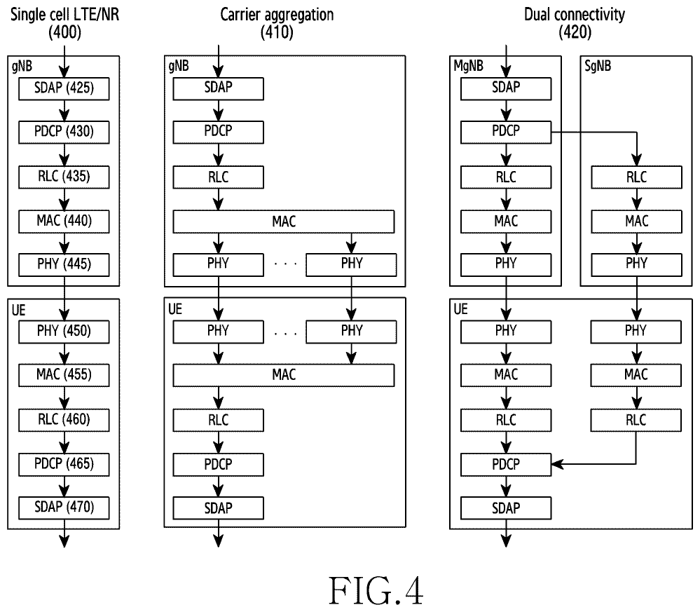

FIG. 4 illustrates radio protocol structures of a base station and a UE in single cell 400, carrier aggregation 410, and dual connectivity 420 situations according to an embodiment of the present disclosure.

Referring to FIG. 4, a radio protocol of a next-generation mobile communication system includes an NR service data adaptation protocol (SDAP) 425 or 470, an NR packet data convergence protocol (PDCP) 430 or 465, an NR radio link control (RLC) 435 or 460, and an NR medium access controls (MAC) 440 or 455, on each of UE and NR base station sides.

The main functions of the NR SDAP 425 or 470 may include some of functions below:
Transfer of user plane data;
Mapping between a QoS flow and a DRB for both DL and UL;
Marking QoS flow ID in both DL and UL packets; and/or
Reflective QoS flow to DRB mapping for the UL SDAP PDUs.

With regard to the SDAP layer device, the UE may be configured, through an RRC message, whether to use the header of the SDAP layer device with regard to each PDCP layer device or with regard to each bearer or with regard to each logical channel, or whether to use functions of the SDAP layer device. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 430 or 465 may include some of functions below:
Header compression and decompression: ROHC only;
Transfer of user data;
In-sequence delivery of upper layer PDUs;
Out-of-sequence delivery of upper layer PDUs;
PDCP PDU reordering for reception;
Duplicate detection of lower layer SDUs;
Retransmission of PDCP SDUs;
Ciphering and deciphering; and/or
Timer-based SDU discard in uplink.

The above-mentioned reordering of the NR PDCP device refers to a function of reordering PDCP PDUs received from a lower layer in an order based on the PDCP sequence number (SN), and may include a function of transferring data to an upper layer in the reordered sequence. Alternatively, the reordering of the NR PDCP device may include at least one of a function of instantly transferring data without considering the order, a function of recording PDCP PDUs lost as a result of reordering, a function of reporting the state of the lost PDCP PDUs to the transmitting side, and a function of requesting retransmission of the lost PDCP PDUs.

The main functions of the NR RLC 435 or 460 may include some of functions below:
Transfer of upper layer PDUs;
In-sequence delivery of upper layer PDUs;
Out-of-sequence delivery of upper layer PDUs;
Error correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and/or
RLC re-establishment.

The in-sequence delivery of the NR RLC device refers to a function of delivering RLC SDUs, received from the lower layer, to the upper layer in sequence. The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs. The in-sequence delivery of the NR RLC device may include a function of, if there is a lost RLC SDU, successively delivering only RLC SDUs before the lost RLC SDU to the upper layer, and may include a function of, if a predetermined timer has expired although there is a lost RLC SDU, successively delivering all RLC SDUs received before the timer was started to the upper layer. Alternatively, the in-sequence delivery of the NR RLC device may include a function of, if a predetermined timer has expired although there is a lost RLC SDU, successively delivering all currently received RLC SDUs to the upper layer. In addition, the in-sequence delivery of the NR RLC device may include a function of processing RLC PDUs in the received order (regardless of the sequence number order, in the order of arrival) and delivering same to the PDCP device regardless of the order (out-of-sequence delivery), and may include a function of, in the case of segments, receiving segments which are stored in a buffer or which are to be received later, reconfiguring same into one complete RLC PDU, processing, and delivering same to the PDCP device. The NR RLC layer may include no concatenation function, which may be performed in the NR MAC layer or replaced with a multiplexing function of the NR MAC layer.

The out-of-sequence delivery of the NR RLC device refers to a function of directly delivering RLC SDUs received from the lower layer to the upper layer regardless of the sequence. The out-of-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, and a function of storing the RLC SN or PDCP SN of received RLC PDUs, and recording RLC PDUs lost as a result of reordering.

The NR MAC 440 or 455 may be connected to multiple NR RLC layer devices configured in one UE, and the main functions of the NR MAC may include some of functions below:
Mapping between logical channels and transport channels;
Multiplexing/demultiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and/or
Padding.

An NR PHY layer 445 or 450 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 400. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 410. As another example, in case that the base station transmits data to the UE, based on dual connectivity (DC) which uses multiple carriers in multiple TRPs, the base station and the UE may use a protocol structure which has a single structure up to the RLC, but multiplexes the PHY layer through a MAC layer, such as 420.

### [Unified TCI State]

Hereinafter, a single TCI state indication and activation method based on a unified TCI scheme is described. The unified TCI scheme may mean a scheme of integrating and managing, through a TCI state, a transmission/reception beam management scheme, which has been classified as a TCI state scheme used in downlink reception of a UE and a spatial relation info scheme used in uplink transmission in conventional Rel-15 and 16. Therefore, in a case where a UE receives an indication from a base station, based on the unified TCI scheme, the UE may perform beam management even for uplink transmission by using a TCI state. If the higher layer signaling TCI-State having the higher layer signaling tci-stateld-r17 is configured for a UE by a base station, the UE may perform an operation based on the unified TCI scheme by using the TCI-State. TCI-State may exist in two types including a joint TCI state and a separate TCI state.

The first type is a joint TCI state, and all TCI states to be applied to uplink transmission and downlink reception may be indicated to a UE by a base station through one value of TCI-State. If joint TCI state-based TCI-state is indicated to the UE, a parameter to be used in downlink channel estimation may be indicated to the UE by using an RS corresponding to qcl-Type1 in the joint TCI state-based TCI-state, and a parameter to be used as a downlink reception beam or reception filter may be indicated thereto by using an RS corresponding to qcl-Type2. If joint TCI state-based TCI-state is indicated to the UE, a parameter to be used as an uplink transmission beam or transmission filter may be indicated to the UE by using an RS corresponding to qcl-Type2 in a corresponding joint DL/UL TCI state-based TCI-state. If a joint TCI state is indicated to the UE, the UE may apply the same beam to uplink transmission and downlink reception.

The second type is a separate TCI state, and a UL TCI state to be applied to uplink transmission and a DL TCI state to be applied to downlink reception may be individually indicated to a UE by a base station. If a UL TCI state is indicated to the UE, a parameter to be used as an uplink transmission beam or transmission filter may be indicated to the UE by using a reference RS or a source RS configured in the UL TCI state. If a DL TCI state is indicated to the UE, a parameter to be used in downlink channel estimation may be indicated to the UE by using an RS corresponding to qcl-Type1 configured in the DL TCI state, and a parameter to be used as a downlink reception beam or reception filter may be indicated thereto by using an RS corresponding to qcl-Type2.

If a DL TCI state and a UL TCI state are indicated to the UE together, a parameter to be used as an uplink transmission beam or transmission filter may be indicated to the UE by using a reference RS or a source RS configured in the UL TCI state, a parameter to be used in downlink channel estimation may be indicated to the UE by using an RS corresponding to qcl-Type1 configured in the DL TCI state, and a parameter to be used as a downlink reception beam or reception filter may be indicated thereto using an RS corresponding to qcl-Type2. If the reference RSs or source RSs configured in the DL TCI state and UL TCI state indicated to the UE are different from each other, the UE may apply individual beams to uplink transmission and downlink reception, based on the indicated UL TCI state and DL TCI state.

A maximum of 128 joint TCI states may be configured for a particular bandwidth part in a particular cell for the UE by the base station through higher layer signaling, a maximum of 64 or 128 DL TCI states among separate TCI states may be configured for a particular bandwidth part in a particular cell through higher layer signaling, based on a UE capability report, and a DL TCI state among separate TCI states and a joint TCI state may use the same higher layer signaling structure. For example, if 128 joint TCI states are configured and 64 DL TCI states among separate TCI states are configured, the 64 DL TCI states may be included in the 128 joint TCI states.

A maximum of 32 or 64 UL TCI states among separate TCI states may be configured for a particular bandwidth part in a particular cell through higher layer signaling, based on a UE capability report, and a UL TCI state among separate TCI states and a joint TCI state may also use the same higher layer signaling structure like the relation between a DL TCI state among separate TCI states and a joint TCI state, or a UL TCI state among separate TCI states may also use a higher layer signaling structure different from that of a joint TCI state and a DL TCI state among separate TCI states.

As described above, using different or identical higher layer signaling structures may be defined in a specification, or may be distinguished through another higher layer signaling configured by a base station, based on a UE capability report including information on a usage scheme which a UE is able to support among two types of usage schemes.

A transmission/reception beam-related indication may be received by a UE in a unified TCI scheme by using one scheme among a joint TCI state and a separate TCI state configured by a base station. Whether to use one of a joint TCI state and a separate TCI state may be configured for a UE by a base station through higher layer signaling.

A UE may receive a transmission/reception beam-related indication through higher layer signaling by using one scheme selected from among a joint TCI state and a separate TCI state, and a method of transmission/reception beam indication by a base station may be classified as two types of methods including a MAC-CE-based indication method and a MAC-CE-based activation and DCI-based indication method.

In a case where a UE receives a transmission/reception beam-related indication through higher layer signaling by using a joint TCI state scheme, the UE may receive a MAC-CE indicating a joint TCI state from a base station to perform a transmission/reception beam application operation, and the base station may schedule reception of a PDSCH including the MAC-CE to the UE through a PDCCH. If there is one joint TCI state included in a MAC-CE, the UE may determine an uplink transmission beam or transmission filter and a downlink reception beam or reception filter by using the indicated joint TCI state after 3 ms after PUCCH transmission including HARQ-ACK information meaning whether a PDSCH including the MAC-CE has been successfully received. If there are two or more joint TCI states included in a MAC-CE, the UE may identify that multiple joint TCI states indicated by the MAC-CE correspond to respective codepoints of a TCI state field of DCI format 1_1 or 1_2, after 3 ms after PUCCH transmission including HARQ-ACK information meaning whether a PDSCH including the MAC-CE has been successfully received, and activate the indicated joint TCI states. Thereafter, the UE may receive DCI format 1_1 or 1_2 to apply one joint TCI state indicated by a TCI state field in the DCI to uplink transmission and downlink reception beams. DCI format 1_1 or 1_2 may include downlink data channel scheduling information (with DL assignment) or not include same (without DL assignment).

In a case where a UE receives a transmission/reception beam-related indication through higher layer signaling by using a separate TCI state scheme, the UE may receive a MAC-CE indicating a separate TCI state from a base station to perform a transmission/reception beam application operation, and the base station may schedule reception of a PDSCH including the MAC-CE to the UE through a PDCCH. If a MAC-CE includes one separate TCI state set, the UE may determine an uplink transmission beam or transmission filter and a downlink reception beam or reception filter by using separate TCI states included in the indicated separate TCI state set after 3 ms after PUCCH transmission including HARQ-ACK information meaning whether a corresponding PDSCH has been successfully received. A separate TCI state set may indicate a single or multiple separate TCI states which one codepoint of a TCI state field in DCI format 1_1 or 1_2 may have, and one separate TCI state set may include one DL TCI state, include one UL TCI state, or include one DL TCI state and one UL TCI state. If a MAC-CE includes two or more separate TCI state sets, the UE may identify that multiple separate TCI state sets indicated by the MAC-CE correspond to respective codepoints of a TCI state field of DCI format 1_1 or 1_2, after 3 ms after PUCCH transmission including HARQ-ACK information meaning whether a corresponding PDSCH has been successfully received, and may activate the indicated separate TCI state sets. Each codepoint of the TCI state field of DCI format 1_1 or 12 may indicate one DL TCI state, indicate one UL TCI state, or indicate one DL TCI state and one UL TCI state. The UE may receive DCI format 1_1 or 12 to apply a separate TCI state set indicated by a TCI state field in the DCI to uplink transmission and downlink reception beams. DCI format 1_1 or 1_2 may include downlink data channel scheduling information (with DL assignment) or not include same (without DL assignment).

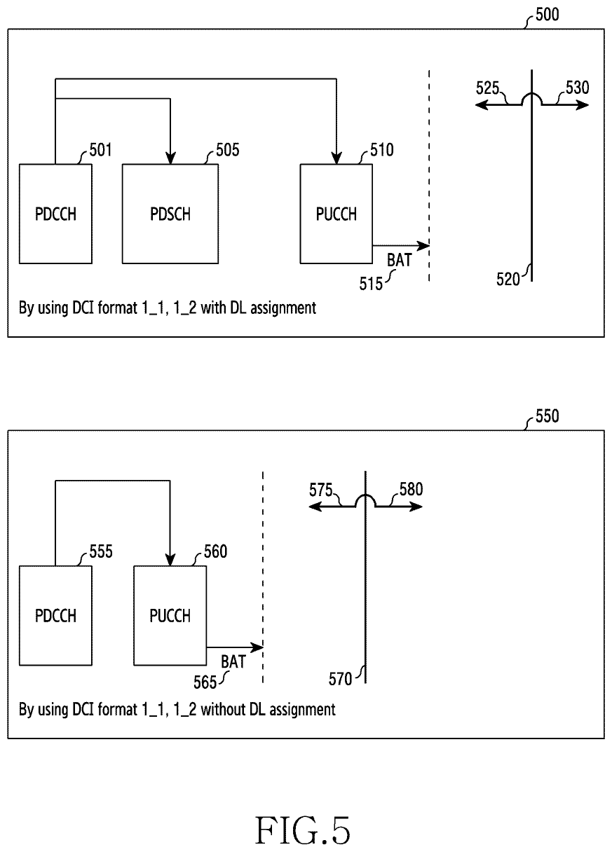

FIG. 5 illustrates a beam application time which may be considered when a unified TCI scheme is used in a wireless communication system according to an embodiment of the present disclosure. As described above, a UE may receive, from a base station, DCI format 1_1 or 1_2 including or not including downlink data channel scheduling information (with DL assignment or without DL assignment), and apply one joint TCI state or one separate TCI state set indicated by a TCI state field in the DCI to uplink transmission and downlink reception beams.
DCI format 1_1 or 1_2 with DL assignment (500): If a UE receives, from a base station, DCI format 1_1 or 1_2 including downlink data channel scheduling information (501) so that one joint TCI state or one separate TCI state set based on a unified TCI scheme is indicated, the UE may receive a PDSCH scheduled based on the received DCI (505), and transmit a PUCCH including a HARQ-ACK indicating whether reception of the DCI and the PDSCH has been successful (510). The HARQ-ACK may include whether reception has been successful, for both the DCI and the PDSCH, if the UE fails to receive at least one of the DCI and the PDSCH, the UE may transmit a NACK, and if the UE succeeds in receiving both of them, the UE may transmit an ACK.
DCI format 1_1 or 1_2 without DL assignment (550): If a UE receives, from abase station, DCI format 1_1 or 1_2 not including downlink data channel scheduling information (555) so that one joint TCI state or one separate TCI state set based on a unified TCI scheme is indicated, the UE may assume at least one combination of the following items for the DCI.
   The DCI includes a CRC scrambled using a CS-RNTI.
   The values of all bits assigned to all fields used as redundancy version (RV) fields are 1.
   The values of all bits assigned to all fields used as modulation and coding scheme (MCS) fields are 1.
   The values of all bits assigned to all fields used as new data indication (NDI) fields are 0.
   In a case of frequency domain resource allocation (FDRA) type 0, the values of all bits assigned to an FDRA field are 0, in a case of FDRA type 1, the values of all bits assigned to an FDRA field are 1, and in a case of an FDRA scheme being dynamicSwitch, the values of all bits assigned to an FDRA field are 0.

The UE may transmit a PUCCH including a HARQ-ACK indicating whether DCI format 1_1 or 1_2 for which the items described above are assumed has been successfully received (560).
With respect to both DCI format 1_1 or 1_2 with DL assignment (500) and without DL assignment (550), if the new TCI state indicated through DCI 501 or 555 is the same as a TCI state that has previously been indicated and thus been being applied to uplink transmission and downlink reception beams, the UE may maintain the previously applied TCI state. If the new TCI state is different from the previously indicated TCI state, the UE may determine, as a time point for application of the joint TCI state or separate TCI state set, which is indicatable by a TCI state field included in the DCI, a time point 530 or 580 after the first slot 520 or 570 after passage of a time interval as long as a beam application time (BAT) 515 or 565 after PUCCH transmission, and may use the previously indicated TCI state at a time point 525 or 575 before the slot 520 or 570.
With respect to both DCI format 1_1 or 1_2 with DL assignment (500) and without DL assignment (550), the BAT is a particular number of OFDM symbols and may be configured through higher layer signaling, based on UE capability report information, and numerologies of the BAT and the first slot after the BAT may be determined based on the smallest numerology among all cells to which a joint TCI state or separate TCI state set indicated through DCI is applied.

A UE may apply one joint TCI state indicated through a MAC-CE or DCI to reception for control resource sets connected to all UE-specific search spaces, reception of a PDSCH scheduled by a PDCCH transmitted from the control resource sets and transmission of a PUSCH, and transmission of all PUCCH resources.

If one separate TCI state set indicated through a MAC-CE or DCI includes one DL TCI state, a UE may apply the one separate TCI state set to reception for control resource sets connected to all UE-specific search spaces and to reception of a PDSCH scheduled by a PDCCH transmitted from the control resource sets, and apply a previously indicated UL TCI state to all PUSCH and PUCCH resources.

If one separate TCI state set indicated through a MAC-CE or DCI includes one UL TCI state, a UE may apply the one separate TCI state set to all PUSCH and PUCCH resources, and apply a previously indicated DL TCI state to reception for control resource sets connected to all UE-specific search spaces and reception of a PDSCH scheduled by a PDCCH transmitted from the control resource sets.

If one separate TCI state set indicated through a MAC-CE or DCI includes one DL TCI state and one UL TCI state, a UE may apply the DL TCI state to reception for control resource sets connected to all UE-specific search spaces and reception of a PDSCH scheduled by a PDCCH transmitted from the control resource sets, and apply the UL TCI state to all PUSCH and PUCCH resources.

### [Unified TCI State MAC-CE]

Hereinafter, a single TCI state indication and activation method based on a unified TCI scheme is described. A PDSCH including a MAC-CE described below may be scheduled to a UE by a base station, and the UE may interpret each codepoint of a TCI state field in DCI format 1_1 or 1_2, based on information in the MAC-CE received from the base station, after 3 slots from transmission of a HARQ-ACK for the PDSCH to the base station. That is, the UE may activate each entry of the MAC-CE received from the base station in each codepoint of the TCI state field in DCI format 1_1 or 1_2.

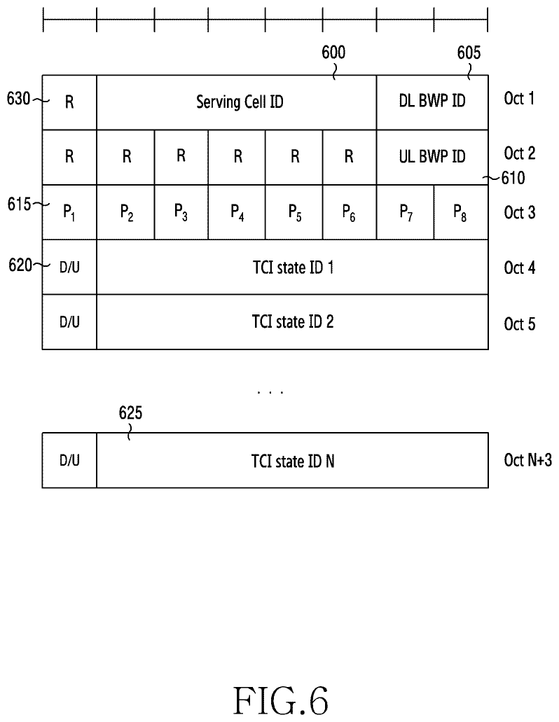

FIG. 6 illustrates a MAC-CE structure for activation and indication of a joint TCI state or a separate DL or UL TCI state in a wireless communication system according to an embodiment of the present disclosure. Each field in the MAC-CE structure may have the following meaning.
Serving Cell ID 600: This field may indicate which serving cell to which a corresponding MAC-CE is to be applied. The length of this field may be 5 bits. If a serving cell indicated by this field is included in at least one of the higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to all serving cells included in one or more lists among simultaneousU-TCI-UpdateList1, simultaneousU-TCI-UpdateList2, simultaneousU-TCI-UpdateList3, or simultaneousU-TCI-UpdateList4, in which the serving cell indicated by the field is included.
DL BWP ID 605: This field may indicate which DL BWP to which the MAC-CE is to be applied, and the meanings of codepoints in the field may correspond to codepoints of a bandwidth part indicator in DCI, respectively. The length of this field may be 2 bits.
UL BWP ID 610: This field may indicate which UL BWP to which the MAC-CE is to be applied, and the meanings of codepoints in the field may correspond to codepoints of a bandwidth part indicator in DCI, respectively. The length of this field may be 2 bits.
Pᵢ 615: This field may indicate whether each codepoint of a TCI state field in DCI format 1_1 or 1_2 has multiple TCI states or one TCI state. If the value of Pᵢ is 1, this indicates that a corresponding i-th codepoint has multiple TCI states, and may imply that the codepoint may include a separate DL TCI state and a separate UL TCI state. If the value of Pᵢ is 0, this indicates that a corresponding i-th codepoint has a single TCI state, and may imply that the codepoint may include one type among a joint TCI state, a separate DCI TCI state, or a separate UL TCI state.
D/U 620: This field may indicate whether a TCI state ID field in the same octet is a joint TCI state, a separate DL TCI state, or a separate UL TCI state. If the field is 1, a TCI state ID field in the same octet may be a joint TCI state or a separate DL TCI state, and if the field is 0, a TCI state ID field in the same octet may be a separate UL TCI state.
TCI state ID 625: This field may indicate a TCI state identifiable by the higher layer signaling TCI-StateId. If the D/U field is configured to be 1, the TCI state ID field may be used to represent TCI-StateId expressible by 7 bits. If the D/U field is configured to be 0, a most significant bit (MSB) of the TCI state ID field may be considered as a reserved bit, and the remaining 6 bits may be used to represent the higher layer signaling UL-TCIState-Id. The number of maximally activatable TCI states may be 8 in a case of joint TCI states, and may be 16 in a case of separate DL or UL TCI states.
R: This indicates a reserved bit and may be configured to be 0.

With respect to the MAC-CE structure of FIG. 6, a UE may include, in the MAC-CE structure, a third octet including P1, P2, . . . , and P8 fields in FIG. 6 regardless of unifiedTCI-StateType-r17 in MIMOparam-r17 in the higher layer signaling ServingCellConfig being configured to be joint or separate. In this case, the UE may perform TCI state activation by using a fixed MAC-CE structure regardless of higher layer signaling configured by a base station. As another example, with respect to the MAC-CE structure of FIG. 6, a UE may omit the third octet including P1, P2, . . . , and P8 fields illustrated in FIG. 6, in a case where unifiedTCI-StateType-r17 in MIMOparam-r17 in the higher layer signaling ServingCellConfig being configured to be joint. In this case, the UE may save the payload of the MAC-CE by a maximum of 8 bits according to higher layer signaling configured by a base station. In addition, all D/U fields positioned on the first bits in octets starting from a fourth octet in FIG. 6 may be considered as R fields, and all the R fields may be configured to be 0 bits.

### [PDCCH: Regarding DCI]

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example.

```
TABLE 4
  - Identifier for DCI formats - [1] bit
  - Frequency domain resource assignment -[ ┌log₂( N_{RB}^{UL,BWP}(N_{RB}^{UL,BWP} + 1)/
2)┐ ] bits
  - Time domain resource assignment - X bits
  - Frequency hopping flag - 1 bit.
  - Modulation and coding scheme - 5 bits
  - New data indicator - 1 bit
  - Redundancy version - 2 bits
  - HARQ process number - 4 bits
  - Transmit power control (TPC) command for scheduled PUSCH - [2] bits
  - Uplink/ supplementary uplink (UL/SUL) indicator - 0 or 1 bit
```

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example.

TABLE 5

```
  - Carrier indicator - 0 or 3 bits
  - UL/SUL indicator - 0 or 1 bit
  - Identifier for DCI formats - [1] bits
  - Bandwidth part indicator - 0, 1 or 2 bits
  - Frequency domain resource assignment
      * For resource allocation type 0, ┌N_{RB}^{UL,BWP}/P┐ bits
      * For resource allocation type 1, ┌log₂(N_{RB}^{UL,BWP}(N_{RB}^{UL,BWP} + 1)/2)┐
      bits
  - Time domain resource assignment - 1, 2, 3, or 4 bits
  - Virtual resource block (VRB)-to-physical resource block (PRB)
mapping - 0 or 1 bit, only for resource allocation type 1.
      * 0 bit if only resource allocation type 0 is configured;
      * 1 bit otherwise.
  - Frequency hopping flag - 0 or 1 bit, only for resource allocation type 1.
      * 0 bit if only resource allocation type 0 is configured;
      * 1 bit otherwise.
  - Modulation and coding scheme - 5 bits
  - New data indicator - 1 bit
  - Redundancy version - 2 bits
  - HARQ process number - 4 bits
  - 1st downlink assignment index - 1 or 2 bits
      * 1 bit for semi-static HARQ-ACK codebook;
      * 2 bits for dynamic HARQ-ACK codebook with single HARQ-ACK
      codebook.
  - 2nd downlink assignment index - 0 or 2 bits
      * 2 bits for dynamic HARQ-ACK codebook with two HARQ-ACK sub-
      codebooks;
      * 0 bit otherwise.
  - TPC command for scheduled PUSCH - 2 bits
  -  $\begin{matrix}SRS resource indicator ⌈ {log}_{2} ( {\sum }_{k = 1}^{{L}_{max \sum }} ( \begin{matrix}{N}_{SRS} \\ k\end{matrix} ) ( ) □□ ⌉ or ⌈ {log}_{2} ( {N}_{S R S} ) ⌉ bits * \\ ⌈ {log}_{2} ( {\sum }_{k = 1}^{{L}_{max \sum }} ( \begin{matrix}{N}_{SRS} \\ k\end{matrix} ) ( ) □□ ⌉ bits for non - codebook based PUSCH \\ transmission ;\end{matrix}$
      * ┌log₂(N_{SRS})┐ bits for codebook based PUSCH transmission.
  - Precoding information and number of layers - up to 6 bits
  - Antenna ports - up to 5 bits
  - SRS request - 2 bits
  - Channel state information (CSI) request - 0, 1, 2, 3, 4, 5, or 6 bits
  - Code block group (CBG) transmission information - 0, 2, 4, 6, or 8 bits
  - Phase tracking reference signal (PTRS)-demodulation reference signal
(DDMRS) association - 0 or 2 bits.
  - beta_offset indicator - 0 or 2 bits
  - DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

```
TABLE 6
  - Identifier for DCI formats - [1] bit
  - Frequency domain resource assignment - [┌log₂( N_{RB}^{DL,BWP}(N_{RB}^{DL,BWP} + 1)/2)┐ ]
bits
  - Time domain resource assignment - X bits
  - VRB-to-PRB mapping - 1 bit.
  - Modulation and coding scheme - 5 bits
  - New data indicator - 1 bit
  - Redundancy version - 2 bits
  - HARQ process number - 4 bits
  - Downlink assignment index - 2 bits
  - TPC command for scheduled PUCCH - [2] bits
  - Physical uplink control channel (PUCCH) resource indicator - 3 bits
  - PDSCH-to-HARQ feedback timing indicator - [3] bits
```

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |
| | * For resource allocation type 0, ┌N_{RB}^{DL,BWP} /P┐ bits |
| | * For resource allocation type 1, [log₂( N_{RB}^{DL,BWP}(N_{RB}^{DL,BWP} + 1/2)┐ bits |
| - | Time domain resource assignment -1, 2, 3, or 4 bits |
| - | VRB-to-PRB mapping - 0 or 1 bit, only for resource allocation type 1. |
| | * 0 bit if only resource allocation type 0 is configured; |
| | * 1 bit otherwise. |
| - | Physical resource block (PRB) bundling size indicator - 0 or 1 bit |
| - | Rate matching indicator - 0, 1, or 2 bits |
| - | Zero power (ZP) channel state information (CSI)-reference signal (RS) trigger - |

0, 1, or 2 bits
For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDCCH: CORESET, REG, CCE, and Search Space]

Hereinafter, a downlink control channel in a 5G communication system will be described in more detail with reference to the accompanying drawings.

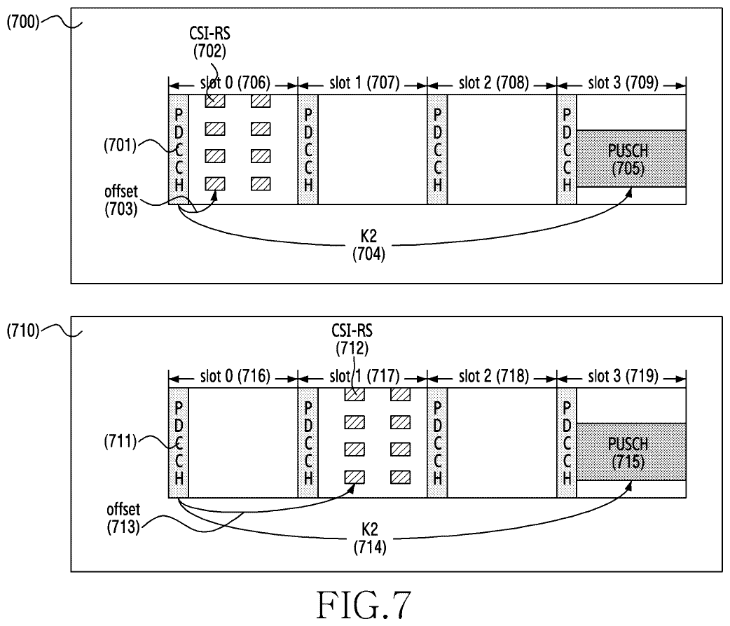

FIG. 7 illustrates an example of a control resource set (CORESET) used to transmit a downlink control channel in a 5G wireless communication system. FIG. 7 illustrates an example in which a UE bandwidth part 710 is configured along the frequency axis, and two control resource sets (control resource set #1 701 and control resource set #2 702) are configured within one slot 720 along the time axis. The control resource sets 701 and 702 may be configured in a specific frequency resource 703 within the entire UE bandwidth part 710 along the frequency axis. Control resource set #1 701 and control resource set #2 702 may be each configured as one or multiple OFDM symbols along the time domain, and the number of the OFDM symbols may be defined as a control resource set duration 704. Referring to the example illustrated in FIG. 7, control resource set #1 701 is configured to have a control resource set duration corresponding to two symbols, and control resource set #2 702 is configured to have a control resource set duration corresponding to one symbol.

A control resource set in 5G described above may be configured for a U by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, this information may include the following pieces of information given in Table 8 below.

TABLE 8

| ControlResourceSet ::= | SEQUENCE { |
|---|---|
| -- Corresponds to L1 parameter ‘CORESET-ID’ | |
| controlResourceSetId | ControlResourceSetId, |
| (control resource set identity) | |
| frequencyDomainResources | BIT STRING (SIZE (45)), |
| (frequency domain resource assignment information) | |
| duration | INTEGER (1..maxCoReSetDuration), |
| (time domain resource assignment information) | |
| cce-REG-MappingType | CHOICE { |
| (CCE-to-REG mapping type) | |
| interleaved | SEQUENCE { |
| reg-BundleSize | ENUMERATED {n2, n3, n6}, |
| (REG bundle size) | |
| precoderGranularity | ENUMERATED {sameAsREG-bu |
| ndle, allContiguousRBs}, | |
| interleaverSize | ENUMERATED {n2, n3, n6} |
| (interleaver size) | |
| shiftIndex | INTEGER(0..maxNrofPhysicalResour |
| ceBlocks-1) | OPTIONAL |
| (interleaver shift) | |
| }, | |
| nonInterleaved | NULL |
| }, | |
| tci-StatesPDCCH | SEQUENCE(SIZE (1..maxNrofTCI-States |
| PDCCH)) OF TCI-StateId | OPTIONAL, |
| (QCL configuration information) | |
| tci-PresentInDCI | ENUMERATED {enabled} |

```
          OPTIONAL, ... Need S
  }
```

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding CORESET.

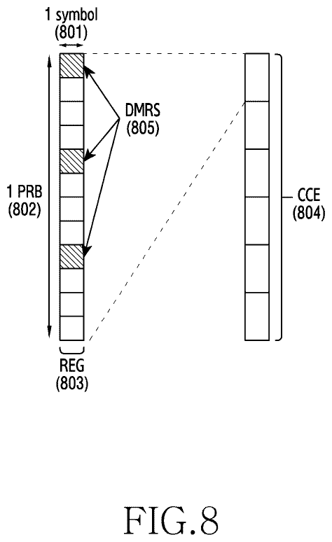

FIG. 8 illustrates an example of a basic unit of time and frequency resources constituting a downlink control channel available in a 5G system. According to FIG. 8, the basic unit of time and frequency resources constituting a control channel may be referred to as a resource element group (REG) 803, and the REG 803 may be defined by one OFDM symbol 801 along the time axis and one physical resource block (PRB) 802, that is, 12 subcarriers, along the frequency axis. The base station may configure a downlink control channel allocation unit by concatenating the REGs 803.

Provided that the basic unit of downlink control channel allocation in 5G is a control channel element 804 as illustrated in FIG. 8, one CCE 804 may include multiple REGs 803. To describe the REG 803 illustrated in FIG. 5, for example, the REG 803 may include 12 REs, and if one CCE 804 includes six REGs 803, one CCE 804 may then include 72 REs. A downlink control resource set, once configured, may include multiple CCEs 804, and a specific downlink control channel may be mapped to one or multiple CCEs 804 and then transmitted according to the aggregation level (AL) in the control resource set. The CCEs 804 in the control resource set are distinguished by numbers, and the numbers of CCEs 804 may be allocated according to a logical mapping scheme.

The basic unit of the downlink control channel illustrated in FIG. 8, that is, the REG 803, may include both REs to which DCI is mapped, and an area to which a reference signal (DMRS 805) for decoding the same is mapped. As in FIG. 8, three DRMSs 803 may be transmitted inside one REG 805. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs may be defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the U.

In 5G, parameters for a search space regarding a PDCCH may be configured for the UE by the base station through upper layer signaling (for example, SIB, MIB, or RRC signaling). For example, the base station may provide the U with configurations such as the number of PDCCH candidates at each aggregation level L, the monitoring cycle regarding the search space, the monitoring occasion with regard to each symbol in a slot regarding the search space, the search space type (common search space or U-specific search space), a combination of an RNTI and a DCI format to be monitored in the corresponding search space, a control resource set index for monitoring the search space, and the like. For example, the information configured for the UE by the base station may include the following pieces of information in Table 9 below.

TABLE 9

| | |
|---|---|
| SearchSpace ::= | SEQUENCE { |

-- Identity of the search space. SearchSpaceId = 0 identifies the SearchSpace configured vi
a PBCH (MIB) or ServingCellConfigCommon.

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

```
    }
          OPTIONAL,
```

| | |
|---|---|
| duration (monitoring duration) | INTEGER (2..2559) |

| | |
|---|---|
| monitoringSymbolsWithinSlot | BIT STRING (SIZE (14)) |

OPTIONAL,

(monitoring symbols within slot)

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, |

n8},

| | |
|---|---|
| aggregationLevel2 | ENUMERATED {n0, n1, n2, n3, n4, n5, n6, |

n8},

| | |
|---|---|
| aggregationLevel4 | ENUMERATED {n0, n1, n2, n3, n4, n5, n6, |

n8},

| | |
|---|---|
| aggregationLevel8 | ENUMERATED {n0, n1, n2, n3, n4, n5, n6, |

n8},

| | |
|---|---|
| aggregationLevel16 | ENUMERATED {n0, n1, n2, n3, n4, n5, n6, |

n8}
},

| | |
|---|---|
| search Space Type | CHOICE { |

```
    (search space type)
      -- Configures this search space as common search space (CSS) and DCI formats to
monitor.
```

| | |
|---|---|
| common | SEQUENCE { |

```
    (common search space)
  }
```

| | |
|---|---|
| ue-Specific | SEQUENCE { |

```
    (UE-specific search space)
        -- Indicates whether the UE monitors in this USS for DCI formats 0-0 and 1-0 or for
formats 0-1 and 1-1.
```

| | |
|---|---|
| formats | ENUMERATED {formats0-0-And-1-0, for |

mats0-1-And-1-1},
...
}

According to configuration information, the base station may configure one or multiple search space sets for the UE. According to an embodiment, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Of course, the combinations of DCI formats and RNTIs monitored in a common search space are not limited to the examples given below:
DCI format 0_0/1_0 with CRC scrambled by C-RNTI, CS-RNTI, SP-CSI-RNTI, RA-RNTI, TC-RNTI, P-RNTI, SI-RNTI;
DCI format 2_0 with CRC scrambled by SFI-RNTI;
DCI format 2_1 with CRC scrambled by INT-RNTI;
   DCI format 2_2 with CRC scrambled by TPC-PUSCH-RNTI, TPC-PUCCH-RNTI; and/or
DCI format 2_3 with CRC scrambled by TPC-SRS-RNTI.

Combinations of DCI formats and RNTIs given below may be monitored in a UE-specific search space. Obviously, the examples given below are not limiting:
DCI format 0_0/1_0 with CRC scrambled by C-RNTI, CS-RNTI, TC-RNTI; and/or
DCI format 1_0/1_1 with CRC scrambled by C-RNTI, CS-RNTI, TC-RNTI.

Enumerated RNTIs may follow the definition and usage given below:
Cell RNTI (C-RNTI): used to schedule a UE-specific PDSCH;
Temporary cell RNTI (TC-RNTI): used to schedule a UE-specific PDSCH;
Configured scheduling RNTI (CS-RNTI): used to schedule a semi-statically configured UE-specific PDSCH;
Random access RNTI (RA-RNTI): used to schedule a PDSCH in a random access step;
Paging RNTI (P-RNTI): used to schedule a PDSCH in which paging is transmitted;
System information RNTI (SI-RNTI): used to schedule a PDSCH in which system information is transmitted;
Interruption RNTI (INT-RNTI): used to indicate whether a PDSCH is punctured;
Transmit power control for PUSCH RNTI (TPC-PUSCH-RNTI): used to indicate a power control command regarding a PUSCH;
Transmit power control for PUCCH RNTI (TPC-PUCCH-RNTI): used to indicate a power control command regarding a PUCCH; and/or
Transmit power control for SRS RNTI (TPC-SRS-RNTI): used to indicate a power control command regarding an SRS.

The DCI formats enumerated above may follow the definitions given in Table 10 below, for example.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In 5G, the search space at aggregation level L in connection with CORESET p and search space set s may be expressed by Equation 1 below.

$$L \cdot \{ ( {Y}_{p , {n}_{s , f}^{µ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

$$L \text{:} aggregation level ;$$

$${N}_{CI} : carrier index ;$$

$${N}_{CCE , p} : total number of CCEs existing in control resource set p ;$$

$${n}_{s , f}^{µ} : slot index ;$$

$${M}_{s , max}^{( L )} : number of PDCCH candidates at aggregation level L ;$$

$${m}_{s , {n}_{CI}} = 0 , … , {M}_{s , max}^{( L )} - 1 : PDCCH candidates at aggregation level L ;$$

$$i = 0 , … , L - 1 ;$$

$${Y}_{p , {n}_{s , f}^{µ}} = ( {A}_{p} \cdot {Y}_{p , {n}_{s , f}^{µ} - 1} ) mod D , {Y}_{p , - 1} = {n}_{RNTI} \neq 0 , {A}_{p} = 39827 for pmod 3 = 0 , {A}_{p} = 39829 for pmod 3 = 1 , {A}_{p} = 39839 for pmod 3 = 2 , D = 65537 ; and$$

$${n}_{RNTI} : UE identity .$$

The

$${Y}_{p , {n}_{s , f}^{μ}}$$

value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [PUCCH: Regarding Transmission]

In an NR system, a UE may transmit control information (UCI) to a base station through a PUCCH. The control information may include at least one of a HARQ-ACK indicating whether the UE has succeeded in demodulating/decoding a transport block (TB) having been received through a PDSCH, a scheduling request (SR) through which the UE requests a PUSCH base station to allocate resources for uplink data transmission, and channel state information (CSI) that is information for reporting a channel state of the UE.

PUCCH resources may be generally classified as for a long PUCCH and a short PUCCH according to the length of allocated symbols. In an NR system, a long PUCCH has a length of 4 or more symbols in a slot, and a short PUCCH has a length of 2 or less symbols in a slot.

In a more detailed description of a long PUCCH, a long PUCCH may be used for the purpose of increasing uplink cell coverage, and thus may be transmitted in a DFT-S-OFDM scheme relating to single carrier transmission rather than OFDM transmission. A long PUCCH supports transmission formats, such as PUCCH format 1, PUCCH format 3, and PUCCH format 4, according to the number of supportable control information bits, and support or nonsupport of UE multiplexing through pre-DFT OCC support at an IFFT front end.

First, PUCCH format 1 is a DFT-S-OFDM-based long PUCCH format capable of supporting control information up to 2 bits, and uses as many frequency resources as 1 RB. The control information may be configured by a HARQ-ACK, an SR, or a combination thereof. PUCCH format 1 has a structure in which an OFDM symbol including a demodulation reference signal (DMRS) that is a demodulation reference signal (or reference signal) and an OFDM symbol including UCI are repeated.

For example, if the number of transmission symbols of PUCCH format 1 is 8, the 8 symbols may be configured by a DMRS symbol, a UCI symbol, a DMRS symbol, a UCI symbol, a DMRS symbol, a UCI symbol, a DMRS symbol, and a UCI symbol sequentially starting from the first starting symbol. DMRS symbols may be spread using an orthogonal code (or orthogonal sequence or spreading code, wᵢ(m)) on the time axis for a sequence corresponding to the length of 1 RB on the frequency axis in one OFDM symbol, may be subject to IFFT, and then be transmitted.

In relation to UCI symbols, the UE may perform BPSK modulation of 1-bit control information or QPSK modulation of 2-bit control information to generate d(0), multiply the generated d(0) by a sequence corresponding to the length of 1 RB on the frequency axis to scramble same, spread the scrambled sequence by using an orthogonal code (or orthogonal sequence or spreading code, wᵢ(m)) on the time axis, perform IFFT of the spread sequence, and then transmit same.

The UE generates a sequence, based on a group hopping or sequence hopping configuration and a configured ID configured by the base station through higher layer signaling, and performs a cyclic shift of the generated sequence by using an initial cyclic shift (CS) value configured through a higher signal to generate a sequence corresponding to the length of 1 RB.

wᵢ(m) is determined such as

$${w}_{i} ( m ) = {e}^{\frac{j 2 πφ ( m )}{{N}_{SF}}}$$

when the length (NSF) of a spreading code is given and, specifically, is given as shown in [Table 11] below. i means the index of the spreading code itself, and m denotes the index of each element of the spreading code. Herein, the numbers in the square brackets [ ] in [Table 11] indicate φ(m), and if the length of a spreading code is 2 and the configured index i of the spreading code is 0 (i=0), the spreading code wᵢ(m) becomes wᵢ(0)=e^{j2π·0/N}^{_{SF}}=1 and wᵢ(1)=e^{j2π·0/N}^{_{SF}}=1 and thus wᵢ(m) is equal to [1 1].

TABLE 11
Spreading code wᵢ(m) = e^{j2πφ(m)/N}^{_{SF}} for PUCCH format 1

| | φ(m) | | | | | | |
|---|---|---|---|---|---|---|---|
| N_{SF} | i = 0 | i = 1 | i = 2 | i = 3 | i = 4 | i = 5 | i = 6 |
| 1 | [0] | | | | | | |
| 2 | [0 0] | [0 1] | | | | | |
| 3 | [0 0 0] | [0 1 2] | [0 2 1] | | | | |
| 4 | [0 0 0 0] | [0 2 0 2] | [0 0 2 2] | [0 2 2 0] | | | |
| 5 | [0 0 0 0 0] | [0 1 2 3 4] | [0 2 4 1 3] | [0 3 1 4 2] | [0 4 3 2 1] | | |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | |
| 7 | [0 0 0 0 0 0 | [0 1 2 3 4 5 | [0 2 4 6 1 3 | [0 3 6 2 5 1 | [0 4 1 5 2 6 | [0 5 3 1 6 4 | [0 6 5 4 3 2 |
| | 0 0] | 6] | 5] | 4] | 3] | 2] | 1] |

Next, PUCCH format 3 is a DFT-S-OFDM-based long PUCCH format capable of supporting control information greater than 2 bits, and the number of used RBs is configurable through a higher layer. The control information may be configured by a combination or each of a HARQ-ACK, an SR, and CSI. DMRS symbol positions in PUCCH format 3 are present in [Table 12] below according to whether there is frequency hopping in a slot, and whether an additional DMRS symbol is configured.

TABLE 12

| | DMRS position in transmission of PUCCH format 3/4 | | | |
|---|---|---|---|---|
| | Additional DMRS | | Additional DMRS | |
| Transmission | not configured | | configured | |
| length of | Frequency | Frequency | Frequency | Frequency |
| PUCCH | hopping not | hopping | hopping not | hopping |
| format 3/4 | configured | configured | configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

If the number of transmission symbols of PUCCH format 3 is 8, a DMRS is transmitted on a first symbol and a fifth symbol when the 0-th symbol is used as the first starting symbol of the 8 symbols. [Table 12] is applied even to DMRS symbol positions of PUCCH format 4 in the same way.

Next, PUCCH format 4 is a DFT-S-OFDM-based long PUCCH format capable of supporting control information greater than 2 bits, and uses as many frequency resources as 1 RB. The control information may be configured by a combination or each of a HARQ-ACK, an SR, and CSI. The difference between PUCCH format 4 and PUCCH format 3 is that, in a case of PUCCH format 4, PUCCH formats 4 of several UEs are multiplexable in one RB. It is possible to multiplex PUCCH formats 4 of multiple UEs through pre-DFT orthogonal cover code (OCC) application to control information at an IFFT front end. However, the number of control information symbols transmittable by one UE is reduced according to the number of multiplexed UEs. The number of multiplexable UEs, that is, the number of available different OCCs may be 2 or 4, and the number of OCCs and OCC indexes to be applied may be configured through a higher layer.

Next, short PUCCHs are described. A short PUCCH may be transmitted on both a downlink-centric slot and an uplink-centric slot, and in general, may be transmitted on the last symbol of a slot or an OFDM symbol positioned in a back part (e.g., the last OFDM symbol, the second last OFDM symbol, or the last two OFDM symbols). It is also possible for a short PUCCH to be transmitted on a random position in a slot. A short PUCCH may be transmitted using one OFDM symbol or two OFDM symbols. A short PUCCH may be used to shorten a delay time, compared to a long PUCCH, in a situation where uplink cell coverage is good, and may be transmitted in a CP-OFDM scheme.

A short PUCCH may support transmission formats, such as PUCCH format 0 and PUCCH format 2, according to the number of supportable control information bits. First, PUCCH format 0 is a short PUCCH format capable of supporting control information up to 2 bits, and uses as many frequency resources as 1 RB. The control information may be configured by a combination or each of a HARQ-ACK and an SR. PUCCH format 0 has a structure of not transmitting a DMRS and transmitting only a sequence mapped to 12 subcarriers on the frequency axis in one OFDM symbol. The UE may generate a sequence, based on a group hopping or sequence hopping configuration and a configured ID configured by the base station through a higher signal, perform a cyclic shift (CS) of the generated sequence by using a final CS value obtained after adding, to an indicated initial CS value, a CS value varying according to an ACK or NACK, map the sequence to 12 subcarriers, and transmit the mapped sequence.

For example, in a case where a HARQ-ACK has 1 bit, as shown in [Table 13] below, if the HARQ-ACK is an ACK, the UE may generate the final CS by adding 6 to the initial CS value, and if the HARQ-ACK is a NACK, the UE may generate the final CS by adding 0 to the initial CS. The value of 0 that is a CS value for NACK and the value of 6 that is a CS value for ACK are defined in a specification, and the UE may generate PUCCH format 0 according to the values defined in the specification to transmit a 1-bit HARQ-ACK.

TABLE 13

| 1-bit HARQ-ACK | NACK | ACK |
|---|---|---|
| Final CS | (initial CS + 0) | (initial CS + 6) |
| | mod 12 = | mod 12 |
| | initial CS | |

For example, in a case where a HARQ-ACK has 2 bits, as shown in [Table 1] below, the UE may add 0 to the initial CS value if the HARQ-ACK is (NACK, NACK), add 3 to the initial CS value if the HARQ-ACK is (NACK, ACK), add 6 to the initial CS value if the HARQ-ACK is (ACK, ACK), and add 9 to the initial CS value if the HARQ-ACK is (ACK, NACK). The value of 0 that is a CS value for (NACK, NACK), the value of 3 that is a CS value for (NACK, ACK), the value of 6 that is a CS value for (ACK, ACK), and the value of 9 that is a CS value for (ACK, NACK) are defined in a specification, and the UE may generate PUCCH format 0 according to the values defined in the specification to transmit a 2-bit HARQ-ACK. If the final CS value exceeds 12 due to the CS value added to the initial CS value according to an ACK or NACK, since length of the sequence is 12, modulo 12 may be applied to the final CS value.

TABLE 14

| 2-bit | NACK, | NACK, | ACK, | ACK, |
|---|---|---|---|---|
| HARQ-ACK | NACK | ACK | ACK | NACK |
| Final CS | (initial CS + 0) | (initial | (initial | (initial |
| | mod 12 = | CS + 3) | CS + 6) | CS + 9) |
| | initial CS | mod 12 | mod 12 | mod 12 |

Next, PUCCH format 2 is a short PUCCH format supporting control information greater than 2 bits, and the number of used RBs may be configured through a higher layer. The control information may be configured by a combination or each of a HARQ-ACK, an SR, and CSI. If the index of a first subcarrier is #0, PUCCH format 2 may be fixed to subcarriers having indexes of #1, #4, #7, and #10 as the positions of subcarriers on which a DMRS is transmitted in one OFDM symbol. The control information may undergo channel coding and then a modulation process to be mapped to the remaining subcarriers except the subcarriers on which the DMRS is positioned.

In summary, configurable values for each PUCCH format described above and the ranges thereof may be organized as shown in [Table 15] below. Values not required to be configured are represented by N.A. in [Table 15] below.

TABLE 15

| | | PUCCH | PUCCH | PUCCH | PUCCH | PUCCH |
|---|---|---|---|---|---|---|
| | | Format 0 | Format 1 | Format 2 | Format 3 | Format 4 |
| Starting | Configurability | ✓ | ✓ | ✓ | ✓ | ✓ |
| symbol | Value range | 0-13 | 0-10 | 0-13 | 0-10 | 0-10 |
| Number of | Configurability | ✓ | ✓ | ✓ | ✓ | ✓ |
| symbols | Value range | 1, 2 | 4-14 | 1, 2 | 4-14 | 4-14 |
| in a slot | | | | | | |
| Index for | Configurability | ✓ | ✓ | ✓ | ✓ | ✓ |
| identifying | Value range | 0-274 | 0-274 | 0-274 | 0-274 | 0-274 |
| starting | | | | | | |
| PRB | | | | | | |
| Number | Configurability | N.A. | N.A. | ✓ | ✓ | N.A. |
| of PRBs | Value range | N.A. | N.A. | 1-16 | 1-6, 8-10, | N.A. |
| | | (Default | (Default | | 12, 15, 16 | (Default |
| | | is 1) | is 1) | | | is 1) |
| Enabling | Configurability | ✓ | ✓ | ✓ | ✓ | ✓ |
| frequency | Value range | On/Off | On/Off | On/Off | On/Off | On/Off |
| hopping | | (only | | (only | | |
| (intra- | | for 2 | | for 2 | | |
| slot) | | symbols) | | symbols) | | |
| Frequency | Configurability | ✓ | ✓ | ✓ | ✓ | ✓ |
| resource | Value range | 0-274 | 0-274 | 0-274 | 0-274 | 0-274 |
| of 2^{nd} | | | | | | |
| hop if | | | | | | |
| intra-slot | | | | | | |
| frequency | | | | | | |
| hopping is | | | | | | |
| enabled | | | | | | |
| Index of | Configurability | ✓ | ✓ | N.A. | N.A. | N.A. |
| initial | Value range | 0-11 | 0-11 | N.A. | N.A. | N.A. |
| cyclic | | | | | | |
| shift | | | | | | |
| Index of | Configurability | N.A. | 1 | N.A. | N.A. | N.A. |
| time- | Value range | N.A. | 0-6 | N.A. | N.A. | N.A. |
| domain | | | | | | |
| OCC | | | | | | |
| Length of | Configurability | N.A. | N.A. | N.A. | N.A. | ✓ |
| Pre-DFT OCC | Value range | N.A. | N.A. | N.A. | N.A. | 2, 4 |
| Index of | Configurability | N.A. | N.A. | N.A. | N.A. | ✓ |
| Pre-DFT OCC | Value range | N.A. | N.A. | N.A. | N.A. | 0, 1, 2, 3 |

For uplink coverage improvement, multi-slot repeated transmission may be supported for PUCCH formats 1, 3, and 4, and PUCCH repeated transmission may be configured for each PUCCH format. The UE may perform repeated transmission of a PUCCH including UCI as many times as the number of slots configured through the higher layer signaling nrofSlots. For PUCCH repeated transmission, a PUCCH transmission on each slot is performed using the same number of consecutive symbols, and the number of consecutive symbols may be configured through nrofSymbols in the higher layer signaling PUCCH-format1, PUCCH-format3, or PUCCH-format4. For PUCCH repeated transmission, a PUCCH transmission on each slot is performed using the same starting symbol, and the starting symbol may be configured through startingSymbolIndex in the higher layer signaling PUCCH-format1, PUCCH-format3, or PUCCH-format4. For PUCCH repeated transmission, single PUCCH-spatialRelationlnfo may be configured for a single PUCCH resource. For PUCCH repeated transmission, if the UE is configured to perform frequency hopping between PUCCH transmissions on different slots, the UE may perform frequency hopping in a unit of a slot. In addition, if the UE is configured to perform frequency hopping between PUCCH transmissions on different slots, the UE may start a PUCCH transmission on an even-numbered slot at a first PRB index configured through the higher layer signaling startingPRB, and start a PUCCH transmission on an odd-numbered slot at a second PRB index configured through the higher layer signaling secondHopPRB. Additionally, if the UE is configured to perform frequency hopping between PUCCH transmissions on different slots, the index of a slot indicated for the UE to perform a first PUCCH transmission thereon is 0, and through a configured entire PUCCH repeated transmission count, a PUCCH repeated transmission count value may be increased independently of whether PUCCH transmission is performed on each slot. If the UE is configured to perform frequency hopping between PUCCH transmissions on different slots, the UE does not expect that frequency hopping in a slot at the time of PUCCH transmission is configured. If performing frequency hopping between PUCCH transmissions on different slots is not configured for the UE and frequency hopping in a slot is configured, the first and second PRB indexes may also be identically applied in the slot. If the number of uplink symbols on which PUCCH transmission is possible is smaller than a number indicated by nrofSymbols configured through higher layer signaling, the UE may not transmit a PUCCH. Even if the UE has failed PUCCH transmission on a slot for a reason during PUCCH repeated transmission, the UE may increase the PUCCH repeated transmission count.

In NR Release 17, the number of slots for repeated transmission of each PUCCH resource in PUCCH-ResourceExt that is an expansion of the higher layer signaling PUCCH-Resource for PUCCH resources may be configured through the higher layer signaling pucch-RepetitionNrofSlots-r17. If the higher layer signaling pucch-RepetitionNrofSlots-r17 is configured, a corresponding PUCCH is configured, and the higher layer signaling nrofSlots is also configured, the UE may determine the number of slots on which the corresponding PUCCH is repeatedly transmitted through pucch-RepetitionNrofSlots-r17, and disregard the higher layer signaling nrofSlots.

### [PUCCH: PUCCH Resource Configuration]

Next, a PUCCH resource configuration of a base station or a UE is described. The base station may be able to configure a PUCCH resource for each BWP for a particular UE through a higher layer. A PUCCH resource configuration may be as shown in [Table 16] below.

TABLE 16

| | |
|---|---|
| PUCCH-Config ::= | SEQUENCE { |

| | |
|---|---|
| resourceSetToAddModList | SEQUENCE (SIZE (1..maxNrofPUCCH-ResourceSets)) OF |

| | |
|---|---|
| PUCCH-ResourceSet | OPTIONAL, -- Need N |

| | |
|---|---|
| resourceSetToReleaseList | SEQUENCE (SIZE (1..maxNrofPUCCH-ResourceSets)) OF |

PUCCH-ResourceSetId OPTIONAL, -- Need N

| | |
|---|---|
| resource ToAddModList | SEQUENCE (SIZE (1..maxNrofPUCCH-Resources)) OF |

| | |
|---|---|
| PUCCH-Resource | OPTIONAL, -- Need N |

| | |
|---|---|
| resourceToReleaseList | SEQUENCE (SIZE (1..maxNrofPUCCH-Resources)) OF |

| | |
|---|---|
| PUCCH-ResourceId | OPTIONAL, -- Need N |

| | | |
|---|---|---|
| format1 | SetupRelease { PUCCH-FormatConfig } | OPTIONAL, -- Need M |
| format2 | SetupRelease { PUCCH-FormatConfig } | OPTIONAL, -- Need M |
| format3 | SetupRelease { PUCCH-FormatConfig } | OPTIONAL, -- Need M |
| format4 | SetupRelease { PUCCH-FormatConfig } | OPTIONAL, -- Need M |

schedulingRequestResourceToAddModList SEQUENCE (SIZE (1..maxNrofSR-Resources))

| | |
|---|---|
| OF SchedulingRequestResourceConfig | OPTIONAL, -- Need N |

schedulingRequestResourceToReleaseList SEQUENCE (SIZE (1..maxNrofSR-Resources))

| | |
|---|---|
| OF SchedulingRequestResourceId | OPTIONAL, -- Need N |

| | |
|---|---|
| multi-CSI-PUCCH-ResourceList | SEQUENCE (SIZE (1..2)) OF PUCCH-ResourceId |

OPTIONAL, -- Need M

| | | |
|---|---|---|
| dl-DataToUL-ACK | SEQUENCE (SIZE (1..8)) OF INTEGER (0..15) | OPTIONAL, -- |

Need M

| | |
|---|---|
| spatialRelationInfoToAddModList | SEQUENCE (SIZE (1..maxNrofSpatialRelationInfos)) |

| | |
|---|---|
| OF PUCCH-SpatialRelationInfo | OPTIONAL, -- Need N |

| | |
|---|---|
| spatialRelationInfoToReleaseList | SEQUENCE (SIZE (1..maxNrofSpatialRelationInfos)) OF |

| | |
|---|---|
| PUCCH-SpatialRelationInfoId | OPTIONAL, -- Need N |

| | | |
|---|---|---|
| pucch-PowerControl | PUCCH-PowerControl | OPTIONAL, -- Need M |

```
  ...,
  [[
```

| | |
|---|---|
| resourceToAddModListExt-r16 | SEQUENCE (SIZE (1..maxNrofPUCCH-Resources)) OF |

PUCCH-ResourceExt-r16 OPTIONAL, -- Need N

| | | |
|---|---|---|
| dl-DataToUL-ACK-r16 | SetupRelease { DL-DataToUL-ACK-r16 } | OPTIONAL, -- Need |

M

| | |
|---|---|
| ul-AccessConfigListDCI-1-1-r16 | SetupRelease { UL-AccessConfigListDCI-1-1-r16 } |

OPTIONAL, -- Need M

| | |
|---|---|
| subslotLengthForPUCCH-r16 | CHOICE { |

| | |
|---|---|
| normalCP-r16 | ENUMERATED {n2,n7}, |
| extendedCP-r16 | ENUMERATED {n2,n6} |
| } | OPTIONAL, -- Need R |

| | |
|---|---|
| dl-DataToUL-ACK-DCI-1-2-r16 | SetupRelease { DL-DataToUL-ACK-DCI-1-2-r16} |

OPTIONAL, -- Need M

| | |
|---|---|
| numberOfBitsForPUCCH-ResourceIndicatorDCI-1-2-r16 INTEGER (0..3) | OPTIONAL, - |

- Need R

| | |
|---|---|
| dmrs-UplinkTransformPrecodingPUCCH-r16 ENUMERATED {enabled} | OPTIONAL, -- |

Cond PI2-BPSK

| | | |
|---|---|---|
| spatialRelationInfoToAddModListSizeExt-v1610 | SEQUENCE | (SIZE |

| | |
|---|---|
| (1..maxNrofSpatialRelationInfosDiff-r16)) OF | PUCCH-SpatialRelationInfo |

OPTIONAL, -- Need N

| | | |
|---|---|---|
| spatialRelationInfoToReleaseListSizeExt-v1610 | SEQUENCE | (SIZE |

| | |
|---|---|
| (1..maxNrofSpatialRelationInfosDiff-r16)) OF | PUCCH-SpatialRelationInfoId |

OPTIONAL, -- Need N

| | | |
|---|---|---|
| spatialRelationInfoToAddModListExt-v1610 | SEQUENCE | (SIZE |

| | |
|---|---|
| (1..maxNrofSpatialRelationInfos-r16)) OF | PUCCH-SpatialRelationInfoExt-r16 |

OPTIONAL, -- Need N

| | | |
|---|---|---|
| spatialRelationInfoToReleaseListExt-v1610 | SEQUENCE | (SIZE |

| | |
|---|---|
| (1..maxNrofSpatialRelationInfos-r16)) OF PUCCH-SpatialRelationInfoId-r16 | OPTIONAL, - |

- Need N

| | |
|---|---|
| resourceGroupToAddModList-r16 | SEQUENCE (SIZE (1..maxNrofPUCCH- |

| | |
|---|---|
| ResourceGroups-r16)) OF PUCCH-ResourceGroup-r16 | OPTIONAL, -- Need |

N

| | |
|---|---|
| resourceGroupToReleaseList-r16 | SEQUENCE (SIZE (1..maxNrofPUCCH- |

| | |
|---|---|
| ResourceGroups-r16)) OF PUCCH-ResourceGroupId-r16 | OPTIONAL, -- Need |

N

| | | |
|---|---|---|
| sps-PUCCH-AN-List-r16 | SetupRelease { SPS-PUCCH-AN-List-r16 } | OPTIONAL, -- |

Need M

| | |
|---|---|
| schedulingRequestResourceToAddModListExt-v1610 | SEQUENCE (SIZE (1..maxNrofSR- |

| | |
|---|---|
| Resources)) OF SchedulingRequestResourceConfigExt-v1610 | OPTIONAL -- Need |

N
]]
}

According to [Table 16], one or multiple PUCCH resource sets may be configured in a PUCCH resource configuration for a particular BWP, and a maximum payload value for UCI transmission may be configured for some of the PUCCH resource sets. One or multiple PUCCH resources may belong to each PUCCH resource set, and each PUCCH resource may belong to one of the PUCCH formats described above.

With respect to the PUCCHresource sets, a maximumpayload value of the first PUCCH resource set may be fixed to 2 bits. Accordingly, the value may not be separately configuredthrough ahigherlayer. Ifthe remaining PUCCHresource sets are configured, the index of a corresponding PUCCH resource set may be configured in an ascending order according to the maximum payload value, and no maximum payload value may be configured for the last PUCCH resource set. A higher layer configuration for a PUCCH resource set may be as shown in [Table 17] below.

TABLE 17

| | |
|---|---|
| PUCCH-ResourceSet ::= | SEQUENCE { |
| pucch-ResourceSetId | PUCCH-ResourceSetId, |

| | |
|---|---|
| resourceList | SEQUENCE (SIZE (1..maxNrofPUCCH-ResourcesPerSet)) OF |

PUCCH-ResourceId,

| | |
|---|---|
| maxPayloadSize | INTEGER (4..256) OPTIONAL -- Need R |

}

The parameter resourceList in [Table 17] may include IDs of PUCCH resources belonging to a PUCCH resource set.

At the time of initial access, or if a PUCCH resource set is not configured, a PUCCH resource set, as shown in [Table 18] below, configured by multiple PUCCH resources which are cell-specific in an initial BWP, may be used. A PUCCH resource to be used for initial access in the PUCCH resource set may be indicated through SIB1.

TABLE 18

| | PUCCH | First | Number of | PRB offset | Set of initial |
|---|---|---|---|---|---|
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | N_{BWP}^{size} / 4 | {0, 3, 6, 9} |

A maximum payload of each of PUCCH resources included in the PUCCH resource set may be 2 bits in a case of PUCCH format 0 or 1, and may be determined according to a symbol length, the number of PRBs, and a maximum code rate in a case of the remaining formats. The symbol length and the number of PRBs may be configured for each PUCCH resource, and the maximum code rate may be configured for each PUCCH format.

Next, PUCCH resource selection for UCI transmission is described. In a case of SRtransmission, a PUCCH resource for an SR corresponding to schedulingRequestID as shown in [Table 19] below may be configured through a higher layer. The PUCCH resource may be a resource belonging to PUCCH format 0 or PUCCH format 1.

TABLE 19

| | |
|---|---|
| SchedulingRequestResourceConfig ::= | SEQUENCE { |

| | |
|---|---|
| schedulingRequestResourceId | SchedulingRequestResourceId, |

| | |
|---|---|
| schedulingRequestID | SchedulingRequestId, |
| periodicity AndOffset | CHOICE { |

| sym2 | NULL, | |
|---|---|---|
| sym6or7 | NULL, | |
| sl1 | NULL, | -- Recurs in every slot |

| | |
|---|---|
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |

| | |
|---|---|
| } | OPTIONAL, -- Need M |

| | | |
|---|---|---|
| resource | PUCCH-ResourceId | OPTIONAL -- Need M |

}

A transmission period and an offset of the configured PUCCH resource may be configured through the parameter periodicityAndOffset in [Table 19]. If there is uplink data to be transmitted by the UC at a time point corresponding to the configured period and offset, the PUCCH resource is transmitted, and otherwise, the PUCCH resource may not be transmitted.

In a case of CSI transmission, a PUCCH resource on which a periodic CSI report or a semi-persistent CSI report through a PUCCH is to be transmitted may be configured in the parameter pucch-CSI-ResourceList as shown in [Table 20] below. The parameter pucch-CSI-ResourceList may include a list of PUCCH resources for each BWP for a cell or CC on which the CSI report is to be transmitted. The PUCCH resource may be a resource belonging to PUCCH format 2, PUCCH format 3, or PUCCH format 4. A transmission period and an offset of the PUCCH resource may be configured through reportSlotConfig in [Table 20].

TABLE 20

| | |
|---|---|
| CSI-ReportConfig ::= | SEQUENCE { |
| reportConfigId | CSI-ReportConfigId, |

| | | |
|---|---|---|
| carrier | ServCellIndex | OPTIONAL, -- Need S |

...

| | |
|---|---|
| reportConfigType | CHOICE { |

| | |
|---|---|
| periodic | SEQUENCE { |

| | |
|---|---|
| reportSlotConfig | CSI-ReportPeriodicityAndOffset, |

| | |
|---|---|
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |

| | |
|---|---|
| reportSlotConfig | CSI-ReportPeriodicity AndOffset, |

| | |
|---|---|
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |

| | |
|---|---|
| reportSlotConfig | ENUMERATED {sl5, sl10, sl20, sl40, sl80, sl160, sl320}, |

| | |
|---|---|
| reportSlotOffsetList | SEQUENCE (SIZE (1..maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |

| | |
|---|---|
| reportSlotOffsetList | SEQUENCE (SIZE (1..maxNrofUL-Allocations)) OF |

```
INTEGER(0..32)
    }
  },
  ...
}
```

In a case of HARQ-ACK transmission, a resource set of PUCCH resources to be transmitted may be first selected according to a payload of UCI including the HARQ-ACK. That is, PUCCH resource set having a minimum payload not smaller than that of the UCI payload may be selected. Next, a PUCCH resource in the PUCCH resource set may be selected through a PUCCH resource indicator (PRI) in DCI scheduling a TB corresponding to the HARQ-ACK, and the PRI may be a PUCCH resource indicator specified in [Table 6] or [Table 7]. A relation between a PRI and a PUCCH resource selected in the PUCCH resource set may be as shown in [Table 21] below.

TABLE 21

| PUCCH resource | |
|---|---|
| indictor | PUCCH resource |
| “000” | 1^{st} PUCCH resource provided by push-ResourceId |
| | obtained from the 1^{st} value of resourceList |
| “001” | 2^{nd} PUCCH resource provided by push-ResourceId |
| | obtained from the 2^{nd} value of resourceList |
| “010” | 3^{rd} PUCCH resource provided by push-ResourceId |
| | obtained from the 3^{rd} value of resourceList |
| “011” | 4^{th} PUCCH resource provided by push-ResourceId |
| | obtained from the 4^{th} value of resourceList |
| “100” | 5^{th} PUCCH resource provided by push-ResourceId |
| | obtained from the 5^{th} value of resourceList |
| “101” | 6^{th} PUCCH resource provided by push-ResourceId |
| | obtained from the 6^{th} value of resourceList |
| “110” | 7^{th} PUCCH resource provided by push-ResourceId |
| | obtained from the 7^{th} value of resourceList |
| “111” | 8^{th} PUCCH resource provided by push-ResourceId |
| | obtained from the 8^{th} value of resourceList |

If the number of PUCCH resources in a selected PUCCH resource set is greater than 8, a PUCCH resource may be selected by [Equation 2] below.

$${γ}_{PUCCH} = \{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ & if {Δ}_{PRI} < {R}_{PUCCH} mod 8 \\ ⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + {R}_{PUCCH} mod 8 & if {Δ}_{PRI} \geq {R}_{PUCCH} mod 8\end{matrix} \} \qquad [ Equation 2 ]$$

In [Equation 2], r_{PUCCH} denotes the index of the selected PUCCH resource in the PUCCH resource set, R_{PUCCH} denotes the number of the PUCCH resources belonging to the PUCCH resource set, Δ_{PRI} denotes a PRI value, N_{CCE,p} denotes a total number of CCEs of CORESET p to which reception DCI belongs, and n_{CCE,p} denotes the index of a first CCE for the reception DCI.

A time point at which the PUCCH resource is transmitted is a time point after K₁ slots after transmission of a TB corresponding to the HARQ-ACK. A candidate of the K₁ value is configured through a higher layer and, more specifically, may be configured in the parameter dl-DataToUL-ACK in PUCCH-Config specified in [Table 16]. One K₁ value among these candidates may be selected by a PDSCH-to-HARQ feedback timing indicator in DCI scheduling a TB, and the value may be a value specified in [Table 5] or [Table 6]. The unit of the K₁ value may be a unit of a slot or a unit of a subslot. Here, a subslot is a length unit smaller than a slot, and one subslot may be configured by one or multiple symbols.

Next, a case where two or more PUCCH resources are positioned in one slot is described. A UE may transmit UCI through one or two PUCCH resources in one slot or subslot, and when UCI is transmitted through two PUCCH resources in one slot/subslot, i) each PUCCH resource does not overlap in a unit of a symbol, and ii) at least one PUCCH resource may be a short PUCCH. The UE may not expect to transmit multiple PUCCH resources for HARQ-ACK transmission in one slot.

### [PUCCH: Regarding Transmission Beam]

Next, an uplink transmission beam configuration to be used in PUCCH transmission is described. If a UE does not have a UE-specific configuration (dedicated PUCCH resource configuration) for a PUCCH resource configuration, a PUCCH resource set is provided through the higher layer signaling pucch-ResourceCommon, and a beam configuration for PUCCH transmission follows a beam configuration used in PUSCH transmission scheduled through a random access response (RAR) UL grant. If the UE has a UE-specific configuration (dedicated PUCCH resource configuration) for a PUCCH resource configuration, a beam configuration for PUCCH transmission may be provided through the higher signaling pucch-spatialRelationInfold included in [Table 16]. If one value of pucch-spatialRelationInfold is configured for the UE, a beam configuration for PUCCH transmission of the UE may be provided through the one value of pucch-spatialRelationInfold. If multiple values of pucch-spatialRelationInfoID are configured for the UE, activation of one value of pucch-spatialRelationInfoID among the multiple values may be indicated to the UE through a MAC control element (CE). A maximum of 8 values of pucch-spatialRelationInfoID may be configured for the UE through higher signaling, and only one value of pucch-spatialRelationInfoID among the 8 values being activated may be indicated thereto. If activation of a random value of pucch-spatialRelationInfoID is indicated to the UE through a MAC CE, the UE may apply pucch-spatialRelationInfoID activation through the MAC CE starting from a slot first appearing after 3Nₛₗₒₜ^{subframe,μ}, slots after a slot transmitting a HARQ-ACK for a PDSCH transmitting the MAC CE containing activation information on pucch-spatialRelationInfoID. μ is a numerology applied to PUCCH transmission, and Nₛₗₒₜ^{subframe,μ}, indicates the number of slots per subframe at the given numerology. A higher layer configuration for pucch-spatialRelationlnfo may be as shown in [Table 22] below.

TABLE 22

| | |
|---|---|
| PUCCH-SpatialRelationInfo ::= | SEQUENCE { |
| pucch-SpatialRelationInfold | PUCCH-SpatialRelationInfoId, |

| | | |
|---|---|---|
| servingCellId | ServCellIndex | OPTIONAL, -- Need S |

| | |
|---|---|
| referenceSignal | CHOICE |

| | |
|---|---|
| ssb-Index | SSB-Index, |

| | |
|---|---|
| csi-RS-Index | NZP-CSI-RS-ResourceId, |

| | |
|---|---|
| srs | PUCCH-SRS |

},

| | |
|---|---|
| pucch-PathlossReferenceRS-Id | PUCCH-PathlossReferenceRS-Id, |

| | |
|---|---|
| p0-PUCCH-Id | P0-PUCCH-Id, |
| closedLoopIndex | ENUMERATED { i0, i1 } |

}

| | |
|---|---|
| PUCCH-SpatialRelationInfoId ::= | INTEGER (1..maxNrofSpatialRelationInfos) |

According to [Table 22], one referenceSignal configuration may exist in a particular pucch-spatialRelationlnfo configuration, the referenceSignal may be ssb-Index indicating a particular SS/PBCH, csi-RS-Index indicating a particular CSI-RS, or srs indicating a particular SRS. If referenceSignal is configured to be ssb-Index, the UE may configure, as a beam for PUCCH transmission, a beam used when an SS/PBCH corresponding to the ssb-Index is received among SS/PBCHs in the same serving cell, or when servingCellld is provided, the UE may configure, as abeam for PUCCH transmission, abeam used when an SS/PBCH corresponding to the ssb-Index is received among SS/PBCHs in a cell indicated by the servingCellld. If referenceSignal is configured to be csi-RS-Index, the UE may configure, as a beam for PUCCH transmission, a beam used when a CSI-RS corresponding to the csi-RS-Index is received among CSI-RSs in the same serving cell, or when servingCellld is provided, the UE may configure, as a beam for PUCCH transmission, a beam used when a CSI-RS corresponding to the csi-RS-Index is received among CSI-RSs in a cell indicated by the servingCellId. If referenceSignal is configured to be srs, the UE may configure, as a beam for PUCCH transmission, a transmission beam used when an SRS corresponding to a resource index provided through a higher signaling resource is transmitted in the same serving cell and/or in an activated uplink BWP, or when servingCellID and/or uplinkBWP is provided, the UE may configure, as a beam for PUCCH transmission, a transmission beam used when an SRS corresponding to a resource index provided through a higher signaling resource is transmitted in a cell and/or in an uplink BWP indicated by the servingCellID and/or uplinkBWP. There may be one pucch-PathlossReferenceRS-Id configuration in a particular pucch-spatialRelationlnfo configuration. PUCCH-PathlossReferenceRS in [Table 23] may be mapped to pucch-PathlossReferenceRS-Id in [Table 22], and a maximum of four values are configurable through pathlossReferenceRSs in the higher signaling PUCCH-PowerControl in [Table 23]. If PUCCH-PathlossReferenceRS is connected to an SS/PBCH through the higher signaling referenceSignal, ssb-Index may be configured, and if same is connected to a CSI-RS, csi-RS-Index may be configured.

TABLE 23

| | |
|---|---|
| PUCCH-PowerControl ::= | SEQUENCE { |

| | | |
|---|---|---|
| deltaF-PUCCH-f0 | INTEGER (−16..15) | OPTIONAL, -- Need R |
| deltaF-PUCCH-f1 | INTEGER (−16..15) | OPTIONAL, -- Need R |
| deltaF-PUCCH-f2 | INTEGER (−16..15) | OPTIONAL, -- Need R |
| deltaF-PUCCH-f3 | INTEGER (−16..15) | OPTIONAL, -- Need R |
| deltaF-PUCCH-f4 | INTEGER (−16..15) | OPTIONAL, -- Need R |

| | |
|---|---|
| p0-Set | SEQUENCE (SIZE (1..maxNrofPUCCH-P0-PerSet)) OF P0-PUCCH |

OPTIONAL, -- Need M

| | |
|---|---|
| pathlossReferenceRSs | SEQUENCE (SIZE (1..maxNrofPUCCH-PathlossReferenceRSs)) |

| | |
|---|---|
| OF PUCCH-PathlossReferenceRS | OPTIONAL, -- Need M |

| | | |
|---|---|---|
| twoPUCCH-PC-AdjustmentStates | ENUMERATED {twoStates} | OPTIONAL, -- Need S |

```
  ...,
  [[
```

| | | |
|---|---|---|
| pathlossReferenceRSs-v1610 | SetupRelease { PathlossReferenceRSs-v1610 } | OPTIONAL |

-- Need M
]]
}

| | |
|---|---|
| P0-PUCCH ::= | SEQUENCE { |
| p0-PUCCH-Id | P0-PUCCH-Id, |

| | |
|---|---|
| p0-PUCCH-Value | INTEGER (−16..15) |

}

| | |
|---|---|
| P0-PUCCH-Id ::= | INTEGER (1..8) |

| | |
|---|---|
| PathlossReferenceRSs-v1610 ::= | SEQUENCE (SIZE (1..maxNrofPUCCH- |

PathlossReferenceRSsDiff-r16)) OF PUCCH-PathlossReferenceRS-r16

| | |
|---|---|
| PUCCH-PathlossReferenceRS ::= | SEQUENCE { |

| | |
|---|---|
| pucch-PathlossReferenceRS-Id | PUCCH-PathlossReferenceRS-Id, |

| | |
|---|---|
| referenceSignal | CHOICE { |
| ssb-Index | SSB-Index, |
| csi-RS-Index | NZP-CSI-RS-ResourceId |

}
}

| | |
|---|---|
| PUCCH-PathlossReferenceRS-r16 ::= | SEQUENCE { |
| pucch-PathlossReferenceRS-Id-r16 | PUCCH-PathlossReferenceRS-Id-v1610, |

| | |
|---|---|
| referenceSignal-r16 | CHOICE { |

| | |
|---|---|
| ssb-Index-r16 | SSB-Index, |
| csi-RS-Index-r16 | NZP-CSI-RS-ResourceId |

}
}

### [PUCCH: Regarding Transmission Power]

As an embodiment of the disclosure, a method of, when uplink control information is transmitted through an uplink control channel (physical uplink control channel, PUCCH) in response to a power control command received from a base station, configuring and transmitting the transmission power of the uplink control channel by a UE will be described. Uplink control channel transmission power (PPUCCH) of the UE may be determined as [Equation 3] below expressed by a unit of dBm together with a PUCCH power control adjustment state corresponding to the i-th transmission unit and closed loop index 1. In [Equation 3] below, when the UE supports multiple carrier frequencies in multiple cells, each parameter may be determined by primary cell c, carrier frequency f, and bandwidth part b, and may be distinguished by the indexes b, f, and c.

$${P}_{PUCCH , b , f , c} ( i , {q}_{u} , {q}_{d} , l ) = min \{ \begin{matrix}{P}_{CMAX , f , c} ( i ) , \\ {P}_{0 \_ PUCCH , b , f , c} ( {q}_{u} ) + 10 {log}_{10} ( {2}^{µ} * {M}_{RB , b , f , c}^{PUCCH} ( i ) ) + {PL}_{b , f , c} ( {q}_{d} ) + {Δ}_{F \_ PUCCH} ( F ) + {Δ}_{TF , b , f , c} ( i ) + {f}_{b , f , c} ( i , l )\end{matrix} \} [ dBm ] \qquad [ Equation 3 ]$$

P_{CMAx,f,c}(i): This is maximum transmission power usable by the UE in the i-th transmission unit, and may be determined by the power class of the UE, and parameters activated by the base station and various parameter embedded in the UE.
P_{0_PUCCH,b,f,c}(qᵤ): P_{0_PUCCH,b,f,c}(qᵤ) may be configured by the sum of P_{0_NOMINAL_PUCCH} and P_{0_UE_PUCCH}(qᵤ). P_{0_NOMINAL_PUCCH} is a cell-specific value and may be configured through p0-nominal that is cell-specific higher layer signaling, and if there is no corresponding configuration, P_{0_NOMINAL_PUCCH} may be 0 dBm. P_{0_UE_PUCCH}(qᵤ) is a UE-specific value and may be configured through p0-PUCCH-Value in the higher layer signaling p0-PUCCH at bandwidth part b, carrier frequency f and primary cell c, Qᵤ may be greater than or equal to 0 and smaller than Qᵤ, and Qᵤ may indicate the size of a set of P_{0_UE_PUCCH} values and may be configured through the higher layer signaling maxNrofPUCCH-P0-PerSet. The set of P_{0_UE_PUCCH} values may be configured by the higher layer signaling p0-Set, and if there is no corresponding configuration, the set may be considered as (qᵤ)=0.
μ: Subcarrier spacing configuration value
M_{RB,b,f,c}^{PUCCH}(i): This may indicate a resource amount (e.g., the number of resource block (RB)s used for PUCCH transmission in the frequency domain) used in the i-th PUCCH transmission unit in bandwidth part b, carrier frequency f and primary cell c.
PL_{b,f,c}(q_{d}): This represents a pathloss between the base station and the UE, and the UE calculates a pathloss from the difference between the transmission power of a reference signal (RS) resource q_{d} signaled by the base station and the UE reception signal level of the reference signal.
Δ_{F PUCCH}(F): The UE may use a corresponding value if the higher layer signaling deltaF-PUCCH-f0 is configured for PUCCH format 0, use a corresponding value if the higher layer signaling deltaF-PUCCH-f1 is configured for PUCCH format 1, use a corresponding value if the higher layer signaling deltaF-PUCCH-f2 is configured for PUCCH format 2, use a corresponding value if the higher layer signaling deltaF-PUCCH-f3 is configured for PUCCH format 3, use a corresponding value if the higher layer signaling deltaF-PUCCH-f4 is configured for PUCCH format 4, and use 0 if a higher layer signaling has failed to be configured for all PUCCH formats.
Δ_{TF,b,f,c}(i): This is a PUCCH transmission power adjustment element in bandwidth part b, carrier frequency f and primary cell c, and different calculation methods may be used according to a PUCCH format.
g_{b,f,c}(i, l): This may indicate a PUCCH power control adjustment state value for the i-th PUCCH transmission unit corresponding to closed loop index l in bandwidth part b, carrier frequency f and primary cell c. Here, closed loop power adjustment for PUCCH transmission may employ an accumulation method of accumulating and applying a value indicated by a TPC command.

The PUCCH power control adjustment state g_{b,f,c}(i, l) may be determined through bandwidth part b, carrier frequency f, primary cell c, the i-th transmission unit, and closed loop index 1.
δ_{PUCCH,b,f,c} (i, l): This may be a value indicated by a TPC command field included in DCI format 1_0, 11, or 1_2 scheduling PDSCH reception and the i-th PUCCH transmission unit corresponding to closed loop index/in bandwidth part b, carrier frequency f and primary cell c, or may be a value indicated by a TPC command field included in DCI format 2_2 transmitted together with a CRC scrambled with a TPC-PUCCH-RNTI.
   If the higher layer signalingtwoPUCCH-PC-AdjustmentStates and PUCCH-SpatialRelationInfo are configured for the UE, closed loop index/may have a value of 0 or 1.
   If the higher layer signalingtwoPUCCH-PC-AdjustmentStates or PUCCH-SpatialRelationInfo is not configured for the UE, closed loop index/may have a value of 0.
   If the UE obtains a TPC command value through a TPC command field included in DCI format 1_0, 11, or 1_2 scheduling PDSCH reception and the higher layer signaling PUCCH-SpatialRelationInfo is configured for the UE, the UE may obtain a connection relation between a pucch-SpatialRelationlnfold value and a closedLoopIndex value configuring a value of closed loop index 1, based on an index configurable through the higher layer signaling p0-PUCCH-Id. If the UE receives a MAC-CE corresponding to pucch-SpatialRelationlnfold, the UE may determine a closedLoopIndex value configuring a value of closed loop index 1, based on a corresponding p0-PUCCH-Id index.
   If the UE obtains one TPC command value from a TPC command field included in DCI format 2_2 transmitted together with a CRC scrambled with a TPC-PUCCH-RNTI, the UE may obtain an/value, based on a closed loop index field included in the DCI format 2_2.
The PUCCH power control adjustment state g_{b,f,c} (i, l) for the i-th PUCCH transmission unit corresponding to closed loop index l in bandwidth part b, carrier frequency f and primary cell c may be calculated as shown in [Equation 4].

$${g}_{b , f , c} ( i , l ) = {g}_{b , f , c} ( i - {i}_{0} , l ) + {\sum }_{m = 0}^{c ( {C}_{i} ) - 1} {δ}_{PUCCH , b , f , c} ( m , l ) \qquad [ Equation 4 ]$$

δ_{PUCCH,b,f,c}(m, l): As described above, this may be a value indicated by a TPC command field included in DCI format 10, 11, or 1_2 scheduling PDSCH reception and the m-th PUCCH transmission unit corresponding to closed loop index l in bandwidth part b, carrier frequency f and primary cell c, or may be a value indicated by a TPC command field included in DCI format 2_2 transmitted together with a CRC scrambled with a TPC-PUCCH-RNTI. If a TPC command accumulation operation is possible, a value of δ_{PUCCH,b,f,c} may be a corresponding value in a unit of [dB] according to a value which a TPC command field included in DCI format 10, 11, 1_2, or 2_2 is indicated to be, as shown in [Table 26]. For example, if the value of the TPC command field is 0, δ_{PUCCH,b,f,c} may have a value of −1 dB.
Σₘ₌₀^{c(C}^{ᵢ}⁾⁻¹δ_{PUCCH,b,f,c}(m, l) may indicate the sum of δ_{PUCCH,b,f,c} for all corresponding transmission units in the particular set Cᵢ according to the above TPC command value. c(Cᵢ) may indicate the number of all elements belonging to the set Cᵢ. Cᵢ may indicate a set of pieces of DCI including all TPC command values for which a TPC command accumulation operation is to be performed for the i-th PUCCH transmission unit. In order to determine Cᵢ, a start point and an end point on the time dimension are defined and the pieces of DCI received by the UE between the two points may all be included as the elements of Cᵢ.
   The end point for determining Cᵢ may be a point before K_{PUCCH}(i) symbols from the starting symbol of the i-th PUCCH transmission unit.
   The start point for determining Cᵢ may be a point before K_{PUCCH}(i−i₀)−1 symbols from the starting symbol of the (i−i0)-th PUCCH transmission unit. i0, which is a positive integer, may be determined to be the smallest value satisfying that a time point before K_{PUCCH}(i−i₀) symbols from the starting symbol of the (i−i0)-th PUCCH transmission unit is earlier, in time, than the end point for determining C (a point before K_{PUCCH}(i) symbols from the starting symbol of the i-th PUCCH transmission unit).
   For example, in a case where the end point for determining Cᵢ is definable to be sym(i) and the time point before K_{PUCCH}(i−₀) symbols from the starting symbol of the (i−i0)-th PUCCH transmission unit is definable to be sym(i−i0), if sym(i)=sym(i−1)>sym(i−2)>sym(i−3) is satisfied, i0 may be determined to be 2.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 24 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 24 through upper signaling. If PUSCH transmission is operated by a configured grant, parameters applied to the PUSCH transmission are applied through configuredGrantConfig (upper signaling) in Table 24 except for dataScramblingIdentityPUSCH, txConfig, codebookSubset, maxRank, and scaling of UCI-OnPUSCH, which are provided by pusch-Config (upper signaling) in Table 25. If provided with transformPrecoder inside configuredGrantConfig (upper signaling) in Table 24, the UE applies tp-pi2BPSK inside pusch-Config in Table 25 to PUSCH transmission operated by a configured grant.

TABLE 24

| | |
|---|---|
| ConfiguredGrantConfig ::= | SEQUENCE { |

| | |
|---|---|
| frequency Hopping | ENUMERATED {intraSlot, interSlot} |

OPTIONAL, -- Need S,

| | |
|---|---|
| cg-DMRS-Configuration | DMRS-UplinkConfig, |

| | | |
|---|---|---|
| mcs-Table | ENUMERATED {qam256, qam64LowSE} | OPTIONAL, - |

- Need S

| | |
|---|---|
| mcs-Table TransformPrecoder | ENUMERATED {qam256, qam64LowSE} |

OPTIONAL, -- Need S

| | | |
|---|---|---|
| uci-OnPUSCH | SetupRelease { CG-UCI-OnPUSCH } | OPTIONAL, -- |

Need M

| | |
|---|---|
| resource Allocation | ENUMERATED { resourceAllocation Type0, |

resource AllocationType1, dynamicSwitch },

| | | |
|---|---|---|
| rbg-Size | ENUMERATED {config2} | OPTIONAL, -- Need S |

| | |
|---|---|
| powerControlLoopToUse | ENUMERATED {n0, n1}, |

| p0-PUSCH-Alpha | P0-PUSCH-AlphaSetId, | |
|---|---|---|
| transformPrecoder | ENUMERATED {enabled, disabled} | OPTIONAL, |

-- Need S

| | |
|---|---|
| nrofHARQ-Processes | INTEGER(1..16), |

| | |
|---|---|
| repK | ENUMERATED {n1, n2, n4, n8}, |

| | | |
|---|---|---|
| repK-RV | ENUMERATED {s1-0231, s2-0303, s3-0000} | OPTIONAL, |

-- Need R

| | |
|---|---|
| periodicity | ENUMERATED { |

sym2, sym7, sym1x14, sym2x14, sym4x14, sym5x14, sym8x14,

sym10x14, sym16x14, sym20x14,

sym32x14, sym40x14, sym64x14, sym80x14, sym128x14, sym160x14,

sym256x14, sym320x14, sym512x14,

sym640x14, sym1024x14, sym1280x14, sym2560x14, sym5120x14,
sym6, sym1x12, sym2x12, sym4x12, sym5x12, sym8x12, sym10x12,

sym16x12, sym20x12, sym32x12,

sym40x12, sym64x12, sym80x12, sym128x12, sym160x12, sym256x12,

sym320x12, sym512x12, sym640x12,

sym1280x12, sym2560x12

},

| | | |
|---|---|---|
| configuredGrantTimer | INTEGER (1..64) | OPTIONAL, -- Need |

R

| | |
|---|---|
| rrc-ConfiguredUplinkGrant | SEQUENCE { |

| | |
|---|---|
| timeDomainOffset | INTEGER (0..5119), |

| | |
|---|---|
| timeDomainAllocation | INTEGER (0..15), |

| | |
|---|---|
| frequencyDomainAllocation | BIT STRING (SIZE(18)), |

| | |
|---|---|
| antennaPort | INTEGER (0..31), |

| | | |
|---|---|---|
| dmrs-SeqInitialization | INTEGER (0..1) | OPTIONAL, -- Need |

R

| | |
|---|---|
| precodingAndNumberOfLayers | INTEGER (0..63), |

| | | |
|---|---|---|
| srs-ResourceIndicator | INTEGER (0..15) | OPTIONAL, -- Need R |

| | |
|---|---|
| mcsAndTBS | INTEGER (0..31), |

| | |
|---|---|
| frequencyHoppingOffset | INTEGER (1..maxNrofPhysicalResourceBlocks-1) |

OPTIONAL, -- Need R

| | |
|---|---|
| pathlossReferenceIndex | INTEGER (0..maxNrofPUSCH-PathlossReferenceRSs- |

1),
...

| | |
|---|---|
| } | OPTIONAL, -- Need R |

...
}

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 25, which is upper signaling, is “codebook” or “nonCodebook.”

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UL performs beam configuration for PUSCH transmission by using pucch-spatialRelationInfoID corresponding to a UL-specific PUCCH resource corresponding to the minimum ID inside an activated uplink BWP inside a serving cell, and the PUSCH transmission is based on a single antenna port. The UL does not expect scheduling regarding PUSCH transmission through DCI format 0 0 inside a BWP having no configured PUCCH resource including pucch-spatialRelationlnfo. If the UL has no configured txConfig inside pusch-Config in Table 25, the UL does not expect scheduling through DCI format 0_1.

TABLE 25

| PUSCH-Config ::= | SEQUENCE { | |
|---|---|---|
| dataScramblingIdentityPUSCH | INTEGER (0..1023) | OPTIONAL, |

-- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | | |
|---|---|---|
| pusch-PowerControl | PUSCH-PowerControl | OPTIONAL, -- |

Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent,nonCoherent}
OPTIONAL, -- Cond codebookBased

| | | |
|---|---|---|
| maxRank | INTEGER (1..4) | OPTIONAL, -- Cond |

codebookBased

| | | |
|---|---|---|
| rbg-Size | ENUMERATED { config2} | OPTIONAL, -- Need |

S

| | | |
|---|---|---|
| uci-OnPUSCH | SetupRelease { UCI-OnPUSCH} | OPTIONAL, -- |

Need M

| | | |
|---|---|---|
| tp-pi2BPSK | ENUMERATED {enabled} | OPTIONAL, -- Need |

S
...
}

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be indicated through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If multiple SRS resources are configured for the UE, the TPMI is used to indicate a precoder to be applied in an SRS resource indicated through the SRI. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent,” “partialAndNonCoherent,” or “noncoherent,” based on UE capability reported by the UE to the base station. If the UE reported “partialAndNonCoherent” as UE capability, the UE does not expect that the value of codebookSubset (upper signaling) may be configured as “fullyAndPartialAndNonCoherent.” In addition, if the UE reported “nonCoherent” as UE capability, UE does not expect that the value of codebookSubset (upper signaling) may be configured as “fullyAndPartialAndNonCoherent” or “partialAndNonCoherent.” If nrofSRS-Ports inside SRS-ResourceSet (upper signaling) indicates two SRS antenna ports, the UE does not expect that the value of codebookSubset (upper signaling) may be configured as “partialAndNonCoherent.”

The UE may have one SRS resource set configured therefor, wherein the value of usage inside SRS-ResourceSet (upper signaling) is “codebook,” and one SRS resource may be indicated through an SRI inside the corresponding SRS resource set. If multiple SRS resources are configured inside the SRS resource set wherein the value of usage inside SRS-ResourceSet (upper signaling) is “codebook,” the UE expects that the value of nrofSRS-Ports inside SRS-Resource (upper signaling) is identical for all SRS resources.

The UE transmits, to the base station, one or multiple SRS resources included in the SRS resource set wherein the value ofusage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE may apply, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook,” non-codebook-based PUSCH transmission may be scheduled for the UE through DCI format 0_1.

With regard to the SRS resource set wherein the value of usage inside SRS-ResourceSet (upper signaling) is “nonCodebook,” one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission may be updated.

If the configured value of resourceType inside SRS-ResourceSet (upper signaling) is “aperiodic,” the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 11) is not “00.” The corresponding DCI may not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) may be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook,” and a maximum of four SRS resources may be configured for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook,” and the base station selects one or multiple SRS resources from the received one or multiple SRS resources. In connection with the non-codebook-based PUSCH transmission, the SRI may indicate an index that may express one SRS resource or a combination of multiple SRS resources. The number of SRS resources indicated by the SRI transmitted by the base station may be the number of transmission layers of the PUSCH, and the UE transmits the PUSCH by applying the precoder applied to SRS resource transmission to each layer.

### [PUSCH: Regarding Transmission Power]

As an embodiment of the disclosure, a method of, when uplink data is transmitted through an uplink data channel (physical uplink shared channel, PUSCH) in response to a power control command received from a base station, configuring and transmitting the transmission power of the uplink data channel by a UE will be described. Uplink data channel transmission power of the UE may be determined as Equation 5 below represented by a unit of dBm together with a PUSCH power control adjustment state corresponding to the i-th transmission unit, parameter set configuration index j, and closed loop index 1. In [Equation 5] below, when the UE supports multiple carrier frequencies in multiple cells, each parameter may be determined by cell c, carrier frequency f, and bandwidth part b, and may be distinguished by the indexes b, f, and c.

$${P}_{PUSCH , b , f , c} ( i , j , {q}_{d} , l ) = min \{ \begin{matrix}{P}_{CMAX , f , c} ( i ) , \\ {P}_{0 \_ PUSCH , b , f , c} ( j ) + 10 {log}_{10} ( {2}^{µ} * {M}_{RB , b , f , c}^{PUSCH} ( i ) ) + {a}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ] \qquad [ Equation 5 ]$$

P_{CMAX,f,c}(i): This is maximum transmission power usable by the UE in the i-th transmission unit, and may be determined by the power class of the UE, and parameters activated by the base station and various parameter embedded in the UE.
P_{0 PUSCH,b,f,c}(j): P_{0 PUSCH,b,f,c}(j) may be configured by the sum of P_{0 NOMINAL PUSCH,f,c}(j) and P_{0 UE PUSCH,b,f,c}(j). P_{0 NOMINAL PUSCH,f,c}(j) is configured for the UE through cell-specific higher layer signaling, and P_{0 UE PUSCH,b,f,c}(j) is configured through UE-specific higher layer signaling. Here, j=0 indicates a PUSCH for transmitting msg3, j=1 indicates a configured grant PUSCH, and one value of j={2, . . . , J−1}indicates a grant PUSCH.
μ: Subcarrier spacing configuration value.
M_{RB,b,f,c}^{PUSCH}(i): This may indicate a resource amount (e.g., the number of resource block (RB)s used for PUSCH transmission on the frequency axis) used in the i-th PUSCH transmission unit.
a_{b,f,c}(j): This indicates a value for compensating for pathloss and indicates a value that may be determined through a higher layer configuration and a SRS resource indicator (SRI) (in a case of a dynamic grant PUSCH).
PL_{b,f,c}(q_{d}): This represents a pathloss between the base station and the UE, and the UE calculates a pathloss from the difference between the transmission power of a reference signal (RS) resource q_{d} signaled by the base station and the UE reception signal level of the reference signal. This equation denotes a downlink pathloss estimation estimated by the UE through a reference signal having a reference signal index of q_{d}, and the reference signal index q_{d} may be determined by the UE through a higher layer configuration and an SRI (in a case of a dynamic grant PUSCH or a configured grant PUSCH (type 2 configured grant PUSCH) based on ConfiguredGrantConfig not including the higher layer configuration rrc-ConfiguredUplinkGrant) or through a higher layer configuration.
Δ_{TF,b,f,c}(i): This may indicate a value determined according to a modulation coding scheme (MCS) and a format (transport format (TF), e.g., whether UL-SCH is included or whether CSI is included) of information transmitted through a PUSCH.
f_{b,f,c}(i, l): This is a closed loop power control adjustment value, and indicates the value of closed loop index l which may be determined for a PUSCH by a higher layer configuration and an SRI. Closed loop power adjustment for PUSCH transmission may be supported by an accumulation method of accumulating and applying a value indicated by a TPC command, or an absolute method of directly applying a value indicated by a TPC command, and may be determined according to whether the higher layer parameter tpc-Accumulation is configured. When the higher layer parameter tpc-Accumulation is configured to be disabled, closed loop power adjustment for PUSCH transmission is performed by the absolute method, and when tpc-Accumulation is not configured, closed loop power adjustment for PUSCH transmission is performed by the accumulation method.

The PUSCH power control adjustment state f_{b,f,c}(i, l) may be determined through bandwidth part b, carrier frequency f, cell c, the i-th transmission unit, and closed loop index l.
δ_{PUSCH,b,f,c}(i, l): This may be a value indicated by a TPC command field included in DCI format 0_0, 0_1, or 0_2 scheduling the i-th PUSCH transmission unit corresponding to closed loop index l in bandwidth part b, carrier frequency f, and cell c, or may be a value indicated by a TPC command field included in DCI format 2_2 transmitted together with a CRC scrambled with a TPC-PUSCH-RNTI.
   If the higher layer signaling twoPUSCH-PC-AdjustmentStates is configured for the UE, closed loop index l may have a value of 0 or 1.
   If the higher layer signalingtwoPUSCH-PC-AdjustmentStates is not configured for the UE or a PUSCH transmission based on a RAR UL grant is scheduled thereto, closed loop index l may have a value of 0.
      If the higher layer signaling ConfiguredGrantConfig is configured for the UE and the UE performs a PUSCH transmission or retransmission therefor, closed loop index l may follow the value of the higher layer signaling powerControlLoopToUse.
      If the higher layer signaling SRI-PUSCH-PowerControl is configured for the UE, the UE may obtain a connection relation between a value indicated by an SRS resource indicator (SRI) field in a DCI format scheduling a PUSCH transmission and closed loop index l configured through the higher layer signaling sri-PUSCH-ClosedLooplndex, and determine closed loop index l according to the value indicated by the SRI field in the DCI format, based on the connection relation.
      If a PUSCH transmission is scheduled to the UE, based on a DCI format not including an SRI field, or the higher layer signaling SRI-PUSCH-PowerControl is not configured therefor, the UE may consider closed loop index/to be 0.
      If a TPC command value is indicated to the UE through a TPC command field included in DCI format 2_2 transmitted together with a CRC scrambled with a TPC-PUSCH-RNTI, closed loop index l may be indicated thereto through a closed loop index field included in DCI format 2_2.
   If the higher layer signaling tpc-Accumulation is not configured for the UE, that is, if a TPC command accumulation operation for the UE is possible, the PUSCH power control adjustment state f_{b,f,c}(i, l) for the i-th PUSCH transmission unit corresponding to closed loop index l in bandwidth part b, carrier frequency f and cell c may be calculated as shown in [Equation 6].

$${f}_{f , b , c} ( i , l ) = {f}_{b , f , c} ( i - {i}_{0} , l ) + {\sum }_{m = 0}^{c ( {D}_{i} ) - 1} {δ}_{PUSCH , b , f , c} ( m , l ) \qquad [ Equation 6 ]$$

δ_{PUSCH,b,f,c}(m, l) may be, as described above, a value indicated by a TPC command field included in DCI format 0_0, 0_1, or 0_2 scheduling the m-th PUSCH transmission unit corresponding to closed loop index l in bandwidth part b, carrier frequency f and cell c, or may be a value indicated by a TPC command field included in DCI format 2_2 transmitted together with a CRC scrambled with a TPC-PUSCH-RNTI. If a TPC command accumulation operation is possible, a value of δ_{PUSCH,b,f,c} may be a corresponding value in a unit of [dB] according to a value which a TPC command field included in DCI format 0_0, 0_1, 0_2, or 2_2 is indicated to be, as shown in [Table 26]. For example, if the value of the TPC command field is 0, δ_{PUSCH,b,f,c} may have a value of −1 dB.
Σₘ₌₀^{c(D}^{ᵢ}⁾⁻¹δ_{PUSCH,b,f,c}(m, l) may indicate the sum of δ_{PUSCH,b,f,c} for all corresponding transmission units in the particular set Dᵢ according to the above TPC command value. c(Dᵢ) may indicate the number of all elements belonging to the set Dᵢ. Dᵢ may indicate a set of pieces of DCI including all TPC command values for which a TPC command accumulation operation is to be performed for the i-th PUSCH transmission unit. In order to determine Dᵢ, a start point and an end point on the time dimension are defined and the pieces of DCI received by the UE between the two points may all be included as the elements of Dᵢ.
   The end point for determining Dᵢ may be a point before K_{PUSCH}(i) symbols from the starting symbol of the i-th PUSCH transmission unit.
   The start point for determining Dᵢ may be a point before K_{PUSCH}(i−i₀)−1 symbols from the starting symbol of the i−i₀-th PUSCH transmission unit. i₀, which is a positive integer, may be determined to be the smallest value satisfying that a time point before K_{PUSCH}(i−i₀) symbols from the starting symbol of the i−i₀-th PUSCH transmission unit is earlier, in time, than the end point for determining Dᵢ (a point before K_{PUSCH}(i) symbols from the starting symbol of the i-th PUSCH transmission unit).
   For example, in a case where the end point for determining Dᵢ is definable to be sym(i) and the time point before K_{PUSCH}(i−i₀) symbols from the starting symbol of the i−i₀-th PUSCH transmission unit is definable to be sym(i−i₀), if sym(i)=sym(i−1)>sym(i−2)>sym(i−3) is satisfied, i0 may be determined to be 2.
If the higher layer signaling tpc-Accumulation is configured for the UE, that is, if a TPC command accumulation operation for the UE is impossible, the PUSCH power control adjustment state f_{b,f,c}(i, l) for the i-th PUSCH transmission unit corresponding to closed loop index l in bandwidth part b, carrier frequency f and cell c may be calculated as shown in [Equation 7].

$${f}_{b , f , c} ( i , l ) = {δ}_{PUSCH , b , f , c} ( i , l ) \qquad [ Equation 7 ]$$

δ_{PUSCH,b,f,c}(i, l): As described above, this may be a value indicated by a TPC command field included in DCI format 0_0, 0_1, or 0_2 scheduling the i-th PUSCH transmission unit corresponding to closed loop index l in bandwidth part b, carrier frequency f and cell c, or may be a value indicated by a TPC command field included in DCI format 2_2 transmitted together with a CRC scrambled with a TPC-PUSCH-RNTI. If a TPC command accumulation operation is impossible, a value of δ_{PUSCH,b,f,c} may be a corresponding value in a unit of [dB] according to a value which a TPC command field included in DCI format 0_0, 0_1, 0_2, or 2_2 is indicated to be, as shown in [Table 26]. For example, if the value of the TPC command field is 0, δ_{PUSCH,b,f,c} may have a value of −4 dB.

TABLE 26

| TPC command | Accumulated | Absolute |
|---|---|---|
| field | δ_{PUSCH, b, f, c}[dB] | δ_{PUSCH, b, f, c}[dB] |
| 0 | −1 | −4 |
| 1 | 0 | −1 |
| 2 | 1 | 1 |
| 3 | 3 | 4 |

### [Regarding PHR]

Power headroom reporting indicates that a UE measures the difference (i.e., this represents the available transmission power of the UE) between the nominal maximum transmission power of the UE (nominal UE maximum transmit power) and estimated power for uplink transmission and transmits the difference to a base station. Power headroom reporting may be used to support power aware packet scheduling. The estimated power for uplink transmission may be estimated power for UL-SCH (PUSCH) transmission per activated serving cell, estimated power for UL-SCH and PUCCH transmission of, in an SpCell, another MAC entity (e.g., E-UTRA MAC entity in EN-DC, NE-DC, and NGEN-DC cases in a 3GPP specification), and estimated power for SRS transmission per activated serving cell. The UE may trigger power headroom reporting if at least one of the following trigger events is satisfied.
[Trigger event 1] When the higher layer parameter phr-ProhibitTimer expires and a MAC entity has an uplink resource for new transmission, a pathloss for at least one activated support cell is changed by an amount greater than the higher layer parameter phr-Tx-PowerFactorChange dB after the latest PHR transmission. Here, an activated downlink bandwidth for the at least one activated support cell is not a dormant bandwidth. The change in the pathloss for one cell is determined by the difference between a pathloss currently measured for a current pathloss reference and a pathloss measured at a corresponding time point for a pathloss reference at the latest PHR transmission time point.
[Trigger event 2] The higher layer parameter phr-PeriodicTimer expires.
[Trigger event 3] Rather than configuration or reconfiguration of not supporting power headroom reporting, configuration or reconfiguration of a power headroom reporting function by a higher layer is performed.
   [Trigger event 4] An SCell for a MAC entity having an uplink for which firstActiveDownlinkBWP-Id is not configured to be a dormant bandwidth part is activated. firstActiveDownlinkBWP-Id indicates an identifier of a DL BWP to be activated at the time of RRC (re)configuration (when same is configured for an SpCell) or an identifier of a DL BWP to be used at the time of activation of an SCell (when same is configured for an SCell).
[Trigger event 5] APSCell is added. (i.e., a PSCell is newly added or changed.)
[Trigger event 6] When the higher layer parameter phr-PrhoibitTimer expires and a MAC entity has an uplink resource for new transmission, the following items a) and b) are both satisfied for activated support cells of a MAC entity having a configured uplink:
a) There is an uplink resource allocated for transmission or a PUCCH is transmitted to a corresponding cell.
b) When a MAC entity has an uplink resource for transmission or transmits a PUCCH to a corresponding cell, a power backoff required for power management for the cell is greater than the higher layer parameter phr-Tx-PowerFactorChange dB after the latest PHR transmission.
[Trigger event 7] An activated bandwidth part of an SCell for a MAC entity having a configured uplink is changed from a dormant bandwidth part to a non-dormant downlink bandwidth.
[Trigger event 8] If the higher layer parameter mpe-Reporting-FR2 for indicating whether to report a maximum permissible exposure maximum allowed UE output power reduction (MPE P-MPR) for satisfying an MPE in FR2 is configured for the UE and mpe-ProhibitTimer is not operating, when power headroom reporting is called “MPE P-MPR reporting,” a measured P-MPR applied to satisfy an FR2 MPE requirement for at least one activated FR2 support cell equal to or greater than the higher layer parameter mpe-Threshold after the latest power headroom reporting.

Power headroom reporting may be triggered according to trigger events and the UE may determine power headroom reporting according to the following additional conditions.
[Additional condition according to temporary required power backoff]A MAC entity needs to avoid triggering power headroom reporting when a required power backoff temporarily (for up to a few tens of milliseconds) decreases due to power management. If the required power backoff temporarily decreases and power headroom reporting is triggered by other trigger events, resultant temporary decrease in the value of PCMAX,f,c/PH representing the ratio between the maximum power and the remaining (available) power needs to be prevented. That is, prevention of PHR being triggered by temporary power backoff is required. For example, the condition is added so that, if PHR is triggered by other PHR trigger events (expiration of periodictimer), PH reflecting temporary power reduction caused by a required power backoff is not reported and PH excluding the effect of the required power backoff is reported.
[Condition for power headroom reporting according to UE implementation] If a single HARQ process is configured by cg-RetransmissionTimer and a power headroom report is already included in a MAC PDU for transmission by the HARQ process, but not yet transmitted through a lower layer, a method of processing the PHR content is determined according to UE implementation.

If one or more events of the trigger events occur and power headroom reporting is triggered, and an uplink transmission resource allocated through downlink control information is able to accommodate a MAC entity for power headroom reporting and a subheader therefor, the UE performs power headroom reporting through the uplink resource. The uplink resource indicates a resource for uplink transmission scheduled by the first uplink grant or the first downlink control information format (first DCI format) scheduling the initial transmission of a transport block (TB) after power headroom triggering. That is, after a power headroom trigger occurs, the UE may perform power headroom reporting through an uplink transmission scheduled by the first uplink grant or the first downlink control information format among uplink resources which are able to accommodate a MAC entity for a power headroom and a subheader therefor. Alternatively, after a power headroom trigger occurs, the UE may perform power headroom reporting through a configured grant PUSCH transmission which are able to accommodate a MAC entity for a power headroom and a subheader therefor.

The UE may, at the time of power headroom reporting for a particular cell, select, calculate, and report one of two types of pieces of power headroom information. The first type is an actual PHR and is power headroom information calculated based on the transmission power of an actually transmitted uplink signal (e.g., PUSCH). The second type is a virtual PHR (or reference format) and is power headroom information calculated based on a transmission power parameter configured in a higher layer although there is no uplink signal (e.g., PUSCH) actually transmitted. After power headroom reporting is triggered, the UE may, as described above, calculate an actual PHR, based on higher layer information for periodic/semi-persistent SRS transmission and configured grant transmission and downlink control information received until a time point including a PDCCH monitoring interval in which the first DCI format scheduling a PUSCH, through which a MAC CE including a power headroom report is to be transmitted, is received. If the UE receives downlink control information after a PDCCH monitoring interval in which the first DCI format is received, or determines a periodic/semi-persistent SRS transmission or configured grant transmission, the UE may calculate a virtual PHR for a corresponding cell. Alternatively, after power headroom reporting is triggered, the UE may calculate an actual PHR, based on higher layer information for periodic/semi-persistent SRS transmission and configured grant transmission and downlink control information received until a time point before T′proc,2=Tproc,2 corresponding to a PUSCH preparation process time described above with respect to the first uplink symbol of a configured grant PUSCH through which transmission of corresponding power headroom information is possible. If the UE receives downlink control information after a time point before T′proc,2 with respect to the first uplink symbol of a configured grant PUSCH, or determines a periodic/semi-persistent SRS transmission or configured grant transmission, the UE may calculate a virtual PHR for a corresponding cell.

If the UE calculates an actual PHR with respect to actual PUSCH transmission, power headroom reporting information for support cell c, carrier f, bandwidth part b, and PUSCH transmission time point i may be expressed as shown in [Equation 8] below.

$$P {H}_{type 1 b , f , c} ( i , j , {q}_{d} , l ) = {P}_{C M A X , f , c} ( i ) - \{ {P}_{0 \_ PUSCH , b , f , c} ( j ) + 10 {log}_{10} ( {2}^{µ} \cdot {M}_{RB , b , f , c}^{PUSCH} ( i ) ) + {a}_{b , f , c} ( j ) \cdot {PL}_{b , f , c} ( {q}_{d} ) + {Δ}_{TF , b , f , c} ( i ) + {f}_{b , f , c} ( i , l ) \} [ dB ] \qquad [ Equation 8 ]$$

As another example, if the UE calculates a virtual PHR, based on a transmission power parameter configured in a higher layer, power headroom reporting information for support cell c, carrier f, bandwidth part b, and PUSCH transmission time point i may be expressed as shown in [Equation 9] below.

$$P {H}_{type 1 b , f , c} ( i , j , {q}_{d} , l ) = {\tilde{P}}_{C M A X , f , c} ( i ) - \{ {P}_{0 \_ PUSCH , b , f , c} ( j ) + {a}_{b , f , c} ( j ) \cdot {PL}_{b , f , c} ( {q}_{d} ) + {f}_{b , f , c} ( i , l ) \} [ dB ] \qquad [ Equation 9 ]$$

According to [Equation 8] above, power headroom information may be calculated by using the difference between transmission power for PUSCH transmission occasion i and maximum output power. According to [Equation 9], power headroom information may be calculated by using the difference between \tilde{P}_{CMAx,f,c}(i), which is maximum output power when it is assumed that a parameter (e.g., MPR, A-MPR (Additional MPR), P-MPR (Power Management MPR), etc.) related to maximum power reduction (MPR) and ΔTc are 0, and reference PUSCH transmission power using a default transmission power parameter (e.g., P_{0_NOMINAL_PUSCH,f,c}(0), p0 and alpha of P0-PUSCH-AlpahSet having p0-PUSCH-AlphaSetId=0, PL_{b,f,c}(q_{d}) corresponding to pusch-PathlossReferenceRS-Id=0, and a closed loop power adjustment value having closed loop index 1=0). Description of each variable in [Equation 8] and [Equation 9] above may be referenced to the description of the variables in [Equation 5]. A-MPR is an MPR satisfying an additional emission requirement (e.g., when NR freq. band and additionalSpectrumEmission indicated through RRC are combined (Table 6.2.3.1-1A in TS 38.101-1), a network signaling label is identified and an A-MPR value according thereto is defined in Table 6.2.3.1-1 in TS 38.101-1) indicated by a base station through higher layer signaling. P-MPR is a MPR which is an output power reduction of a UE maximally allowed for support cell c (maximum allowed UE output power reduction for serving cell c) and has a purpose of satisfying applicable electromagnetic energy absorption requirements. A-MPR and P-MPR may be referenced to 3GPP specification TS 38.101-1 section 6.2. First type power headroom information in a communication system to which the disclosure is applicable may indicate power headroom information for PUSCH transmission power, second type power headroom information may indicate power headroom information for PUCCH transmission power, and third type power headroom information may indicate power headroom information for SRS transmission power. However, the disclosure is not limited thereto.

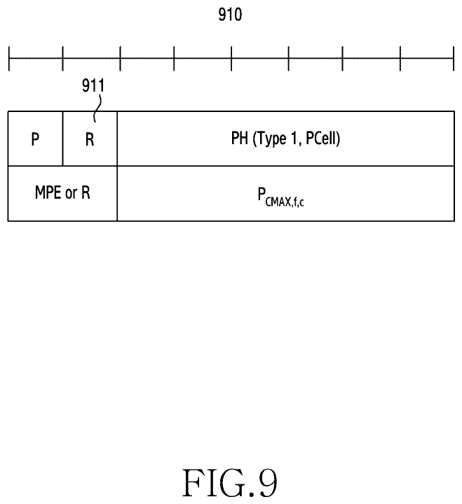

If MR-DC or UL-CA is not supported, a base station configures “false” as the higher layer parameter “multiplePHR” for a corresponding UE. This implies that the UE supports power headroom reporting for a PCell through a MAC CE having a single entry as indicated by reference numeral 910 in FIG. 9. Each field in FIG. 9 may be defined as shown in [Table 27] below. However, this merely corresponds to an example and the disclosure is not limited thereto.

TABLE 27
- P: P configured by 1 bit is set to 0 in a case where mpe-Reporting-FR2 is configured
and a serving cell operates in FR2, a P-MPR applied according to TS38.133 is smaller than P-
MPR_00, and otherwise, P is set to 1. If mpe-Reporting-FR2 is not configured or a serving cell
operates in FR1, P indicates whether power backoff has been applied for transmission power
adjustment. If power backoff due to power management is not applied and thus a corresponding
Pcmax, c field has a different value, a corresponding P area is set to 1.
- P_{CMAX, f, c}: This field indicates a maximum transmission power value used to calculate
a power headroom, at the time of power headroom reporting. One of a total of 64 nominal UE
transmission (transmit) power levels may be selected using 6 bits of information.
- MPE: If mpe-Reporting-FR2 is configured, a serving cell operates in FR2, and a P field
is set to 1, an MPE area indicates a power backoff value applied to satisfy a maximum
permissible exposure (MPE) requirement. One value of a total of 4 measured P-MPR value
levels is indicated by a field configured by 2 bits. If mpe-Reporting-FR2 is not configured, a
serving cell operates in FR1, or a P field is set to 0, this area may exist as a reserved bit such as
R.
- R: This is a reserved bit and is set to 0.
- PH: This field indicates a power headroom level. This field is configured by 6 bits and
may select one value among a total of 64 power headroom levels.

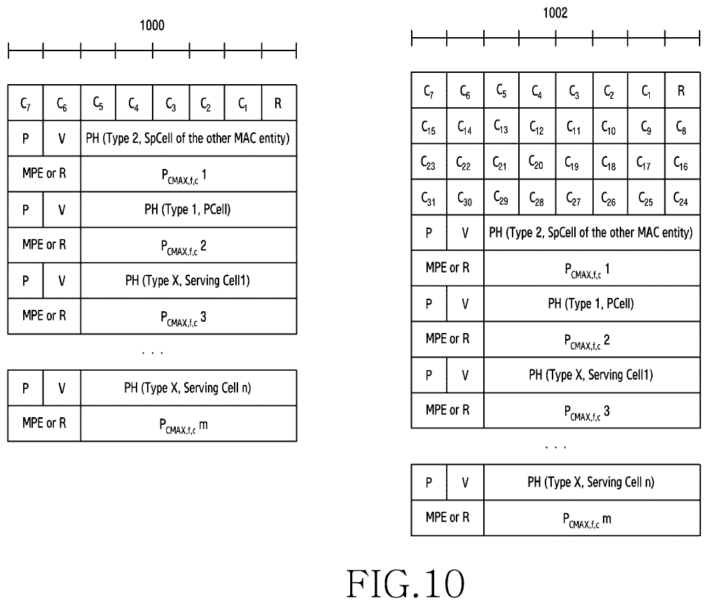

If a UE supports multi-RAT dual connectivity (MR-DC) or uplink carrier aggregation (UL-CA), a base station may configure “true” as the higher layer parameter “multiplePHR” for the UE to perform power headroom reporting for each support cell. This implies that the UE supports power headroom reporting for multiple support cells through a MAC CE having multiple entries, such as a first format 1000 or a second format 1002 illustrated in FIG. 10. The first format 1000 in FIG. 10 is a PHR MAC CE format which is usable when multiple serving cells are configured and the largest index of the serving cells is smaller than 8. The second format 1002 in FIG. 10 is a PHR MAC CE format which is usable when multiple serving cells are configured and the largest index of the serving cells is equal to or greater than 8. The first format 1000 or the second format 1002 illustrated FIG. 10 may have a variable size according to a set in which serving cells are configured and the number thereof unlike the PHR MAC CE format illustrated in FIG. 9. Corresponding information may include second type of PH information for an SpCell (special cell) of another MAC entity (e.g., LTE), and first type of PH information for a PCell. If the largest index of the serving cells is smaller than 8, a field representing serving cell information may be configured by one octet. If the largest index of the serving cells is equal to or greater than 8, a field representing serving cell information may be configured by four octets. In a PHR MAC CE, power headroom information may be included according to an order of serving cell indexes. A MAC entity may transmit a PHR MAC CE including power headroom information through a transmittable PUSCH when power headroom reporting is triggered. Whether the power headroom information is calculated based on actual transmission (i.e., this is an actual PHR) or is calculated based on a transmission power parameter configured in a higher layer (i.e., this is a virtual PHR) may be determined based on downlink control information and a higher signal received until a particular time point (a time point including a PDCCH monitoring interval in which a first DCI format is detected or a time point before T′proc,2 from the first symbol of an initial PUSCH) as described above. The fields in the PHR MAC CE formats illustrated FIG. 10 may have the same meaning (definition) as almost fields of the PHR MAC CE format illustrated in FIG. 9, and Cᵢ and V may have the same meaning as described in [Table 28] below.

TABLE 28
- Cᵢ: This area indicates whether there is a power headroom area for a support
cell having ServCellIndex i. If a power headroom for support cell i is reported, a
corresponding Cᵢ area is set to 1. If a power headroom for support cell i is not reported,
a corresponding Cᵢ area is set to 0.
- V: This area indicates whether a power headroom value has been calculated
based on actual transmission or a reference format. For first type power headroom
information, if a PUSCH is actually transmitted, V is set to 0, and if a reference format
for a PUSCH is used, V is set to 1. For second type PH information, if a PUCCH is
actually transmitted, V is set to 0, and if a reference format for a PUCCH is used, V is
set to 1. For third type PH information, if an SRS is actually transmitted, V is set to 0,
and if a reference format for an SRS is used, V is set to 1. In addition, for first type,
second type, and third type power headroom information, if a V value is 0, there are
P_{cmax, f, c} and MPE fields therefor, and if a V value is 1, the P_{cmax, f, c} and MPE fields
therefor may be omitted.

### [Regarding SRS]

Next, an uplink channel estimation method using sounding reference signal (SRS) transmission of a UE will be described. The base station may configure at least one SRS configuration with regard to each uplink BWP in order to transfer configuration information for SRS transmission to the UE, and may also configure as least one SRS resource set with regard to each SRS configuration. As an example, the base station and the UE may exchange upper signaling information as follows, in order to transfer information regarding the SRS resource set.
srs-ResourceSetId: an SRS resource set index,
srs-ResourceldList: a set of SRS resource indices referred to by SRS resource sets,
resourceType: time domain transmission configuration of SRS resources referred to by SRS resource sets, and may be configured as one of “periodic,” “semi-persistent,” and “aperiodic.” If configured as “periodic” or “semi-persistent,” associated CSI-RS information may be provided according to the place of use of SRS resource sets. If configured as “aperiodic,” an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement,” “codebook,” “nonCodebook,” and “antennaSwitching.”
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

In addition, the base station and the UE may transmit/receive upper layer signaling information in order to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources, and may be configured as one of “periodic,” “semi-persistent,” and “aperiodic” The time domain transmission configuration of SRS resources may be limited to have the same time domain transmission configuration as the SRS resource set including the SRS resources. If the time domain transmission configuration of SRS resources is configured as “periodic” or “semi-persistent,” the time domain transmission configuration may further include an SRS resource transmission cycle and a slot offset (for example, periodicityAndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent.” Intra-slot time-frequency domain resource mapping of the transmitted SRS resource follows resource mapping information configured for the SRS resource, and slot mapping, including the transmission cycle and slot offset, follows periodicityAndOffset configured for the SRS resource. In addition, the spatial domain transmission filter applied to the transmitted SRS resource may refer to spatial relation info configured for the SRS resource, or may refer to associated CSI-RS information configured for the SRS resource set including the SRS resource. If the SRS resource has spatial relation info configured therefor, the spatial domain transmission filter may be determined, without following the same, by referring to configuration information regarding spatial relation info transferred through MAC CE signaling that activates semi-persistent SRS transmission. The UE may transmit the SRS resource inside the uplink BWP activated with regard to the semi-persistent SRS resource activated through upper layer signaling.

For example, the base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the triggered SRS resource set. Intra-slot time-frequency domain resource mapping of the transmitted SRS resource follows resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. In addition, the spatial domain transmission filter applied to the transmitted SRS resource may refer to spatial relation info configured for the SRS resource, or may refer to associated CSI-RS information configured for the SRS resource set including the SRS resource. The UE may transmit the SRS resource inside the uplink BWP activated with regard to the aperiodic SRS resource triggered through DCI.

If the base station triggers aperiodic SRS transmission by the UE through DCI, a minimum time interval may be necessary between the transmitted SRS and the PDCCH including the DCI that triggers aperiodic SRS transmission, in order for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place ofuse of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in consideration of the place of use of the SRS resource set including the transmitted SRS resource, the minimum time interval may be determined as N2 symbols, and if the place of use of the SRS resource set is configured as “nonCodebook” or “beamManagement,” the minimum time interval may be determined as N2+14 symbols. The UE may transmit an aperiodic SRS if the time interval for aperiodic SRS transmission is larger than or equal to the minimum time interval, and may ignore the DCI that triggers the aperiodic SRS if the time interval for aperiodic SRS transmission is smaller than the minimum time interval.

TABLE 29

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, groupHopping, quenceHopping }, |
| resourceType | CHOICE { |
| aperiodic | SEQUENCE { |

```
      ...
    },
```

| | |
|---|---|
| semi-persistent | SEQUENCE { |
| periodicityAndOffset-sp | SRS-PeriodicityAndOffset, |

```
      ...
    },
```

| | |
|---|---|
| periodic | SEQUENCE { |
| periodicityAndOffset-p | SRS-PeriodicityAndOffset, |

```
      ...
    }
  },
```

| | |
|---|---|
| sequenceId | INTEGER (0..1023), |
| spatialRelationInfo | SRS-SpatialRelationInfo |

```
  OPTIONAL, -- Need R
    ...
}
```

Configuration information spatialRelationInfo in Table 29 above may be applied, with reference to one reference signal, to a beam used for SRS transmission corresponding to beam information of the corresponding reference signal. For example, configuration of spatialRelationInfo may include information as in Table 30 below.

TABLE 30

| | |
|---|---|
| SRS-SpatialRelationInfo ::= | SEQUENCE { |
| servingCellId | ServCellIndex OPTIONAL, -- Need S |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the spatialRelationInfo configuration, an SS/PBCH block index, CSI-RS index, or SRS index may be configured as the index of a reference signal to be referred to in order to use beam information of a specific reference signal. Upper signaling referenceSignal corresponds to configuration information indicating which reference signal's beam information is to be referred to for corresponding SRS transmission, ssb-Index refers to the index of an SS/PBCH block, csi-RS-Index refers to the index of a CSI-RS, and srs refers to the index of an SRS. If upper signaling referenceSignal has a configured value of “ssb-Index,” the UE may apply the reception beam which was used to receive the SS/PBCH block corresponding to ssb-Index as the transmission beam for the corresponding SRS transmission. If upper signaling referenceSignal has a configured value of “csi-RS-Index,” the UE may apply the reception beam which was used to receive the CSI-RS corresponding to csi-RS-Index as the transmission beam for the corresponding SRS transmission. If upper signaling referenceSignal has a configured value of “srs,” the UE may apply the reception beam which was used to transmit the SRS corresponding to srs as the transmission beam for the corresponding SRS transmission.

### [Regarding SRS Transmission Power]

As an embodiment of the disclosure, a method in which, when a UE performs transmission through an uplink reference signal (sounding reference signal, SRS) in response to a power control command received from a base station, the UE configures the transmission power of the uplink reference signal and transmits same will be described. Uplink reference signal transmission power (PSRS) of the UE may be determined as [Equation 10] below expressed by a unit of dBm together with an SRS power control adjustment state corresponding to the i-th transmission unit and closed loop index 1. In [Equation 10] below, when the UE supports multiple carrier frequencies in multiple cells, each parameter may be determined by cell c, carrier frequency f, and bandwidth part b, and may be distinguished by the indexes b, f, and c.

$${P}_{SRS , b , f , c} ( i , {q}_{s} , l ) = min \{ \begin{matrix}{P}_{CMAX , f , c} ( i ) , \\ {P}_{0 \_ SRS , b , f , c} ( {q}_{s} ) + 10 {log}_{10} ( {2}^{µ} * {M}_{SRS , b , f , c} ( i ) ) + {a}_{SRS , b , f , c} ( {q}_{s} ) \cdot {PL}_{b , f , c} ( {q}_{d} ) + {h}_{b , f , c} ( i , l )\end{matrix} \} [ dBm ] \qquad [ Equation 10 ]$$

P_{CMAX,f,c}(i): This is maximum transmission power usable by the UE in the i-th transmission unit, and may be determined by the power class of the UE, and parameters activated by the base station and various parameter embedded in the UE.

P_{0_SRS,b,f,c}(qₛ)-: This may be configured by p0 in SRS-ResourceSet, which is higher layer signaling, for bandwidth part b, carrier frequency f, and cell c, and the SRS resource set qₛ may be configured through SRS-ResourceSet and SRS-ResourceSetId, which are higher layer signaling.
μ: Subcarrier spacing configuration value.
M_{SRS,b,f,c}(i): This may indicate a resource amount (e.g., the number of resource block (RB)s used for SRS transmission on the frequency axis) used in the i-th SRS transmission unit.
a_{SRS,b,f,c}(j): This may be configured by alpha, which is higher layer signaling, for bandwidth part b, carrier frequency f, and cell c, and the SRS resource set qₛ may be configured through SRS-ResourceSet and SRS-ResourceSetId, which are higher layer signaling.
PL_{b,f,c}(q_{d}): This represents a pathloss between the base station and the UE, and the UE calculates a pathloss from the difference between the transmission power of a reference signal (RS) resource q_{d} signaled by the base station and the UE reception signal level of the reference signal.
h_{b,f,c}(i, l): This may indicate an SRS power control adjustment state value for the i-th SRS transmission unit corresponding to closed loop index 1 in bandwidth part b, carrier frequency f, and cell c.

The SRS power control adjustment state may be determined through bandwidth part b, carrier frequency f, cell c, and the i-th transmission unit.
If the UE is configured to have the same power control adjustment state value between SRS transmission and PUSCH transmission through the higher layer signaling srs-PowerControlAdjustmentStates, the SRS power control adjustment state may be represented as shown in [Equation 11] below, and f_{b,f,c}(i, l) in [Equation 11] may indicate a current PUSCH power control adjustment state. In this case, f_{b,f,c}(i, l) may be calculated through various methods of embodiment 1 described above, and the value may be substituted into h_{b,f,c}(i, 1).

$${h}_{b , f , c} ( i , l ) = {f}_{b , f , c} ( i , l ) \qquad [ Equation 11 ]$$

If the UE fails to be configured for PUSCH transmission in bandwidth part b, carrier frequency f, and cell c, the UE is configured to have different power control adjustment state values between SRS transmission and PUSCH transmission through the higher layer signaling srs-PowerControlAdjustmentStates, and the higher layer signaling tpc-Accumulation is not configured, an SRS power control adjustment state may be represented independently to closed loop 1 as shown in [Equation 12] below.

$${h}_{b , f , c} ( i ) = {h}_{b , f , c} ( i - {i}_{0} ) + {\sum }_{m = 0}^{c ( {S}_{i} ) - 1} {δ}_{S R S , b , f , c} ( m ) \qquad [ Equation 12 ]$$

δ_{SRS,b,f,c}(m): This may be a value indicated by a TPC command field included in DCI format 2_3, and the value may follow [Table 17] above.
   Σₘ₌₀^{c(S}^{ᵢ}⁾⁻¹δ_{SRS,b,f,c}(m) may indicate the sum of δ_{SRS,b,f,c} for all corresponding transmission units in the particular set Sᵢ according to the above TPC command value. c(Sᵢ) may indicate the number of all elements belonging to the set Sᵢ. Sᵢ may indicate a set of pieces of DCI including all TPC command values for which a TPC command accumulation operation is to be performed for the i-th SRS transmission unit. In order to determine Sᵢ, a start point and an end point on the time dimension are defined and the pieces of DCI received by the UE between the two points may all be included as the elements of Sᵢ.
      The end point for determining Sᵢ may be a point before K_{SRS}(i) symbols from the starting symbol of the i-th SRS transmission unit.
      The start point for determining Sᵢ may be a point before K_{SRS}(i−i₀)−1 symbols from the starting symbol of the (i−i0)-th SRS transmission unit. i0, which is a positive integer, may be determined to be the smallest value satisfying that a time point before K_{SRS}(i−iₒ) symbols from the starting symbol of the (i−i0)-th SRS transmission unit is earlier, in time, than the end point for determining Sᵢ (a point before K_{SRS}(i) symbols from the starting symbol of the i-th SRS transmission unit).
      For example, in a case where the end point for determining Sᵢ is definable to be sym(i) and the time point before K_{SRS}(i−iₒ) symbols from the starting symbol of the (i−i0)-th SRS transmission unit is definable to be sym(i−i0), if sym(i)=sym(i−1)>sym(i−2)>sym(i−3) is satisfied, i0 may be determined to be 2.
If the UE fails to be configured for PUSCH transmission in bandwidth part b, carrier frequency f, and cell c, or the UE is configured to have different power control adjustment state values between SRS transmission and PUSCH transmission through the higher layer signaling srs-PowerControlAdjustmentStates, and the higher layer signaling tpc-Accumulation is configured (i.e., the UE is unable to perform a TPC command accumulation operation and an absolute TCP command value is applicable), an SRS power control adjustment state may be represented independently to closed loop 1 as shown in [Equation 13] below.

$${h}_{b , f , c} ( i ) = {δ}_{SRS , b , f , c} ( i ) \qquad [ Equation 13 ]$$

δ_{SRS,b,f,c}(i) may be a value indicated by a TPC command field included in DCI format 2_3 in bandwidth part b, carrier frequency f, and cell c, as described above, and the value may follow [Table 26] above. For example, if the value of the TPC command field is 0, δ_{SRS,b,f,c} may have a value of −4 dB.

### [Regarding UE Capability Report]

In LTE and NR, a UE may perform a procedure in which, while being connected to a serving base station, the UE reports capability supported by the UE to the corresponding base station. In the following description, the above-described procedure will be referred to as a UE capability report.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA—NR dual connectivity (EN-DC). The UE capability enquiry message may be transmitted initially after the UE is connected to the base station, in general, but may be requested in any condition if needed by the base station.

Upon receiving the UE capability report request from the base station in the above step, the UE configures UE capability according to band information and RAT type requested by the base station. The method in which the UE configures UE capability in an NR system is summarized below.

1. If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. Bands have priority in the order described in FreqBandList.

2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.

3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same can be omitted. This step is applied in MR-DC as well, that is, LTE bands are also applied. BCs remaining after the above step constitute the final “candidate BC list.”

4. The UE selects BCs appropriate for the requested RAT type from the final “candidate BC list” and configures BCs to report. In this step, the UE configures supportedBandCombinationList in a determined order. That is, the UE configures BCs and UE capability to report according to a preconfigured rat-Type order. (nr→eutra-nr→eutra). In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be obtained from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

Hereinafter, embodiments of the disclosure will be described in detail in conjunction with the accompanying drawings. The contents of the disclosure may be applied to FDD and TDD systems. As used herein, upper signaling (or upper layer signaling”) is a method for transferring signals from a base station to a UE by using a downlink data channel of a physical layer, or from the UE to the base station by using an uplink data channel of the physical layer, and may also be referred to as “RRC signaling,” “PDCP signaling,” or “MAC control element (MAC CE).”

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

Hereinafter, for the sake of descriptive convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, when actually applied, a TRP, a beam, or a TCI state may be appropriately replaced with one of the above terms.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to a case in which the UE receives a PDSCH to which cooperative communication is applied, based on conditions similar to those described above.

Hereinafter, embodiments of the disclosure will be described in detail in conjunction with the accompanying drawings. Hereinafter, a base station refers to an entity that allocates resources to a terminal, and may be at least one of a gNode B, a gNB, an eNode B, a node B, a base station (BS), a radio access unit, a base station controller, or a node on a network. A terminal may include a user equipment (UE), a mobile station (MS), a cellular phone, a smartphone, a computer, or a multimedia system capable of performing a communication function. In the following description of embodiments of the disclosure, 5G systems will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may be applied to other communication systems through some modifications without significantly departing from the scope of the disclosure. The contents of the disclosure may be applied to FDD and TDD systems.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, upper layer signaling may refer to signaling corresponding to at least one signaling among the following signaling, or a combination of one or more thereof:
Master information block (MIB);
System information block (SIB) or SIB X (X=1, 2, . . . );
Radio resource control (RRC); and/or
Medium access control (MAC) control element (CE).

In addition, L1 signaling may refer to signaling corresponding to at least one signaling method among signaling methods using the following physical layer channels or signaling, or a combination of one or more thereof:
Physical downlink control channel (PDCCH);
Downlink control information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical uplink control channel (PUCCH); and/or
Uplink control information (UCI).

Hereinafter, determining priority between A and B may be variously described as, for example, selecting an entity having a higher priority according to a predetermined priority rule and performing an operation corresponding thereto, or omitting or dropping operations regarding an entity having a lower priority.

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through several embodiments, but they are not independent of each other, and one or more embodiments may be applied simultaneously or in combination.

### First Embodiment: Method of Configuring Transmission Power Parameter when Unified TCI State is Supported

As an embodiment of the disclosure, a method of configuring, for a UE, a transmission power parameter when the UE supports a unified TCI state is described. This embodiment may be operated in combination with other embodiments.

The higher layer signaling ServingCellConfig may be configured for a UE by a base station and, additionally, the higher layer signaling MIMOParam-r17 may be configured in ServingCellConfig for the UE. The detailed higher layer signaling structures of ServingCellConfig and MIMOParam-r17 may be shown in [Table 31] below.

TABLE 31
ServingCellConfig

| | |
|---|---|
| ServingCellConfig ::= | SEQUENCE { |

...
pathlossReferenceLinking ENUMERATED {spCell, sCell} OPTIONAL, -- Cond SCellOnly

| | | |
|---|---|---|
| mimoParam-r17 | SetupRelease {MIMOParam-r17} | OPTIONAL, -- Need |

M
...
}
MIMOParam-r17 ::= SEQUENCE {

| | |
|---|---|
| additionalPCI-ToAddModList-r17 | SEQUENCE (SIZE(1..maxNrofAdditionalPCI-r17)) OF |

SSB-MTC-AdditionalPCI-r17 OPTIONAL, -- Need N

| additionalPCI-ToReleaseList-r17 | SEQUENCE (SIZE(1..maxNrofAdditionalPCI-r17)) OF | |
|---|---|---|
| AdditionalPCIIndex-r17 | OPTIONAL, -- Need N | |
| unifiedTCI-StateType-r17 | ENUMERATED {separate, joint} | OPTIONAL, -- |

Need R
uplink-PowerControlToAddModList-r17 SEQUENCE (SIZE (1..maxUL-TCI-r17)) OF

| | |
|---|---|
| Uplink-powerControl-r17 | OPTIONAL, -- Need N |

uplink-PowerControlToReleaseList-r17 SEQUENCE (SIZE (1..maxUL-TCI-r17)) OF

| | |
|---|---|
| Uplink-powerControlId-r17 | OPTIONAL, -- Need N |
| sfnSchemePDCCH-r17 | ENUMERATED {sfnSchemeA,sfnSchemeB} |

OPTIONAL, -- Need R

| | |
|---|---|
| sfnSchemePDSCH-r17 | ENUMERATED {sfnSchemeA,sfnSchemeB} |

OPTIONAL -- Need R
}

As shown in [Table 31] above, the higher layer signaling unifiedTCI-StateType-r17 may be configured in MIMOParam-r17 for the UE by the base station, and the value may be one of separate or joint.
The higher layer signaling unifiedTCI-StateType-r17 being configured for the UE as separate may imply that, when the UE receives a configuration and indication related to a unified TCI state from the base station, a TCI state (e.g., a DL TCI state) applicable for downlink reception and a TCI state (e.g., UL TCI state) applicable for uplink transmission are individually configurable and indicatable. In this case, each of the higher layer signalings dl-OrJointTCI-StateList and ul-TCI-ToAddModList indicating lists of DL TCI states and UL TCI states may be configured for the UE by the base station.
The higher layer signaling unifiedTCI-StateType-r17 being configured for the UE as joint may imply that, when the UE receives a configuration and indication related to a unified TCI state from the base station, a TCI state (e.g., a joint TCI state) applicable for downlink reception and uplink transmission is collectively configurable and indicatable. In this case, each of the higher layer signaling dl-OrJointTCI-StateList indicating a list of joint TCI states may be configured for the UE by the base station.

As shown in [Table 31], the higher layer signaling uplink-PowerControlToAddModList may be configured in MIMOParam-r17 for the UE. The higher layer signaling uplink-PowerControlToAddModList, if the higher layer signaling unifiedTCI-StateType is configured in a corresponding serving cell for the UE, may include transmission power parameters for a PUSCH, a PUCCH, and an SRS for the UE. According to the higher layer signaling uplink-PowerControlToAddModList, a corresponding parameter may include a list of a maximum of 64 values of Uplink-powerControl-r17 and Uplink-powerControlId-r17. The higher layer signaling Uplink-powerControl-r17 may have a structure as shown in [Table 32] below.

As shown in [Table 31], pathlossReferenceLinking may be configured in ServingCellConfig for the UE. The higher layer signaling pathlossReferenceLinking may indicate which of an SpCell or SCell in which the UE refers to a list of reference signals for pathloss amount measurement.

TABLE 32
Uplink-powerControl

Uplink-powerControl-r17 ::= SEQUENCE {

| ul-powercontrolId-r17 | Uplink-powerControlId-r17, | |
|---|---|---|
| p0AlphaSetforPUSCH-r17 | P0AlphaSet-r17 | OPTIONAL, -- Need R |
| p0AlphaSetforPUCCH-r17 | P0AlphaSet-r17 | OPTIONAL, -- Need R |
| p0AlphaSetforSRS-r17 | P0AlphaSet-r17 | OPTIONAL -- Need R |

}

| P0AlphaSet-r17 ::= | SEQUENCE { | |
|---|---|---|
| p0-r17 | INTEGER (−16..15) | OPTIONAL, -- Need R |
| alpha-r17 | Alpha | OPTIONAL, -- Need S |

| | |
|---|---|
| closedLoopIndex-r17 | ENUMERATED { i0, i1 } |

}
Uplink-powerControlId-r17 ::= INTEGER(1.. maxUL-TCI-r17)

As shown in [Table 32], the UE may include ul-powercontrolld-r17 in one Uplink-powerControl-r17 parameter, individual POAlphaSet-r17 applicable to each of a PUSCH, a PUCCH, or an SRS may be configured for the UE, and each POAlphaSet-r17 may include p, alpha, and a closed loop index that are uplink transmission power parameters described above.

The higher layer signalings in [Table 31] above maybe appliedto allbandwidth parts in the corresponding serving cell. [Table 33] below represents a higher layer signaling structure configurable for the UE for each uplink bandwidth part (e.g., BWP-UplinkDedicated).

TABLE 33
BWP-UplinkDedicated

| BWP-UplinkDedicated ::= | SEQUENCE { | |
|---|---|---|
| pucch-Config | SetupRelease { PUCCH-Config } | OPTIONAL, -- Need M |
| pusch-Config | SetupRelease { PUSCH-Config } | OPTIONAL, -- Need M |

| | |
|---|---|
| configuredGrantConfig | SetupRelease { ConfiguredGrantConfig } |

OPTIONAL, -- Need M

| | | |
|---|---|---|
| srs-Config | SetupRelease { SRS-Config } | OPTIONAL, -- Need M |

...
[[

| | |
|---|---|
| ul-TCI-StateList-r17 | CHOICE { |
| explicitlist | SEQUENCE { |
| ul-TCI-ToAddModList-r17 | SEQUENCE (SIZE (1..maxUL-TCI-r17)) OF TCI-UL- |
| State-r17 | OPTIONAL, -- Need N |
| ul-TCI-ToReleaseList-r17 | SEQUENCE (SIZE (1..maxUL-TCI-r17)) OF TCI-UL- |
| StateId-r17 | OPTIONAL -- Need N |

},

| unifiedTCI-StateRef-r17 | ServingCellAndBWP-Id-r17 | |
|---|---|---|
| } | OPTIONAL, -- Need R | |
| ul-powerControl-r17 | Uplink-powerControlId-r17 | OPTIONAL, -- Cond |

NoTCI-PC
...
[[

| | |
|---|---|
| pathlossReferenceRSToAddModList-r17 | SEQUENCE (SIZE |

(1..maxNrofPathlossReferenceRSs-r17)) OF PathlossReferenceRS-r17

| | |
|---|---|
| | OPTIONAL, -- Need N |
| pathlossReferenceRSToReleaseList-r17 | SEQUENCE (SIZE |

(1..maxNrofPathlossReferenceRSs-r17)) OF PathlossReferenceRS-Id-r17

OPTIONAL -- Need N

]]
}

As shown in [Table 33], the higher layer signaling ul-TCI-StateList-r17 may be configured for the UE, and one of explicitlist or unifiedTCI-StateRef-r17 may be configured for the UE with respect to the higher layer signaling. If explicitlist is configured for the UE with respect to the higher layer signaling ul-TCI-StateList-r17, a list of UL TCI states usable in a corresponding uplink bandwidth part may be explicitly configured for the UE through ul-TCI-ToAddModList-r17. If unifiedTCI-StateRef-r17 is configured for the UE with respect to the higher layer signaling ul-TCI-StateList-r17, a joint TCI state or UL TCI state usable in a corresponding uplink bandwidth part may not be explicitly configured for the UE for the uplink bandwidth part, and the UE may refer to and use a joint TCI state or UL TCI state configured for another uplink bandwidth part. The higher layer signaling unifiedTCI-StateRef-r17 may indicate an index of a random bandwidth part in a random serving cell. In addition, the UE may expect that a serving cell including a bandwidth part for which unifiedTCI-StateRef-r17 is configured, and a random serving cell including a bandwidth part configurable by the base station through unifiedTCI-StateRef-r17 have the same value of unifiedTCI-StateType.

As shown in [Table 33], if unifiedTCI-StateType is configured for the UE, the higher layer signaling ul-powerControl may be configured for the UE and ul-powerControl may refer to one value of Uplink-powerControlId-r17. In this case, the higher layer signaling ul-powerControl may be configured for the UE with respect to all uplink bandwidth parts in a particular serving cell, or the higher layer signaling ul-powerControl may not be configured with respect to all the uplink bandwidth parts. If unifiedTCI-StateRef-r17 is configured in BWP-UplinkDedicated for the UE or the UE receives a configuration referring to a different serving cell and bandwidth part through a value of unifiedTCI-StateRef-r17 in PDSCH-Config, and unifiedTCI-StateType is configured as joint, the UE may expect that ul-powerControl is configured for the UE in a referred serving cell and all uplink bandwidth parts in the serving cell, or ul-powerControl is not configured in the referred serving cell and all the uplink bandwidth parts in the serving cell. The higher layer signaling ul-powerControl may be configured for the UE only when a condition of NoTCI-PC is satisfied, and the condition of NoTCI-PC may indicate that the higher layer signaling ul-powerControl is not configured in a joint TCI state or UL TCI state in a corresponding serving cell.

As shown in [Table 33], if unifiedTCI-StateType is configured for the UE, the higher layer signaling pathlossReferenceRSToAddModList-r17 may be configured for the UE, and the higher layer signaling may indicate a list of reference signals usable to calculate a pathloss amount when a PUSCH, a PUCCH, or an SRS is transmitted in a case where the UE supports a unified TCI state. If unifiedTCI-StateType is not configured for the UE, the UE may not include any list in the higher layer signaling.

If unifiedTCI-StateType is configured for the UE, when a reference signal for pathloss amount measurement is indicated to the UE through a TCI state indication, the indicated reference signal for pathloss amount measurement may indicate a reference signal for pathloss amount measurement configured in a serving cell to which the indicated TCI state is applied. In this case, if pathlossReferenceLinking is configured for the UE, the UE may consider that the indicated reference signal for pathloss amount measurement indicates a reference signal for pathloss amount measurement configured in a serving cell configured through pathlossReferenceLinking.

If the UE operates based on a unified TCI state, that is, if the higher layer signaling unifiedTCI-StateType is configured for the UE as joint or separate, a higher layer signaling structure of a TCI state indicatable to the UE by the base station may be determined. If the higher layer signaling unifiedTCI-StateType is configured for the UE as joint, a joint TCI state may be configured and indicated for the UE by the base station by using a higher layer signaling structure shown in [Table 34] below. If the higher layer signaling unifiedTCI-StateType is configured for the UE as separate, a DL TCI state may be configured and indicated for the UE by the base station by using a higher layer signaling structure shown in [Table 34] below, and a UL TCI state may be configured and indicated for the UE by the base station by using a higher layer signaling structure shown in [Table 35] below.

Ifthe higher layer signaling unifiedTC-StateType is configured for the UE as joint, the UE may expect that pathlossReferenceRS-Id-r17 in [Table 34] below is always configured, if unifiedTCI-StateType is configured as separate or unifiedTC-StateType is not configured, the UE may expect that pathlossReferenceRS-Id-r17 is not configured, and the name of such a condition may be defined as JointTCI1.

If the higher layer signaling unifiedTCI-StateType is configured for the UE as separate, the UE may expect that pathlossReferenceRS-Id-r17 in [Table 35] below is always configured, and the name of such a condition may be defined as mandatory.

TABLE 34
TCI-State

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

```
  ...,
  [[
```

| | | |
|---|---|---|
| additionalPCI-r17 | AdditionalPCIIndex-r17 | OPTIONAL, -- Need R |
| pathlossReferenceRS-Id-r17 | PathlossReferenceRS-Id-r17 | OPTIONAL, -- Cond |

JointTCI1

| | | |
|---|---|---|
| ul-powerControl-r17 | Uplink-powerControlId-r17 | OPTIONAL -- Cond |

JointTCI
]]
}

TABLE 35
TCI-UL-State

| TCI-UL-State-r17 ::= | SEQUENCE { | |
|---|---|---|
| tci-UL-StateId-r17 | TCI-UL-StateId-r17, | |
| servingCellId-r17 | ServCellIndex | OPTIONAL, -- Need R |
| bwp-Id-r17 | BWP-Id | OPTIONAL, -- Cond CSI-RSorSRS-Indicated |

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | | |
|---|---|---|
| additionalPCI-r17 | AdditionalPCIIndex-r17 | OPTIONAL, -- Need R |
| ul-powerControl-r17 | Uplink-powerControlId-r17 | OPTIONAL, -- Need R |
| pathlossReferenceRS-Id-r17 | PathlossReferenceRS-Id-r17 | OPTIONAL, -- Cond |

Mandatory
...
}

In consideration of the higher layer signaling structure described above, the UE may use two types of uplink transmission power determination methods when operating according to a unified TCI state.

### [Method 1-1] Basic Transmission Power Determination Method: Application of Common Transmission Power Parameter

The parameter ul-powerControl may be configured for each of one or more uplink bandwidth parts configured in a particular serving cell. That is, when the UE performs all uplink transmission in each uplink bandwidth part, the UE may apply a set of transmission power parameters (e.g., p0, alpha, and closed loop index) identifiable through ul-powerControl configured for a corresponding uplink bandwidth part. Therefore, the UE does not use an individual transmission power parameter according to an uplink channel and signal, and may use only one common set of transmission power parameters.

### [Method 1-2] Additional Transmission Power Determination Method: Different Transmission Power Parameters Applicable

The parameter ul-powerControl is not configured for each of one or more uplink bandwidth parts configured in a particular serving cell, and the UE may apply a set of transmission power parameters (e.g., p0, alpha, and closed loop index) identifiable through the higher layer signaling ul-powerControl-r17 in a joint TCI state or UL TCI state as shown in [Table 34] or [Table 35]. Therefore, different values of ul-powerControl-r17 may be configured for the UE for different joint TCI states or UL TCI states, accordingly, the UE may operate various transmission power parameters compared to [Method 1-1], and use different transmission power parameters according to uplink transmission situations and UE and base station operation scenarios.

Commonly for [Method 1-1] and [Method 1-2] described above, a reference signal for pathloss amount measurement may be configured for the UE in a joint TCI state or UL TCI state. That is, as described above, if the UE operates according to a unified TCI state, a reference signal for pathloss amount measurement may be always configured for the UE in a joint TCI state or UL TCI state, and the UE may determine a pathloss amount to be reflected at the time of determination of uplink transmission power by using a reference signal for pathloss amount measurement configured in a configured and indicated unified TCI state. In addition, the UE may track a maximum of four reference signals for pathloss amount measurement per random serving cell to update a maximum of four different pathloss amounts.

The UE may transfer whether the UE supports a combination of at least one of [Method 1-1] and [Method 1-2], to the base station through a UE capability report. In addition, a combination of at least one of [Method 1-1] and [Method 1-2] may be configured for the UE by the base station through higher layer signaling.

If the UE does not operate according to a unified TCI state, that is, if unifiedTCI-StateType is not configured for the UE, the UE may consider the following items at the time of determination of the transmission power of a PUSCH, a PUCCH, and an SRS, and such a method may be named [Method 1-3].

Higher layer signaling related to a transmission power parameter applicable at the time of PUSCH transmission may be configured for the UE according to [Table 36] and [Table 37] below.

TABLE 36
PUSCH-PowerControl

| PUSCH-PowerControl ::= | SEQUENCE { | |
|---|---|---|
| tpc-Accumulation | ENUMERATED { disabled } | OPTIONAL, -- Need S |
| msg3-Alpha | Alpha | OPTIONAL, -- Need S |
| p0-NominalWithoutGrant | INTEGER (−202..24) | OPTIONAL, -- Need M |

| | |
|---|---|
| p0-AlphaSets | SEQUENCE (SIZE (1..maxNrofP0-PUSCH-AlphaSets)) OF P0- |
| PUSCH-AlphaSet | OPTIONAL, -- Need M |
| pathlossReferenceRSToAddModList | SEQUENCE (SIZE (1..maxNrofPUSCH- |

PathlossReferenceRSs)) OF PUSCH-PathlossReferenceRS

OPTIONAL, -- Need N

pathlossReferenceRSToReleaseList SEQUENCE (SIZE (1..maxNrofPUSCH-
PathlossReferenceRSs)) OF PUSCH-PathlossReferenceRS-Id

| | |
|---|---|
| | OPTIONAL, -- Need N |
| twoPUSCH-PC-AdjustmentStates | ENUMERATED {twoStates} |

OPTIONAL, -- Need S

| | | |
|---|---|---|
| deltaMCS | ENUMERATED {enabled} | OPTIONAL, -- Need S |

| | |
|---|---|
| sri-PUSCH-MappingToAddModList | SEQUENCE (SIZE (1..maxNrofSRI-PUSCH- |

Mappings)) OF SRI-PUSCH-PowerControl

| | |
|---|---|
| | OPTIONAL, -- Need N |
| sri-PUSCH-MappingToReleaseList | SEQUENCE (SIZE (1..maxNrofSRI-PUSCH- |

Mappings)) OF SRI-PUSCH-PowerControlId

OPTIONAL -- Need N

}

TABLE 37
PUSCH-PowerControl-v1610

| | |
|---|---|
| PUSCH-PowerControl-v1610 ::= | SEQUENCE { |

pathlossReferenceRSToAddModListSizeExt-v1610 SEQUENCE (SIZE
(1..maxNrofPUSCH-PathlossReferenceRSsDiff-r16)) OF PUSCH-PathlossReferenceRS-r16

OPTIONAL, -- Need N

pathlossReferenceRSToReleaseListSizeExt-v1610 SEQUENCE (SIZE (1..maxNrofPUSCH-
PathlossReferenceRSsDiff-r16)) OF PUSCH-PathlossReferenceRS-Id-v1610

| | OPTIONAL, -- Need N | |
|---|---|---|
| p0-PUSCH-SetList-r16 | SEQUENCE (SIZE (1..maxNrofSRI-PUSCH-Mappings)) OF | |
| P0-PUSCH-Set-r16 | OPTIONAL, -- Need R | |
| olpc-ParameterSet | SEQUENCE { | |
| olpc-ParameterSetDCI-0-1-r16 | INTEGER (1..2) | OPTIONAL, -- Need R |
| olpc-ParameterSetDCI-0-2-r16 | INTEGER (1..2) | OPTIONAL -- Need R |

| | |
|---|---|
| } | OPTIONAL, -- Need M |

```
  ...,
  [[
  sri-PUSCH-MappingToAddModList2-r17 SEQUENCE (SIZE (1..maxNrofSRI-PUSCH-
Mappings)) OF SRI-PUSCH-PowerControl
```

OPTIONAL, -- Need N

sri-PUSCH-MappingToReleaseList2-r17 SEQUENCE (SIZE (1..maxNrofSRI-PUSCH-
Mappings)) OF SRI-PUSCH-PowerControlId OPTIONAL, -- Need N

| | |
|---|---|
| p0-PUSCH-SetList2-r17 | SEQUENCE (SIZE (1..maxNrofSRI-PUSCH-Mappings)) OF |
| P0-PUSCH-Set-r16 | OPTIONAL, -- Need R |

dummy SEQUENCE (SIZE (1..maxNrofPUSCH-PathlossReferenceRSs-r16)) OF

| | |
|---|---|
| DummyPathlossReferenceRS-v1710 | OPTIONAL -- Need N |

]]
}

Description of each higher layer signaling parameter in [Table 36] and [Table 37] may be as follows.
tpc-Accumulation: If tpc-Accumulation is not configured for the UE, when a TPC command indicating a change in PUSCH transmission power is received, the UE may perform an operation of additionally accumulating the TPC command to previously indicated TPC command values. If disabled is configured for tpc-Accumulation for the UE, when a TPC command indicating a change in PUSCH transmission power is received, the UE may not perform an operation of accumulating and perform an operation of applying an absolute TPC.
msg3-Alpha: An explicit alpha value for a Msg3 PUSCH may be configured for the UE through this higher layer signaling. If this parameter does not exist, the UE may use 1 as an alpha value for a Msg3 PUSCH.
twoPUSCH-PC-AdjustmentStates: The UE may determine the number of closed loop indexes usable for a PUSCH through this higher layer signaling. If the higher layer signaling is configured, the UE may use two closed loop indexes for a PUSCH, and if same is not configured, the UE may use one closed loop index for a PUSCH.
p0-NominalWithoutGrant: A p0 value to be applied to a configured grant-based PUSCH may be configured for the UE through this higher layer signaling. The UE may consider −202 to 24 at intervals of 2 for a p0 value configurable through the higher layer signaling (e.g., −202, −200, −198, . . . , 20, 22, and 24).
deltaMCS: The UE may determine whether to apply a delta MCS through this higher layer signaling. A delta MCS is a parameter capable of determining Δ_{TF,b,f,c}(i) in [Equation 5], and if the higher layer signaling fails to be configured for the UE, the UE may determine Δ_{TF,b,f,c}(i) to be 0, and if same is configured, the UE may determine Δ_{TF,b,f,c}(i) according to a modulation coding scheme (MCS) and a format (transport format (TF), e.g., whether UL-SCH is included or whether CSI is included)) of information transmitted through a PUSCH.
olpc-ParameterSetDCI-0-1, olpc-ParameterSetDCI-0-2: The UE may, if there is no SRS resource indicator (SRI) field in DCI formats 0_1 and 0_2, determine the bit length of an open-loop power control parameter set indication field in DCI formats 0_1 and 0_2 through this higher layer signaling.
p0-AlphaSets: A combination of p0 and alpha may be configured for the UE through this parameter. The parameter may be included in a random SRI-PUSCH-PowerControl in sri-PUSCH-MappingToAddModList.
pathlossReferenceRSToAddModList: A list of reference signals for measuring a pathloss amount to be used at the time of determination of PUSCH transmission power, may be configured for the UE through this parameter.
p0-PUSCH-SetList: A list for additional p0 corresponding to each codepoint of an SRI may be configured for the UE through this higher layer signaling. If this parameter is configured, the UE may assume that an open-loop power control parameter set indication field configured by 1 bit or 2 bits exists in DCI.
p0-PUSCH-SetList2: A list for additional p0 corresponding to each codepoint of a second SRI may be configured for the UE through this higher layer signaling. The second SRI may correspond to a second SRS resource set when two different SRS resource sets having usage configured to be codebook or non-codebook are configured for the UE, and in this case, p0-PUSCH-SetList may correspond to a first SRS resource set.

If the UE does not operate according to a unified TCI state, that is, if unifiedTCI-StateType is not configured for the UE, higher layer signaling related to a transmission power parameter applicable at the time of PUCCH transmission may be configured for the UE according to [Table 38] below.

TABLE 38
PUCCH-PowerControl

| PUCCH-PowerControl ::= | SEQUENCE { | |
|---|---|---|
| deltaF-PUCCH-f0 | INTEGER (−16..15) | OPTIONAL, -- Need R |
| deltaF-PUCCH-f1 | INTEGER (−16..15) | OPTIONAL, -- Need R |
| deltaF-PUCCH-f2 | INTEGER (−16..15) | OPTIONAL, -- Need R |
| deltaF-PUCCH-f3 | INTEGER (−16..15) | OPTIONAL, -- Need R |
| deltaF-PUCCH-f4 | INTEGER (−16..15) | OPTIONAL, -- Need R |

| | |
|---|---|
| p0-Set | SEQUENCE (SIZE (1..maxNrofPUCCH-P0-PerSet)) OF P0-PUCCH |

OPTIONAL, -- Need M

| | |
|---|---|
| pathlossReferenceRSs | SEQUENCE (SIZE (1..maxNrofPUCCH-PathlossReferenceRSs)) |

OF PUCCH-PathlossReferenceRS

| | OPTIONAL, -- Need M | |
|---|---|---|
| twoPUCCH-PC-AdjustmentStates | ENUMERATED {twoStates} | OPTIONAL, |

```
-- Need S
  ...,
  [[
```

| | |
|---|---|
| pathlossReferenceRSs-v1610 | SetupRelease { PathlossReferenceRSs-v1610 } |

OPTIONAL -- Need M
]]
}

Description of each higher layer signaling parameter in [Table 38] may be as follows.
deltaF-PUCCH-f0, deltaF-PUCCH-f1, deltaF-PUCCH-f2, deltaF-PUCCH-f3, deltaF-PUCCH-f4: If this parameter is configured for the UE, a value for Δ_{F} PUCCH(F) in [Equation 3] may be configured for the UE for each PUCCH format. For example, deltaF-PUCCH-fx may indicate a Δ_{F PUCCH} (F) value for PUCCH format x (0, 1, 2, 3, and 4 may be possible as x). If the parameter is not configured, Δ_{F PUCCH} (F) may be considered and used as 0.
twoPUCCH-PC-AdjustmentStates: The UE may determine the number of closed loop indexes usable for a PUCCH through this higher layer signaling. If the higher layer signaling is configured, the UE may use two closed loop indexes for a PUCCH, and if same is not configured, the UE may use one closed loop index for a PUCCH.
p0-Set: A p0 value may be configured for the UE through this parameter.
pathlossReferenceRSs: A list of reference signals for measuring a pathloss amount to be used at the time of determination of PUCCH transmission power, may be configured for the U through this parameter.

Higher layer signaling related to a transmission power parameter applicable at the time of SRS transmission may be configured for the UE according to [Table 39] and [Table 40] below.

TABLE 39
SRS-Config

| SRS-Config ::= | SEQUENCE { | |
|---|---|---|
| srs-ResourceSetToReleaseList | SEQUENCE (SIZE(1..maxNrofSRS-ResourceSets)) OF | |
| SRS-ResourceSetId | OPTIONAL, -- Need N | |
| srs-ResourceSetToAddModList | SEQUENCE (SIZE(1..maxNrofSRS-ResourceSets)) OF | |
| SRS-ResourceSet | OPTIONAL, -- Need N | |
| srs-ResourceToReleaseList | SEQUENCE (SIZE(1..maxNrofSRS-Resources)) OF SRS- | |
| ResourceId | OPTIONAL, -- Need N | |
| srs-ResourceToAddModList | SEQUENCE (SIZE(1..maxNrofSRS-Resources)) OF SRS- | |
| Resource | OPTIONAL, -- Need N | |
| tpc-Accumulation | ENUMERATED {disabled} | OPTIONAL, -- Need |

```
S
  ...,
  [[
```

| | | |
|---|---|---|
| srs-RequestDCI-1-2-r16 | INTEGER (1..2) | OPTIONAL, -- Need S |
| srs-RequestDCI-0-2-r16 | INTEGER (1..2) | OPTIONAL, -- Need S |

srs-ResourceSetToAddModListDCI-0-2-r16 SEQUENCE (SIZE(1..maxNrofSRS-

| | |
|---|---|
| ResourceSets)) OF SRS-ResourceSet | OPTIONAL, -- Need N |

srs-ResourceSetToReleaseListDCI-0-2-r16 SEQUENCE (SIZE(1..maxNrofSRS-

| | |
|---|---|
| ResourceSets)) OF SRS-ResourceSetId | OPTIONAL, -- Need N |
| srs-PosResourceSetToReleaseList-r16 | SEQUENCE (SIZE(1..maxNrofSRS- |

PosResourceSets-r16)) OF SRS-PosResourceSetId-r16

| | |
|---|---|
| | OPTIONAL, -- Need N |
| srs-PosResourceSetToAddModList-r16 | SEQUENCE (SIZE(1..maxNrofSRS- |

| | |
|---|---|
| PosResourceSets-r16)) OF SRS-PosResourceSet-r16 | OPTIONAL,-- Need N |

| | |
|---|---|
| srs-PosResourceToReleaseList-r16 | SEQUENCE (SIZE(1..maxNrofSRS-PosResources- |
| r16)) OF SRS-PosResourceId-r16 | OPTIONAL,-- Need N |
| srs-PosResourceToAddModList-r16 | SEQUENCE (SIZE(1..maxNrofSRS-PosResources- |
| r16)) OF SRS-PosResource-r16 | OPTIONAL -- Need N |

]]
}

TABLE 40
SRS-ResourceSet

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) OF SRS- |

ResourceId OPTIONAL, -- Cond Setup

| resourceType | CHOICE { | |
|---|---|---|
| aperiodic | SEQUENCE { | |
| aperiodicSRS-ResourceTrigger | INTEGER (1..maxNrofSRS-TriggerStates-1), | |
| csi-RS | NZP-CSI-RS-ResourceId | OPTIONAL, -- Cond NonCodebook |
| slotOffset | INTEGER (1..32) | OPTIONAL, -- Need S |

```
      ...,
      [[
```

| | |
|---|---|
| aperiodicSRS-Resource TriggerList | SEQUENCE (SIZE(1..maxNrofSRS-TriggerStates- |

2))

| | |
|---|---|
| OF INTEGER (1..maxNrofSRS-TriggerStates-1) | OPTIONAL -- Need M |

```
      ]]
    },
```

| semi-persistent | SEQUENCE { | |
|---|---|---|
| associatedCSI-RS | NZP-CSI-RS-ResourceId | OPTIONAL, -- Cond |

```
NonCodebook
      ...
    },
```

| periodic | SEQUENCE { | |
|---|---|---|
| associatedCSI-RS | NZP-CSI-RS-ResourceId | OPTIONAL, -- Cond |

```
NonCodebook
      ...
    }
  },
```

| | |
|---|---|
| usage | ENUMERATED {beamManagement, codebook, nonCodebook, |

antennaSwitching},

| | | |
|---|---|---|
| alpha | Alpha | OPTIONAL, -- Need S |
| p0 | INTEGER (−202..24) | OPTIONAL, -- Cond Setup |
| pathlossReferenceRS | PathlossReferenceRS-Config | OPTIONAL, -- Need M |

| | |
|---|---|
| srs-PowerControlAdjustmentStates | ENUMERATED { sameAsFci2, separateClosedLoop} |
| OPTIONAL, -- Need S | |
| ..., | |
| [[ | |
| pathlossReferenceRSList-r16 | SetupRelease { PathlossReferenceRSList-r16} |

```
OPTIONAL -- Need M
  ]],
  [[
```

| | | |
|---|---|---|
| usagePDC-r17 | ENUMERATED {true} | OPTIONAL, -- Need R |

| | |
|---|---|
| availableSlotOffsetList-r17 | SEQUENCE (SIZE(1..4)) OF AvailableSlotOffset-r17 |

OPTIONAL, -- Need R

| | | |
|---|---|---|
| followUnifiedTCI-StateSRS-r17 | ENUMERATED {enabled} | OPTIONAL -- |

Need R
]]
}

Description of each higher layer signaling parameter in [Table 39] and [Table 40] may be as follows.
tpc-Accumulation: If tpc-Accumulation is not configured for the UE, when a TPC command indicating a change in SRS transmission power is received, the UE may perform an operation of additionally accumulating the TPC command to previously indicated TPC command values. If disabled is configured for tpc-Accumulation for the UE, when a TPC command indicating a change in SRS transmission power is received, the UE may not perform an operation of accumulating and perform an operation of applying an absolute TPC. Such an absolute TPC operation may be possible when an SRS does not share a closed loop index with a PUSCH.
Alpha: An alpha value for determining SRS transmission power may be configured for the UE through this higher layer signaling.
p0: An p0 value in SRS-resourceSet for determining SRS transmission power may be configured for the UE through this higher layer signaling. If the higher layer signaling unifiedTCI-StateType is not configured for the UE, the UE may determine a P_{0_SRS,b,f,c} (qₛ) value in [Equation 10] through the higher layer signaling p0. If the higher layer signaling unifiedTCI-StateType is configured for the UE, the UE may determine a P_{0_SRS,b,f,c}(qₛ) value in [Equation 10] to be the sum of p0 in the higher layer signaling SRS-resourceSet and a p0 value (e.g., P_{0_UE_SRS,b,f,c}(qₛ)) configurable in p0AlphaSetforSRS in Uplink-powerControlId-r17. Uplink-powerControlId-r17 may be determined through the following method.
   If the UE determines uplink transmission power through [Method 1-1], the UE may determine same through one value of ul-powerControl configured in a particular uplink bandwidth part.
   If the UE determines uplink transmission power through [Method 1-2].
      If the higher layer signaling followUnifiedTCIstateSRS is configured in SRS resource set for the UE, the UE may be provided with the values of P_{0_UE_SRS,b,f,c}(qₛ), alpha, and srs-PowerControlAdjustmentStates, based on the higher layer signaling p0AlphaSetforSRS associated with TCIState or UL-TCIstate indicated by the base station, and the higher layer signaling pathlossReferenceRS indicating a pathloss reference signal may be provided based on pathlossReferenceRS-Id-r17 that is higher layer signaling associated with or included in TCIState or UL-TCIstate indicated by the base station.
      If the higher layer signaling followUnifiedTCIstateSRS is not configured in SRS resource set for the UE, the UE may be provided with the values of P_{0_UE_SRS,b,f,c}(qₛ), alpha, and srs-PowerControlAdjustmentStates, based on the higher layer signaling p0AlphaSetforSRS associated with TCIState or UL-TCIstate configured for an SRS resource having the lowest index in the SRS resource set, and the higher layer signaling pathlossReferenceRS indicating a pathloss reference signal may be provided based on pathlossReferenceRS-Id-r17 that is higher layer signaling associated with or included in TCIState or UL-TCIstate configured for an SRS resource having the lowest index in the SRS resource set.
srs-PowerControlAdjustmentStates: A closed loop index used at the time of determination of SRS transmission power may be configured for the UE through this higher layer signaling. If the higher layer signaling fails to be configured for the UE, the UE may share a closed loop index of an SRS with a first closed loop index of a PUSCH. If the higher layer signaling is configured for the UE as sameAsFci2, the UE may share a closed loop index of an SRS with a second closed loop index of a PUSCH. Higher layer signaling may be configured for the UE to have a maximum of two closed loop indexes for a PUSCH. If the higher layer signaling is configured for the UE as separateClosedLoop, the UE does not share a closed loop index of an SRS with a closed loop index of a PUSCH and the index may be individually configured for the UE.
   If the higher layer signaling unifiedTCI-StateType is configured for the UE and srs-PowerControlAdjustmentStates is configured in a particular SRS resource set as separateClosedLoop, the UE may consider that SRS resources included in the SRS resource set are connected to a closed loop index independent to a PUSCH. The UE may consider a closed loop index independent to a PUSCH, as described above, regardless of a closed loop connected to a TCI state indicated by the base station.
   If the higher layer signaling unifiedTCI-StateType is configured for the UE and srs-PowerControlAdjustmentStates is not configured in a particular SRS resource set as separateClosedLoop (i.e., srs-PowerControlAdjustmentStates is not configured or is configured as sameAsFci2), the UE may consider that SRS resources included in the SRS resource set are connected to a first or second closed loop index connected to a PUSCH. If a closed loop connected to a TCI state indicated by the base station is i0, the UE may consider that, at the time of determination of the transmission power of an SRS to which the TCI state is applied, the SRS resources are connected to a first closed loop index connected to a PUSCH, and if the closed loop is i1, the UE may consider that, at the time of determination of the transmission power of an SRS to which the TCI state is applied, the SRS resources are connected to a second closed loop index connected to a PUSCH.
pathlossReferenceRSList: A list of reference signals capable of measuring a pathloss amount for determining SRS transmission power may be configured for the UE through this higher layer signaling.

If the UE operates according to a unified TCI state, that is, if unifiedTCI-StateType is configured for the UE, some or all of higher layer signalings used at the time of determination of the transmission power of a PUSCH, a PUCCH, and an SRS in a case where the UE does not operate according to a unified TCI state may not be configured.

For example, if the UE operates according to a unified TCI state, that is, if unifiedTCI-StateType is configured for the UE, PUSCH-PowerControl in [Table 36] and [Table 37] may not be configured for the UE at the time of determination of PUSCH transmission power. That is, if the UE operates according to a unified TCI state, tpc-Accumulation, msg3-Alpha, twoPUSCH-PC-AdjustmentStates, p0-NominalWithoutGrant, deltaMCS, olpc-ParameterSetDCI-0-1, olpc-ParameterSetDCI-0-2, p0-AlphaSets, pathlossReferenceRSToAddModList, p0-PUSCH-SetList, and p0-PUSCH-SetList2, which may be included in PUSCH-PowerControl in [Table 36] and [Table 37], may not be configured for the UE. As described above, when the above higher layer signaling fails to be configured for the UE, the following restrictions may exist.
If tpc-Accumulation is not configured for the UE, only an accumulation method may be configured for the UE for a TPC command that may be received from the base station. That is, the UE is unable to apply an absolute TPC method.
If msg3-Alpha is not configured for the UE, the UE may use 1 as an alpha value for a Msg3 PUSCH.
If twoPUSCH-PC-AdjustmentStates is not configured for the UE, only one closed loop index may be configured for the UE at the time of determination of PUSCH transmission power.
If p0-NominalWithoutGrant is not configured for the UE, the UE is unable to use a particular p0 value for configured grant-based PUSCH transmission, and may use a nominal p0 value at the time of RAR UL grant-based PUSCH transmission.
If deltaMCS is not configured for the UE, the UE may determine Δ_{TF,b,f,c} (i) in [Equation 5] to be 0.
If olpc-ParameterSetDCI-0-1, olpc-ParameterSetDCI-0-2 is not configured for the UE, the UE is unable to determine the bit length of an open-loop power control parameter set indication field in DCI format 0_1 and 0_2 when there is no SRI field.
If p0-PUSCH-SetList or p0-PUSCH-SetList2 is not configured for the UE, there may be no open-loop power control parameter set indication field in DCI format 0_1 and 0_2.
Even if p0-AlphaSets is not configured for the UE, p0 and alpha in Uplink-powerControl-r17 connected to a joint TCI state or UL TCI state may be configured and indicated for the UE and the UE may determine PUSCH transmission power.
Even if pathlossReferenceRSToAddModList is not configured for the UE, pathlossReferenceRS-Id-r17 included in a joint TCI state or UL TCI state may be configured and indicated for the UE and the UE may determine PUSCH transmission power.

For example, if the UE operates according to a unified TCI state, that is, if unifiedTCI-StateType is configured for the UE, PUCCH-PowerControl in [Table 38] may not be configured for the UE at the time of determination of PUCCH transmission power. That is, if the UE operates according to a unified TCI state, deltaF-PUCCH-f0, deltaF-PUCCH-f1, deltaF-PUCCH-f2, deltaF-PUCCH-f3, deltaF-PUCCH-f4, twoPUCCH-PC-AdjustmentStates, p0-Set, and pathlossReferenceRSs, which may be included in PUCCH-PowerControl in [Table 38], may not be configured for the UE. As described above, when the above higher layer signaling fails to be configured for the UE, the following restrictions may exist.
If deltaF-PUCCH-f0, deltaF-PUCCH-f1, deltaF-PUCCH-f2, deltaF-PUCCH-f3, and deltaF-PUCCH-f4 are not configured for the UE, the UE may consider Δ_{F} PUCCH(F) in [Equation 3] as 0.
If twoPUCCH-PC-AdjustmentStates is not configured for the UE, only one closed loop index may be configured for the UE at the time of determination of PUCCH transmission power.
Even if p0-Set is not configured for the UE, p0 in Uplink-powerControl-r17 connected to a joint TCI state or UL TCI state may be configured and indicated for the UE and the UE may determine PUCCH transmission power.
Even if pathlossReferenceRSs is not configured for the UE, pathlossReferenceRS-Id-r17 included in a joint TCI state or UL TCI state may be configured and indicated for the UE and the UE may determine PUCCH transmission power.

For example, if the UE operates according to a unified TCI state, that is, if unifiedTCI-StateType is configured for the UE, alpha, p0, and pathlossReferenceRS in [Table 40] may not be configured for the UE at the time of determination of SRS transmission power. As described above, when the above higher layer signaling fails to be configured for the UE, the following restrictions may exist.
Even if alpha is not configured for the UE, alpha in Uplink-powerControl-r17 connected to a joint TCI state or UL TCI state may be configured and indicated for the UE and the UE may determine SRS transmission power.
If p0 is not configured for the UE, p0 in Uplink-powerControl-r17 connected to a joint TCI state or UL TCI state may be configured and indicated for the UE and the UE may determine SRS transmission power. However, as described above, when the UE determines P_{0_SRS,b,f,c}(qₛ) in [Equation 10], the UE may determine the value to be the sum of p0 in the higher layer signaling SRS-resourceSet and a p0 value (e.g., P_{0_UE_SRS,b,f,c}(qₛ)) configurable in p0AlphaSetforSRS in Uplink-powerControlId-r17, but the UE is unable to determine P_{0_SRS,b,f,c}(qₛ) when p0 is not configured.
Even if pathlossReferenceRSs is not configured for the UE, pathlossReferenceRS-Id-r17 included in a joint TCI state or UL TCI state may be configured and indicated for the UE and the UE may determine SRS transmission power.

In summary of the above items, it may be identified that if the UE operates according to a unified TCI state, that is, if unifiedTCI-StateType is configured for the UE, some of higher layer signalings capable of determining PUSCH, PUCCH, and SRS transmission power are not configured. As described above, in a case where the UE operates according to a unified TCI state, some higher layer signalings has substitutable basic (default) values defined in case that the signalings are not configured. However, configuring the higher layer signalings may restrict functions operable by the UE. For example, if two closed loop indexes for control of PUSCH transmission power being possible fails to be configured for the UE (e.g., twoPUSCH-PC-AdjustmentStates is not configured), the UE is able to use only one closed loop index for control of PUSCH transmission power. Therefore, in a case where the base station transfer a TPC command for transmission power control by the UE, it may be impossible to perform individual transmission power control required according to the type of uplink traffic of the UE (e.g., eMBB traffic, which requires high transmission throughput, and URLLC traffic, which demands low error rates and high robustness, etc.) or which TRP toward which the UE performs uplink transmission. Therefore, in a case where unifiedTCI-StateType is configured for the UE, some higher layer signalings not configured may make only restricted uplink transmission power control methods possible for the UE.

### Second Embodiment: Additional Method of Configuring Transmission Power Parameter when Unified TCI State is Supported

As an embodiment of the disclosure, an additional method of configuring a transmission power parameter when a unified TCI state is supported is described. This embodiment may be operated in combination with other embodiments.

As mentioned in the first embodiment, in a case where unifiedTCI-StateType is configured for a UE, some of higher layer signalings for control of uplink transmission power may fail to be configured for the UE. Hereinafter, a method of solving restrictions occurring due to the above reason is described. The UE may operate through a combination of at least one of the following methods so as to easily control uplink transmission power when operating according to a unified TCI state.

### [Method 2-0]

If unifiedTCI-StateType is configured for the UE, some of higher layer signalings for control of PUSCH, PUCCH, and SRS transmission power may not be configured for the UE.

For control of PUSCH transmission power, if unifiedTCI-StateType is configured for the UE, pusch-PowerControl may not be configured for the UE.

For control of PUCCH transmission power, if unifiedTCI-StateType is configured for the UE, pucch-PowerControl may not be configured for the UE.

For control of SRS transmission power, if unifiedTCI-StateType is configured for the UE, p0, alpha, and pathlossReferenceRS in SRS-ResourceSet may not be configured for the UE.

### [Method 2-1]

If unifiedTCI-StateType is configured for the UE, some of higher layer signalings for control of PUSCH, PUCCH, and SRS transmission power may not be configured for the UE.

For control of PUSCH transmission power, if unifiedTCI-StateType is configured for the UE, only some higher layer signalings in pusch-PowerControl may be configured for the UE. Parameters configurable for the UE among the higher layer signalings in pusch-PowerControl may be a combination of at least one of the following items:
tpc-Accumulation;
msg3-Alpha;
twoPUSCH-PC-AdjustmentStates;
p0-NominalWithoutGrant;
deltaMCS;
olpc-ParameterSetDCI-0-1, olpc-ParameterSetDCI-0-2;
p0-PUSCH-SetList; and/or
p0-PUSCH-SetList2.

For control of PUSCH transmission power, if unifiedTCI-StateType is configured for the UE, some higher layer signalings in pusch-PowerControl may not be configured for the UE. Parameters, which may not be configured for the UE, among the higher layer signaling s in pusch-PowerControl may be a combination of at least one of the following items:
sri-PUSCH-MappingToAddModList, sri-PUSCH-MappingToAddModList2;
p0-AlphaSets; and/or
pathlossReferenceRSToAddModList.

In a case where the UE operates according to a unified TCI state, the UE may apply p0, alpha, and a closed loop index included in ul-powerControl-r17 in [Table 33] at the time of determination of PUSCH transmission power regardless of a TCI state indicated to the UE as in [Method 1-1], and may apply p0, alpha, and a closed loop index included in p0AlphaSetforPUSCH-r17 in ul-powerControl-r17 in [Table 34] and [Table 35] below configurable in a TCI state indicated to the UE at the time of determination of PUSCH transmission power as in [Method 1-2]. Therefore, if the UE does not operate according to a unified TCI state, the higher layer signalings sri-PUSCH-MappingToAddModList and sri-PUSCH-MappingToAddModList2, which have been used to indicate a PUSCH transmission power parameter by using an SRI field in DCI, may not be configured.

For the higher layer signaling p0-AlphaSets, if unifiedTCI-StateType is configured for the UE, the UE may replace the higher layer signaling by p0-r17 and alpha-r17 in the higher layer signaling p0AlphaSetforPUSCH-r17 in [Table 32] being configured.

For the higher layer signaling pathlossReferenceRSToAddModList, if unifiedTCI-StateType is configured for the UE, the UE may replace the higher layer signaling by the higher layer signaling pathlossReferenceRSToAddModList-r17 in [Table 33] being configured, and the base station may indicate, to the UE, one of reference signals for measuring a pathloss amount, which are configured for the UE as described above.

For control of PUCCH transmission power, if unifiedTCI-StateType is configured for the UE, only some higher layer signalings in pucch-PowerControl may be configured for the UE. Parameters configurable for the UE among the higher layer signalings in pucch-PowerControl may be a combination of at least one of the following items:
deltaF-PUCCH-f0, deltaF-PUCCH-f1, deltaF-PUCCH-f2, deltaF-PUCCH-f3, deltaF-PUCCH-f4; and/or
twoPUCCH-PC-AdjustmentStates.

For control of PUCCH transmission power, if unifiedTCI-StateType is configured for the UE, some higher layer signalings in pucch-PowerControl may not be configured for the UE. Parameters, which may not be configured for the UE, among the higher layer signalings in pucch-PowerControl may be a combination of at least one of the following items:
p0-Set; and/or
pathlossReferenceRSs.

For the higher layer signaling p0-Set, if unifiedTCI-StateType is configured for the UE, the UE may replace the higher layer signaling by p0-r17 in the higher layer signaling p0AlphaSetforPUCCH-r17 in [Table 32] being configured.

For the higher layer signaling pathlossReferenceRSs, if unifiedTCI-StateType is configured for the UE, the UE may replace the higher layer signaling by the higher layer signaling pathlossReferenceRSToAddModList-r17 in [Table 33] being configured, and the base station may indicate, to the UE, one of reference signals for measuring a pathloss amount, which are configured for the UE as described above.

For control of SRS transmission power, if unifiedTCI-StateType is configured for the UE, p0 and srs-PowerControlAdjustmentStates in SRS-ResourceSet may be configured for the UE.

For control of SRS transmission power, if unifiedTCI-StateType is configured for the UE, some higher layer signalings in SRS-ResourceSet may not be configured for the UE. Parameters, which may not be configured for the UE, among the higher layer signalings in SRS-ResourceSet may be a combination of at least one of the following items:
alpha; and/or
pathlossReferenceRS.

For the higher layer signaling alpha, if unifiedTCI-StateType is configured for the UE, the UE may replace the higher layer signaling by alpha-r17 in the higher layer signaling p0AlphaSetforSRS-r17 in [Table 32] being configured.

For the higher layer signaling pathlossReferenceRSs, if unifiedTCI-StateType is configured for the UE, the UE may replace the higher layer signaling by the higher layer signaling pathlossReferenceRSToAddModList-r17 in [Table 33] being configured, and the base station may indicate, to the UE, one of reference signals for measuring a pathloss amount, which are configured for the UE as described above.

### [Method 2-2]

If unifiedTCI-StateType is configured for the UE, some of higher layer signalings for control of PUSCH, PUCCH, and SRS transmission power may not be configured for the UE, and new higher layer signaling may be configured therefor as below.

For control of PUSCH transmission power, if unifiedTCI-StateType is configured for the UE, pusch-PowerControl may not be configured for the UE, and a combination of at least one of the following higher layer signalings may be configured in the higher layer signaling PUSCH-config. The following higher layer signalings may have a part such as “-r17,” “-r18,” or “-r19” (e.g., tpc-Accumulation-r17 or p0-PUSCH-SetList2-r18) added after the name of each parameter:
tpc-Accumulation;
msg3-Alpha;
twoPUSCH-PC-AdjustmentStates;
p0-NominalWithoutGrant;
deltaMCS;
olpc-ParameterSetDCI-0-1, olpc-ParameterSetDCI-0-2;
p0-PUSCH-SetList; and/or
p0-PUSCH-SetList2.

The UE may additionally consider a combination of at least one of the following conditions for PUSCH transmission power control.
If unifiedTCI-StateType is not configured for the UE, pusch-PowerControl may be configured for the UE, and a combination of at least one of higher layer signalings may not be configured in the higher layer signaling PUSCH-config.
If pusch-PowerControl is configured for the UE, a combination of at least one of higher layer signalings may not be configured in the higher layer signaling PUSCH-config for the UE.
If pusch-PowerControl is not configured for the UE, a combination of at least one of higher layer signalings may be configured in the higher layer signaling PUSCH-config for the UE.

For control of PUCCH transmission power, if unifiedTCI-StateType is configured for the UE, pucch-PowerControl may not be configured for the UE, and a combination of at least one of the following higher layer signalings may be configured in the higher layer signaling PUCCH-config. The following higher layer signalings may have a part such as “-r17,” “-r18,” or “-r19” (e.g., deltaF-PUCCH-f0-r17 or twoPUCCH-PC-AdjustmentStates-r18) added after the name of each parameter:
deltaF-PUCCH-f0, deltaF-PUCCH-f1, deltaF-PUCCH-f2, deltaF-PUCCH-f3, deltaF-PUCCH-f4; and/or
twoPUCCH-PC-AdjustmentStates.

The UE may additionally consider a combination of at least one of the following conditions for PUCCH transmission power control.
If unifiedTCI-StateType is not configured for the UE, pucch-PowerControl may be configured for the UE, and a combination of at least one of higher layer signalings may not be configured in the higher layer signaling PUCCH-config.
If pucch-PowerControl is configured for the UE, a combination of at least one of higher layer signalings may not be configured in the higher layer signaling PUCCH-config.
If pucch-PowerControl is not configured for the UE, a combination of at least one of higher layer signalings may be configured in the higher layer signaling PUCCH-config.

For control of SRS transmission power, if unifiedTCI-StateType is configured for the UE, p0, alpha, and pathlossReferenceRS may not be configured in SRS-ResourceSet for the UE, and p0 may be configured in the higher layer signaling SRS-config. A part, such as “-r17,” “-r18,” or “-r19,” or a part such as “-srs” for expressing p0 being applied to an SRS may be added after p0 (e.g., p0-srs-r18).

The UE may additionally consider a combination of at least one of the following conditions for SRS transmission power control.
If unified TCI-StateType is not configured for the UE, p0, alpha, and pathlossReferenceRS may be configured in SRS-ResourceSet for the UE, and p0 may be not configured in the higher layer signaling SRS-config for the UE.
If p0, alpha, and pathlossReferenceRS are configured in SRS-ResourceSet for the UE, and p0 may be not configured in the higher layer signaling SRS-config for the UE.
If p0, alpha, and pathlossReferenceRS are not configured in SRS-ResourceSet for the UE, and p0 may be configured in the higher layer signaling SRS-config for the UE.

### [Method 2-3]

If unifiedTCI-StateType is configured for the UE, some of higher layer signalings for control of PUSCH, PUCCH, and SRS transmission power may not be configured for the UE, and the UE may receive new higher layer signaling in a bandwidth part configuration as below.

For control of PUSCH transmission power, if unifiedTCI-StateType is configured for the UE, pusch-PowerControl may not be configured for the UE, and a combination of at least one of the following higher layer signalings may be configured in the higher layer signaling BWP-UplinkDedicated. The following higher layer signalings may have a part such as “-r17,” “-r18,” or “-r19” added after the name of each parameter, may have a part such as “-pusch” to express that a corresponding higher layer signaling is applied to a PUSCH, or may have both of the parts (e.g., tpc-Accumulation-PUSCH-r17 or p0-PUSCH-SetList2-r18):
tpc-Accumulation;
msg3-Alpha;
twoPUSCH-PC-AdjustmentStates;
p0-NominalWithoutGrant;
deltaMCS;
olpc-ParameterSetDCI-0-1, olpc-ParameterSetDCI-0-2;
p0-PUSCH-SetList; and/or
p0-PUSCH-SetList2.

The UE may additionally consider a combination of at least one of the following conditions for PUSCH transmission power control.
If unifiedTCI-StateType is not configured for the UE, pusch-PowerControl may be configured for the UE, and a combination of at least one of higher layer signalings may not be configured in the higher layer signaling BWP-UplinkDedicated.
If pusch-PowerControl is configured for the UE, a combination of at least one of higher layer signalings may not be configured in the higher layer signaling BWP-UplinkDedicated.
If pusch-PowerControl is not configured for the UE, a combination of at least one of higher layer signalings may be configured in the higher layer signaling BWP-UplinkDedicated.

For control of PUCCH transmission power, if unifiedTCI-StateType is configured for the UE, pucch-PowerControl may not be configured for the UE, and a combination of at least one of the following higher layer signalings may be configured in the higher layer signaling BWP-UplinkDedicated. The following higher layer signalings may have a part such as “-r17,” “-r18,” or “-r19” added after the name of each parameter, may have a part such as “-pucch” to express that a corresponding higher layer signaling is applied to a PUCCH, or may have both of the parts (e.g., deltaF-PUCCH-f0-r17 or twoPUCCH-PC-AdjustmentStates-r18):
deltaF-PUCCH-f0, deltaF-PUCCH-f1, deltaF-PUCCH-f2, deltaF-PUCCH-f3, deltaF-PUCCH-f4; and/or
twoPUCCH-PC-AdjustmentStates.

The UE may additionally consider a combination of at least one of the following conditions for PUCCH transmission power control.
If unifiedTCI-StateType is not configured for the UE, pucch-PowerControl may be configured for the UE, and a combination of at least one of higher layer signalings may not be configured in the higher layer signaling BWP-UplinkDedicated.
If pucch-PowerControl is configured for the UE, a combination of at least one of higher layer signalings may not be configured in the higher layer signaling BWP-UplinkDedicated.
If pucch-PowerControl is not configured for the UE, a combination of at least one of higher layer signalings may be configured in the higher layer signaling BWP-UplinkDedicated.

For control of SRS transmission power, if unifiedTCI-StateType is configured for the UE, p0, alpha, and pathlossReferenceRS may not be configured in SRS-ResourceSet for the UE, and p0 may be configured in the higher layer signaling BWP-UplinkDedicated. A part, such as “-r17,” “-r18,” or “-r19,” or a part such as “-srs” for expressing p0 being applied to an SRS may be added after p0 (e.g., p0-srs-r18).

The UE may additionally consider a combination of at least one of the following conditions for SRS transmission power control.
If unified TCI-StateType is not configured for the UE, p0, alpha, and pathlossReferenceRS may be configured in SRS-ResourceSet for the UE, and p0 may be not configured in the higher layer signaling BWP-UplinkDedicated.
If p0, alpha, and pathlossReferenceRS are configured in SRS-ResourceSet for the UE, and p0 may be not configured in the higher layer signaling BWP-UplinkDedicated for the UE.
If p0, alpha, and pathlossReferenceRS are not configured in SRS-ResourceSet for the UE, and p0 may be configured in the higher layer signaling BWP-UplinkDedicated for the UE.

With respect to each of [Method 2-1] to [Method 2-3], for control of PUSCH transmission power, if unifiedTCI-StateType is configured for the UE, a combination of at least one of the following higher layer signalings may not be configured for the UE in the higher layer signaling pusch-PowerControl, PUSCH-config, or BWP-UplinkDedicated:
olpc-ParameterSetDCI-0-1, olpc-ParameterSetDCI-0-2;
p0-PUSCH-SetList; and/or
p0-PUSCH-SetList2.

In a case where the UE operates according to a unified TCI state, the UE may apply p0, alpha, and a closed loop index included in ul-powerControl-r17 in [Table 33] at the time of determination of PUSCH transmission power regardless of a TCI state indicated to the UE as in [Method 1-1], and may apply p0, alpha, and a closed loop index included in p0AlphaSetforPUSCH-r17 in ul-powerControl-r17 in [Table 34] and [Table 35] below configurable in a TCI state indicated to the UE at the time of determination of PUS CH transmission power as in [Method 1-2].

Higher layer signalings may be higher layer signalings used in open-loop power control (OLPC). Through p0-PUSCH-SetList and p0-PUSCH-SetList2, another p0 value indicatable by the same SRI may be configured for the UE by the base station. In this case, through an open-loop power control parameter set indication field in DCI, the UE may receive an indication of one of a value configured through the higher layer signaling p0-AlphaSets and a value configured through the higher layer signalings p0-PUSCH-SetList and p0-PUSCH-SetList2, to determine final p0 at time of determination of PUSCH transmission power. However, since [Method 1-1] is a method of using common p0, alpha, and closed loop index at determination of all uplink transmission power, there may be no reason to use additional p0 through p0-PUSCH-SetList and p0-PUSCH-SetList2 described above. In addition, since [Method 1-2] enables indication of different transmission power parameters p0, alpha, and closed loop index through a TCI state, signaling flexibility may be already sufficiently ensured even if additional p0 is not used through p0-PUSCH-SetList and p0-PUSCH-SetList2 described above. Therefore, in a case where the UE operates according to a unified TCI state, higher layer signaling (e.g., olpc-ParameterSetDCI-0-1, olpc-ParameterSetDCI-0-2, p0-PUSCH-SetList, or p0-PUSCH-SetList2) used in open-loop power control may not be configured for the UE, and the UE may not support an open-loop power control parameter set indication field in DCI format 0_1, 0_2, and 0_3,

On the contrary, if uplink transmission power control signaling is indicated to the UE by the base station through [Method 1-2], the flexibility of the signaling may relate to the number of cases where different p0 values are connected to different TCI states. That is, the number of transmission power parameter sets in which different p0 values are connected to the same alpha value and the same closed loop index value may be greater than 64 that is a maximum number of UL TCI state. For example, the total number of possible value candidates of the higher layer signaling alpha is 8 including alpha0, alpha04, alpha05, alpha06, alpha07, alpha08, alpha09, and alphal, two closed loop indexes including i0 and i1 are possible, and thus a total of 16 combinations of alpha and a closed loop index may be possible. In addition, integers between −16 and 15 are possible as a value of p0 and thus a possible total number of the values is 32, and the number of all possible combinations of p0, alpha, and a closed loop index may be 512 in total. Therefore, if multiple different TRPs exist in a particular serving cell operating in an FR2 band and the UE operates multiple transmission/reception beams, the UE may require various combinations of transmission power parameters. In this case, for signaling flexibility which may be insufficient with a method capable of indicating a maximum of 8 activated TCI states, if open-loop power control is additionally employed, additionally flexibility may be ensured on signaling. Therefore, for control of PUSCH transmission power, if unifiedTCI-StateType is configured for the UE, a combination of at least one of the following higher layer signalings may be configured in the higher layer signaling PUSCH-config for the UE. In order to distinguish between the following higher layer signalings and existing higher layer signaling, a part such as “-UTCI” and/or a part such as “-r17,” “-r18,” or “-r19” may be added in the parameter name of the following higher layer signalings (e.g., olpc-ParameterSet-UTCI-DCI-0-1 or p0-PUSCH-SetList-UTCI-r18):
olpc-ParameterSet-DCI-0-1, olpc-ParameterSet-DCI-0-2;
p0-PUSCH-SetList; and/or
p0-PUSCH-SetList2.

olpc-ParameterSet-DCI-0-1 and olpc-ParameterSet-DCI-0-2 may indicate the length of an open-loop power control parameter set indication field which may be included in DCI, and 1 or 2 bits may be possible. The higher layer signaling p0-PUSCH-SetList may indicate additional p0 corresponding to a codepoint of each TCI state field in DCI. The length of the higher layer signaling p0-PUSCH-SetList may be a power of 2 with the exponent being the larger value of the lengths of TCI state fields included in DCI formats 0_1 and 0_2, and a p0 value corresponding to the length of p0-PUSCH-SetList may be configured for the UE. For example, if the lengths of TCI state fields in DCI formats 0_1 and 0_2 are 3 bits and 2 bits, respectively, the length of the higher layer signaling p0-PUSCH-SetList may be 8 that is a power of 2 having the exponent of 3, which is the larger value among 3 bits and 2 bits, and a total of 8 identical or different p0 values may be configured. The UE may determine which p0 which the UE is to apply to calculate uplink transmission power according to the value of an open-loop power control parameter set indication field in DCI received by the UE, through a method as below. In a case of the higher layer signaling p0-PUSCH-SetList2, if two TCI states are indicated to the UE through TCI state in DCI (the second joint TCI state in a case of joint TCI state, and the second UL TCI state in a case of separate TCI state), the UE may interpret and apply the TCI state in the following method as the second joint TCI state or the second UL TCI state indicated to the UE.
If an open-loop power control parameter set indication field is indicated as 0 (if the field is 1 bit) or 00 (if the field is 2 bits) to the UE through DCI and the fourth codepoint of a TCI state field is indicated to the UE through the same DCI, the UE may use p0 connected to an indicated TCI state as a transmission power parameter.
If an open-loop power control parameter set indication field is indicated as 1 (if the field is 1 bit) or 01 (if the field is 2 bits) to the UE and the fourth codepoint of a TCI state field is indicated to the UE through the same DCI, the UE may use, as a transmission power parameter, the fourth value of p0 among the values of p0 configured through the higher layer signaling p0-PUSCH-SetList (i.e., another p0 connected to the fourth TCI state indicated to the UE).

As another method, the higher layer signaling p0-PUSCH-SetList may include a maximum of two different values of p0.
If an open-loop power control parameter set indication field is indicated as 0 (if the field is 1 bit) or 00 (if the field is 2 bits) to the UE through DCI and the fourth codepoint of a TCI state field is indicated to the UE through the same DCI, the UE may use p0 connected to an indicated TCI state as a transmission power parameter.
If an open-loop power control parameter set indication field is indicated as 1 (if the field is 1 bit) or 01 (if the field is 2 bits) to the UE and the fourth codepoint of a TCI state field is indicated to the UE through the same DCI, the UE may use, as a transmission power parameter, the first value of p0 among the values of p0 configured through the higher layer signaling p0-PUSCH-SetList.
If an open-loop power control parameter set indication field is indicated as 10 (if the field is 2 bits) to the UE and the fourth codepoint of a TCI state field is indicated to the UE through the same DCI, the UE may use, as a transmission power parameter, the second value of p0 among the values of p0 configured through the higher layer signaling p0-PUSCH-SetList.

A UE may be notified by a base station of at least one of [Method 1-1], [Method 1-2], [Method 1-3], [Method 2-0], [Method 2-1], [Method 2-2], or [Method 2-3] through at least one of higher layer signaling, MAC-CE signaling, or L1 signaling, or may expect at least one of [Method 1-1], [Method 1-2], [Method 1-3], [Method2-0], [Method 2-1], [Method 2-2], or [Method 2-3] to be statically defined in a specification. In the disclosure, phrases such as “A or B,” “at least one of A and B,” “at least one of A or B,” “A, B, or C,” “at least one of A, B, and C,” and “at least one of A, B, or C” may include any one or all possible combinations of the items listed in a corresponding phrase of the respective phrases.

Additionally, if a UE is notified by a base station of a combination of one or more specific methods through at least one of higher layer signaling, MAC-CE signaling, or L1 signaling, it may imply that the UE is unable to support other combinations of the one or more specific methods. In other words, if the UE is notified of at least one of [Method 1-1], [Method 1-2], [Method 1-3], [Method 2-0], [Method 2-1], [Method 2-2], or [Method 2-3] by the base station, it may imply that the UE is unable to support the one or more other methods except for the at least one.

For example, the UE may expect [Method 1-1] and/or [Method 2-2] to be statically defined in a specification for higher layer signaling configuration methods related to uplink transmission power.

In another example, the UE may be notified of [Method 1-2] and/or [Method 2-3] by the base station through at least one of higher layer signaling, MAC-CE signaling, or L1 signaling. In such cases, the UE may consider that at least one of the methods not notified (e.g., [Method 1-1] and/or [Method 2-0]) not being supported is notified by the base station.

The UE may report, to the base station as UE capability, whether the UE is able to support at least one of [Method 1-1], [Method 1-2], [Method 1-3], [Method 2-0], [Method 2-1], [Method 2-2], or [Method 2-3]. If the UE reports, to the base station as UE capability, whether the UE is able to a combination of one or more specific methods, it may be considered that the UE reports that the UE is unable to support other combinations of one or more specific methods. In other words, if the UE reports, to the base station as UE capability, that the UE is able to at least one of [Method 1-1], [Method 1-2], [Method 1-3], [Method 2-0], [Method 2-1], [Method 2-2], or [Method 2-3], it may be considered that the UE reports that the UE is unable to support one or more methods of the remaining methods except for the reported at least one method. In other words, it may be considered that the UE reports that the UE is unable to support other methods or other methods not reported as UE capability.

For instance, the UE may report, to the base station, whether the UE is able to support [Method 1-1], [Method 1-2], [Method 2-0], and/or [Method 2-3]. In this case, the UE may report, to the base station as a UE capability report, that the UE is able to support [Method 1-2] and/or [Method 2-3], and the UE capability report may imply that the UE is unable to support [Method 1-1] and/or [Method 2-0].

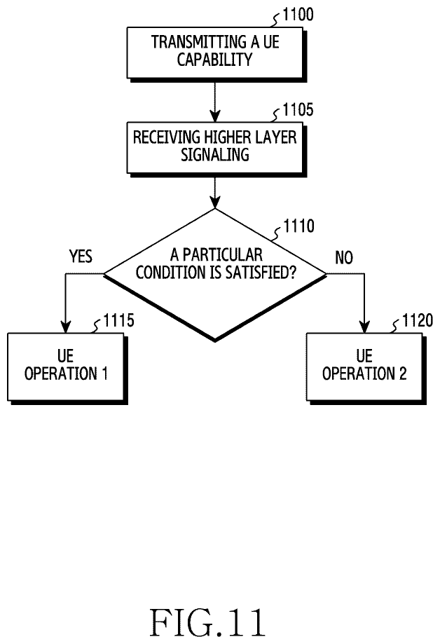

FIG. 11 illustrates an operation of a UE for controlling uplink transmission power according to an embodiment of the present disclosure.

In operation 1100, a UE may transmit a UE capability to a base station. UE capability signaling which may be reported at this time may relate to at least one of a UE capability related to PUSCH, PUCCH, and SRS transmission, a UE capability related to a unified TCI state operation, or a UE capability corresponding to at least one of [Method 1-1], [Method 1-2], [Method 1-3], [Method 2-0], [Method 2-1], [Method 2-2], or [Method 2-3]. Omission of operation 1100 is possible.

In operation 1105, the UE may receive higher layer signaling from the base station according to the reported UE capability. The UE may define higher layer parameters for a combination of at least one of higher layer signaling related to PUSCH, PUCCH, and SRS transmission, higher layer signaling related to a unified TCI state operation, or higher layer signaling related to supporting of [Method 1-1] to [Method 1-3] or [Method 2-0] to [Method 2-3], which is received from the base station, and use one of the defined higher layer parameters.

In operation 1110, the UE may be notified by the base station of whether to perform UE operation 1 or 2 according to whether a particular condition is satisfied. The particular condition may be a condition under which [Method 2-0] to [Method 2-3] are performed. For example, the particular condition may be a combination of at least one of the following items:
unifiedTCI-StateType is configured for the UE (i.e., the UE operates according to a unified TCI state);
The UE reports, to the base station, a UE capability indicating whether the UE is able to support at least one of [Method 1-1], [Method 1-2], [Method 1-3], [Method 2-0], [Method 2-1], [Method 2-2], or [Method 2-3]; and/or
The UE is notified by the base station of at least one of [Method 1-1], [Method 1-2], [Method 1-3], [Method 2-0], [Method 2-1], [Method 2-2], or [Method 2-3] through at least one of higher layer signaling, MAC-CE signaling, or L1 signaling, or is statically defined in a specification to operate according to at least one of [Method 1-1], [Method 1-2], [Method 1-3], [Method 2-0], [Method 2-1], [Method 2-2], or [Method 2-3].

If the UE satisfies the particular condition, in operation 1115, the UE may perform UE operation 1 in determining uplink transmission power. UE operation 1 may follow at least one of [Method 1-1], [Method 1-2], [Method 2-0], [Method 2-2], or [Method 2-3].

If the UE does not satisfy the particular condition, in operation 1120, the UE may perform UE operation 2 in determining uplink transmission power. UE operation 2 may follow [Method 1-3].

A flowchart described above illustrates an exemplified method implementable according to the principle of the disclosure, and a method illustrated in the flowchart of this specification may be variously modified. For example, a series of operations are illustrated, but various operations in each drawing may overlap with each other, occur in parallel, occur in a different sequence, or occur several times. In another example, an operation may be omitted or replaced with another operation.

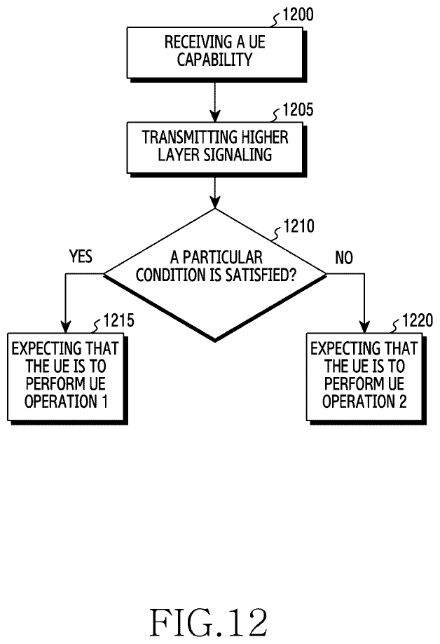

FIG. 12 illustrates an operation of a base station for controlling uplink transmission power according to an embodiment of the present disclosure.

In operation 1200, a base station may receive a UE capability from a UE. UE capability signaling which may be received by the base station may relate to at least one of a UE capability related to PUSCH, PUCCH, and SRS transmission, a UE capability related to a unified TCI state operation, or a UE capability corresponding to at least one of [Method 1-1], [Method 1-2], [Method 1-3], [Method 2-0], [Method 2-1], [Method 2-2], or [Method 2-3]. Omission of operation 1200 is possible.

In operation 1205, the base station may transmit higher layer signaling to the UE according to the UE capability reported by the UE. The UE may define higher layer parameters for a combination of at least one of higher layer signaling related to PUSCH, PUCCH, and SRS transmission, higher layer signaling related to a unified TCI state operation, or higher layer signaling related to supporting of [Method 1-1] to [Method 1-3] or [Method 2-0] to [Method 2-3], which is received from the base station, and use one of the defined higher layer parameters.

In operation 1210, the base station may determine whether the UE is to perform UE operation 1 or 2 according to whether the UE satisfies a particular condition, and notify the UE of the determination. The particular condition may be a condition under which [Method 2-0] to [Method 2-3] are performed. For example, the particular condition may be a combination of at least one of the following items:
unifiedTCI-StateType is configured for the UE (i.e., the UE operates according to a unified TCI state);
The UE reports, to the base station, a UE capability indicating whether the UE is able to support at least one of [Method 1-1], [Method 1-2], [Method 1-3], [Method 2-0], [Method 2-1], [Method 2-2], or [Method 2-3]; and/or
The UE is notified by the base station of at least one of [Method 1-1], [Method 1-2], [Method 1-3], [Method 2-0], [Method 2-1], [Method 2-2], or [Method 2-3] through at least one of higher layer signaling, MAC-CE signaling, or L1 signaling, or is statically defined in a specification to operate according to at least one of [Method 1-1], [Method 1-2], [Method 1-3], [Method 2-0], [Method 2-1], [Method 2-2], or [Method 2-3].

If the UE satisfies the particular condition, in operation 1215, the base station may expect that the UE is to perform UE operation 1 in determining uplink transmission power. UE operation 1 may follow at least one of [Method 1-1], [Method 1-2], [Method 2-0], [Method 2-2], or [Method 2-3].

If the UE does not satisfy the particular condition, in operation 1220, the base station may expect that the UE is to perform UE operation 2 in determining uplink transmission power. UE operation 2 may follow [Method 1-3].

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, an operation may be omitted or replaced with another operation.

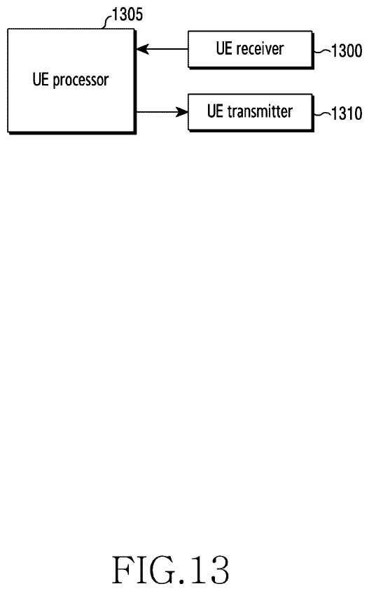

FIG. 13 illustrates a structure of a UE in a wireless communication system according to an embodiment of the present disclosure.

Referring to FIG. 13, the UE may include a transceiver, which refers to a UE receiver 1300 and a UE transmitter 1310 as a whole, a memory (not illustrated), and a UE processor 1305 (or UE controller or processor). The UE transceiver 1300 and 1310, the memory, and the UE processor 1305 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

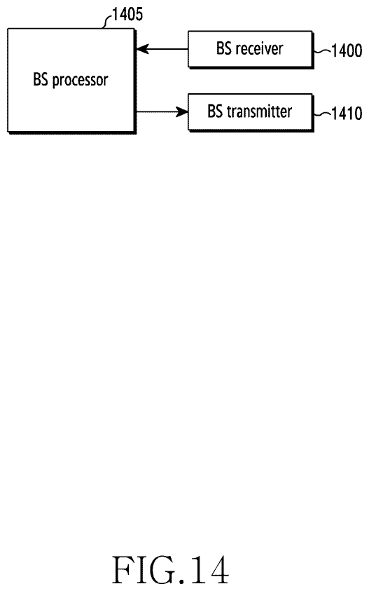

FIG. 14 illustrates a structure of a base station in a wireless communication system according to an embodiment of the present disclosure.

Referring to FIG. 14, the base station may include a transceiver, which refers to a base station receiver 1400 and a base station transmitter 1410 as a whole, a memory (not illustrated), and a base station processor 1405 (or base station controller or processor). The base station transceiver 1400 and 1410, the memory, and the base station processor 1405 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station, a radio resource control (RRC) message including physical uplink control channel (PUCCH)-power control information, unified transmission configuration indication (TCI) state type information, and uplink-power control information associated with the unified TCI state type information; and
transmitting, to the base station, a PUCCH based on the PUCCH-power control information and the uplink-power control information,
wherein, based on the unified TCI state type information being configured in the RRC message, the PUCCH-power control information does not include p0-set information and pathlossReferenceRSs information, and
wherein the uplink-power control information includes p0 information and alpha information for the PUCCH.

2. The method of claim 1, wherein the PUCCH-power control information further comprises at least one of deltaF-PUCCH-f0 information, deltaF-PUCCH-f1 information, deltaF-PUCCH-f2 information, deltaF-PUCCH-f3 information, deltaF-PUCCH-f4 information, or two-PUCCH-PC-AdjustmentStates information.

3. The method of claim 1, wherein the RRC message further includes physical uplink shared channel (PUSCH)-power control information,
wherein the method further comprises transmitting a PUSCH based on the PUSCH-power control information and the uplink-power control information,
wherein, based on the unified TCI state type information being configured in the RRC message, the PUSCH-power control information does not include p0-AlphaSets information, pathlossReferenceRSToAddModList information, sri-PUSCH-MappingtoAddModList information, and sri-PUSCH-MappingtoAddModList2 information, and
wherein the uplink-power control information includes p0 information and alpha information for the PUSCH.

4. The method of claim 3, wherein the PUSCH-power control information further comprises at least one of tpc-Accumulation information, msg3-Alpha information, p0-NominalWithoutGrant information, two-PUSCH-PC-AdjustmentStates information, deltaMCS information, olpc-ParameterSetDCI-0-1 information, or olpc-ParameterSetDCI-0-2 information.

5. The method of claim 1, wherein the RRC message further includes sounding reference signal (SRS) resource set information,
wherein the method further comprises transmitting an SRS based on the SRS resource set information and the uplink-power control information,
wherein, based on the unified TCI state type information being configured in the RRC message, the SRS resource set information does not include alpha information and pathlossReferenceRS information, and
wherein the uplink-power control information includes p0 information and alpha information for the SRS.

6. A method performed by a base station in a wireless communication system, the method comprising:
transmitting, to a terminal, a radio resource control (RRC) message including physical uplink control channel (PUCCH)-power control information, unified transmission configuration indication (TCI) state type information, and uplink-power control information associated with the unified TCI state type information; and
receiving, from the terminal, a PUCCH based on the PUCCH-power control information and the uplink-power control information, and
wherein, based on the unified TCI state type information being configured in the RRC message, the PUCCH-power control information does not include p0-set information and pathlossReferenceRSs information, and
wherein the uplink-power control information includes p0 information and alpha information for the PUCCH.

7. The method of claim 6, wherein the PUCCH-power control information further comprises at least one of deltaF-PUCCH-f0 information, deltaF-PUCCH-f1 information, deltaF-PUCCH-f2 information, deltaF-PUCCH-f3 information, deltaF-PUCCH-f4 information, or two-PUCCH-PC-AdjustmentStates information.

8. The method of claim 6, wherein the RRC message further includes physical uplink shared channel (PUSCH)-power control information,
wherein the method further comprises receiving a PUSCH based on the PUSCH-power control information and the uplink-power control information,
wherein, based on the unified TCI state type information being configured in the RRC message, the PUSCH-power control information does not include p0-AlphaSets information, pathlossReferenceRSToAddModList information, sri-PUSCH-MappingtoAddModList information, and sri-PUSCH-MappingtoAddModList2 information, and
wherein the uplink-power control information includes p0 information and alpha information for the PUSCH.

9. The method of claim 8, wherein the PUSCH-power control information further comprises at least one of tpc-Accumulation information, msg3-Alpha information, p0-NominalWithoutGrant information, two-PUSCH-PC-AdjustmentStates information, deltaMCS information, olpc-ParameterSetDCI-0-1 information, or olpc-ParameterSetDCI-0-2 information.

10. The method of claim 6, wherein the RRC message further includes sounding reference signal (SRS) resource set information,
wherein the method further comprises receiving an SRS based on the SRS resource set information and the uplink-power control information,
wherein, based on the unified TCI state type information being configured in the RRC message, the SRS resource set information does not include alpha information and pathlossReferenceRS information, and
wherein the uplink-power control information includes p0 information and alpha information for the SRS.

11. A terminal in a wireless communication system, the terminal comprising:
a transceiver; and
a controller coupled with the transceiver and configured to:
receive, from a base station, a radio resource control (RRC) message including physical uplink control channel (PUCCH)-power control information, unified transmission configuration indication (TCI) state type information, and uplink-power control information associated with the unified TCI state type information, and
transmit, to the base station, a PUCCH based on the PUCCH-power control information and the uplink-power control information,
wherein, based on the unified TCI state type information being configured in the RRC message, the PUCCH-power control information does not include p0-set information and pathlossReferenceRSs information, and
wherein the uplink-power control information includes p0 information and alpha information for the PUCCH.

12. The terminal of claim 11, wherein the PUCCH-power control information further comprises at least one of deltaF-PUCCH-f0 information, deltaF-PUCCH-f1 information, deltaF-PUCCH-f2 information, deltaF-PUCCH-f3 information, deltaF-PUCCH-f4 information, or two-PUCCH-PC-AdjustmentStates information.

13. The terminal of claim 11, wherein the RRC message further includes physical uplink shared channel (PUSCH)-power control information,
wherein the controller is further configured to transmit a PUSCH based on the PUSCH-power control information and the uplink-power control information,
wherein, based on the unified TCI state type information being configured in the RRC message, the PUSCH-power control information does not include p0-AlphaSets information, pathlossReferenceRSToAddModList information, sri-PUSCH-MappingtoAddModList information, and sri-PUSCH-MappingtoAddModList2 information, and
wherein the uplink-power control information includes p0 information and alpha information for the PUSCH.

14. The terminal of claim 13, wherein the PUSCH-power control information further comprises at least one of tpc-Accumulation information, msg3-Alpha information, p0-NominalWithoutGrant information, two-PUSCH-PC-AdjustmentStates information, deltaMCS information, olpc-ParameterSetDCI-0-1 information, or olpc-ParameterSetDCI-0-2 information.

15. The terminal of claim 11, wherein the RRC message further includes sounding reference signal (SRS) resource set information,
wherein the controller is further configured to transmit an SRS based on the SRS resource set information and the uplink-power control information,
wherein, based on the unified TCI state type information being configured in the RRC message, the SRS resource set information does not include alpha information and pathlossReferenceRS information, and
wherein the uplink-power control information includes p0 information and alpha information for the SRS.

16. Abase station in a wireless communication system, the base station comprising:
a transceiver; and
a controller coupled with the transceiver and configured to:
transmit, to a terminal, a radio resource control (RRC) message including physical uplink control channel (PUCCH)-power control information, unified transmission configuration indication (TCI) state type information, and uplink-power control information associated with the unified TCI state type information; and
receive, from the terminal, a PUCCH based on the PUCCH-power control information and the uplink-power control information,
wherein, based on the unified TCI state type information being configured in the RRC message, the PUCCH-power control information does not include p0-set information and pathlossReferenceRSs information, and
wherein the uplink-power control information includes p0 information and alpha information for the PUCCH.

17. The base station of claim 16, wherein the PUCCH-power control information further comprises at least one of deltaF-PUCCH-f0 information, deltaF-PUCCH-f1 information, deltaF-PUCCH-f2 information, deltaF-PUCCH-f3 information, deltaF-PUCCH-f4 information, or two-PUCCH-PC-AdjustmentStates information.

18. The base station of claim 16, wherein the RRC message further includes physical uplink shared channel (PUSCH)-power control information,
wherein the controller is further configured to receive a PUSCH based on the PUSCH-power control information and the uplink-power control information,
wherein, based on the unified TCI state type information being configured in the RRC message, the PUSCH-power control information does not include p0-AlphaSets information, pathlossReferenceRSToAddModList information, sri-PUSCH-MappingtoAddModList information, and sri-PUSCH-MappingtoAddModList2 information, and
wherein the uplink-power control information includes p0 information and alpha information for the PUSCH.

19. The base station of claim 18, wherein the PUSCH-power control information further comprises at least one of tpc-Accumulation information, msg3-Alpha information, p0-NominalWithoutGrant information, two-PUSCH-PC-AdjustmentStates information, deltaMCS information, olpc-ParameterSetDCI-0-1 information, or olpc-ParameterSetDCI-0-2 information.

20. The base station of claim 16, wherein the RRC message further includes sounding reference signal (SRS) resource set information,
wherein the controller is further configured to receive an SRS based on the SRS resource set information and the uplink-power control information,
wherein, based on the unified TCI state type information being configured in the RRC message, the SRS resource set information does not include alpha information and pathlossReferenceRS information, and
wherein the uplink-power control information includes p0 information and alpha information for the SRS.
